(19) United States
(12) Patent Application Publication
(10) Pub. No.: US 2006/0015396 A1
(43) Pub. Date: Jan. 19, 2006

(54) System and method for optimizing the utilization of a cargo space and for maximizing the revenue from a cargo transport

(76) Inventor: Johannes Blomeyer, Frankfurt (DE)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/129,047

(22) Filed: May 13, 2005

(30) Foreign Application Priority Data
May 13, 2004 (DE) 102004023833.2

(51) Int. Cl. G06F 17/60

(52) U.S. Cl. 705/13; 705/6

(57) ABSTRACT

The present invention relates to a process for the automatic maximization and/or optimization of the load, the chargeable weight, the revenue, the capacities and/or the cargo space of a cargo transport, particularly of an air-cargo transport, consisting of cargo of differing volume weight d, calculated as volume per weight, wherein a maximum cargo volume Vₘₐₓ and a maximum cargo weight Wₘₐₓ are predetermined for the cargo space. The process in accordance with the invention uses scaled values of volume weight and is based particularly on the optimization process of linear programming.

### FIELD OF THE INVENTION

The present invention relates to a method for automatically maximizing or optimizing the full utilization, the chargeable weight, the revenue, the capacities, and/or the cargo space of a cargo transport, for example air cargo transport, involving loading with differing volume weight d, calculated as volume per weight, possibly using electronic data processing (EDP) equipment, in which a maximum cargo volume Vₘₐₓ and a maximum cargo weight Wₘₐₓ are specified for the cargo space.

### BACKGROUND OF THE INVENTION

It is sufficiently well-known that preliminary and intermediate products for varied production processes are not produced at one and the same place but are often delivered just in time. In particular, due to modem means of communication and the increasing significance of E-commerce associated therewith, intermediate and end products may be and are often ordered at very short notice. This makes it possible to flexibly respond to the changing market conditions. The production and market situations described always presuppose that there are corresponding means of transportation and cargo capacities available. In view of the increasing internationalization of business connections and market globalization, the desired cargo quantities may as a rule be transported only with the help of air cargo service at short notice from an origin to a place of destination. As expected, air cargo service continues to increase in scale and significance.

Air cargo service in the meantime offers worldwide cargo connections between all important commercial metropolises such that time-critical cargo can often be sent by air. At the same time, air cargo service is exposed to considerable limitations. For one, each cargo plane inevitably has a limited maximum payload and load volume. For example, the maximum payload here may vary, depending on the particular flight length or the distance between two fuel stops, depending on how much fuel is needed. Moreover, the maximum load volume for cargo may vary, for example, depending on how much space is taken up by passenger baggage or by stowage loss caused by bulky cargo. It must also altogether be ensured that the weight while loading the cargo space is not very unevenly distributed. The complexity of air cargo service is further increased in that flights bearing cargo are conceived not inevitably as outward and inward flights, but that several airports must be accessed in succession in order to deliver a part of the load, and if necessary, to take on new load before once again reaching the airport of origin. In order to make air cargo service profitable, the regular high costs of purchasing or leasing for the (cargo) plane, as well as the maintenance, operating and personal costs must be met. This generally succeeds only if the cargo space available is optimally utilized on every flight segment of a flight, without exceeding the allowable maximum weight or volume in the process.

Because there is great competition among air cargo companies, the optimal use of the resources of a particular cargo flight is of primary concern. Unlike passenger service, what aggravates air cargo service is that air cargo is transported in only one direction and a demand irrespective of the outward flight must be taken as a basis for the return flight. Furthermore, unlike passenger service, the individual load units normally differ greatly with respect to their weight and their volume and can therefore not be handled uniformly. Also because of the already described limitations imposed on air cargo service with respect to weight and volume, there has been little success in accepting incoming cargo transport requests according to the so-called first-come-first-served principle, since much higher rates are paid for bookings shortly before departure.

Nevertheless, in order to immediately respond as smoothly as possible to numerous individual requests close to the flight date, and in the process, to also divide the weight and volume available in a cost-bearing manner among the individual requests, EDP-supported systems are used these days. Through this approach, the objective of the air cargo company is to be able to give an acceptance or a refusal right away, i.e., within a few seconds, if possible. Modern computers may be able to perform a multitude of simple operations within the shortest period possible, but in the decision process with respect to whether a cargo request for a particular flight may be accepted or not, many such parameters that moreover depend on one another and that also change upon acceptance of each cargo transport request are to be taken into account, such that unambiguous EDP-supported decisions may not easily be made within a second, for example. In this connection, it must be taken into account that the computers to be used for passenger and cargo service must process several thousand transactions per second at peak times (see Durham, “The Future of SABRE,” in The Handbook of Airline Economics, D. Jenkins (ed.), The Aviation Weekly Group of the McGraw-Hill Companies, New York, N.Y., 469-482, 1995).

U.S. Pat. No. 6,263,315 B1 describes, for example, a Revenue Management System that strives to be able to appropriately respond to air cargo requests independent of the resources available, on the basis of the evaluated figures based on experience. This is a development of the so-called nested capacity provision first introduced by K. Littlewood (“Forecasting and Control of Passenger Bookings,” British Overseas Airways Corp. (10/1972)). According to Littlewood, booking requests related to flights that also offer reasonable fares, e.g., for early booking, are to be accepted for as long as revenue achieved therewith exceed the revenue to be expected, based on future bookings at normal tariff. According to U.S. Pat. No. 6,263,315, the particular resources may be classified with multidimensional tableaus as function of the capacity. With this method, it should be possible to respond appropriately to changes in capacity. For example, the limit to be exceeded for each cargo acceptance is readjusted after each cargo request effected. This should avoid prematurely assigning extra charges to a cargo request that excessively takes up much cargo space, although these in themselves do not cover the cargo costs and/or the remaining cargo capacity would also not be sufficient, or be hardly sufficient, to maintain a cost-covering flight.

U.S. Pat. No. 6,526,392 B1 generally deals with EDP-supported systems for the optimized provision of resources in passenger and air cargo service, and in this connection, uses the so-called linear programming, among other things.

In order to minimize the flight costs for a single flight, U.S. Pat. No. 6,134,500 suggests using a four-dimensional dynamic program-supported search algorithm. This approach to the solution should be applicable both to passenger as well as to cargo flights.

U.S. Pat. No. 6,085,164 likewise deals with the provision of cargo transport and passenger transport capacities at reasonable prices. In the process, the optimized price is always calculated independently of the current request.

Most systems and methods for optimizing the utilization of cargo capacities handle reference quantities, such as cargo volume, cargo weight, maximum volume capacity, and the maximum allowable total cargo weight for a flight. Moreover, Kasilingam (http://soom.utdallas.edu/c4isn/isn_seminars-cscmc.htm) takes an approach that simultaneously shows the density and the volume weight respectively of the particular individual load with the price to be estimated. In cargo trade in Continental Europe, the volume weight is often chosen as the reference quantity, while in the Anglo-Saxon region, the density is normally used. The volume weight generally serves as basis for fee computation, together with the chargeable weight and the rate. Moreover, the volume weight is referred to when computing the specific weight and volume consumption of the chargeable weight of a cargo shipment.

In an agreement with the International Air Transport Association (IATA), a so-called standard density and a so-called standard volume weight respectively was established some time ago with the unit m³/t. This standard volume weight is currently at 6 m³/t. Accordingly, cargo with a volume weight between 0 and the standard volume weight (inclusive) is charged according to the weight, and cargo with an actual volume weight above the standard volume weight is charged by volume, expressed in chargeable kilogram.

Since air cargo service normally involves parcel service, the cargo is divided into classes for predicting the flow of transport or cargo to be expected for a particular flight. This is because if each individual ordinary cargo were considered as an independent class, there would be an inappropriately high computational expense just to be able to give somewhat reliable forecasts on the cargo to be expected. The cargo classes should therefore be kept within a reasonable scope and nevertheless be suitable for summing up similar cargo or cargo elements in a class so that these may then be handled as a unit.

At present, in the air cargo business, either the rate per weight unit, the volume weight (or the density) or the shipment revenue is used for grouping (see Kasilingam, a.a.O.; I. Z. Karaesmen, Dissertation, Three Essays on Revenue Management, Columbia University, 2001; Sabre, http://www.sabre.com/products/airline/pdf/CargoRevMgmt.pdf). For this type of grouping, cargo with a volume weight of, for example, 1 m³/t and cargo with a volume weight of, for example, 2 m³/t, will be regarded in a similar manner as cargo with volume weight values of 3 and 4, 5 and 6, or 7 and 8 m³/t. Assuming that the specific volume consumption for volume weight values in the range of 0 up to and including the standard volume weight is derived from the quotient of the actual volume weight to standard volume weight, and the specific volume consumption for volume weight values in the range between the standard volume weight and infinity is derived from the quotient of standard volume weight to actual volume weight, it has been established that the specific volume consumption behaves proportionally to the volume weight only for values between zero and the standard volume weight. On the other hand, for volume weight values over the standard volume weight, the specific weight consumption does not decrease in measurement when the specific volume consumption increases for volume weight values below the standard. The further the volume weight lies beyond the standard volume weight, the less adequate the similarity of a chargeable kilogram is shown in the specific weight and volume consumption.

Furthermore, the disadvantage in this method is that the similarity of two volume weights does not indicate whether one of the values is infinite. Cargo to which the infinite volume weight value is allocated is quite unusual in air traffic. For example, for an already booked shipment of a subsequent increase in volume, the infinite value is allocated to the volume weight. After all, the volume weight of the chargeable weight cannot likewise be visualized since the value range of the volume weight extends from zero to infinite. Moreover, the intercept between the standard volume weight and the infinite value is over-represented. Without a scaling of the volume weight, this intercept is longer than the section between the value zero and the standard volume weight. This means that the variation of the specific volume consumption for the same specific weight consumption is shown differently from the variation of the specific weight consumption for the same specific volume consumption, i.e., the weight and volume dimensions are not equal with respect to the chargeable weight. Karaesmen, op cit, page 60, currently leaves it open as to how an optimal classification, with which the actual similar cargo can be allocated to one another, can be created based on the volume weight, in view of the situation shown. According to Karaesmen, there have until now not been any systems for adequately subdividing the weight/volume space that are manageable in terms of size, and at the same time, appropriately represent reality. On the contrary, current attempts would not go beyond outlining the problems relating to cargo revenue management and comparing the existing systems for air cargo and passenger service.

All existing systems and methods for the optimal utilization of cargo space in a cargo transport have until now not led to a satisfactory approach for obtaining, in the most reliable manner, optimal cargo space loading for optimal revenue while utilizing the existing resources.

The task of the present invention, therefore, is to present a system or a method with which the cargo capacity of any cargo transport, in particular of air cargo transport, in particular also from the standpoint of revenue, can be utilized as optimally as possible, without having to rely on very time-consuming EDP-supported systems that attempt to show the extremely complex, mutually dependent correlations in cargo traffic.

### BRIEF DESCRIPTION OF THE DRAWINGS

The following figures illustrate special embodiments of the present invention without restricting its scope.

FIG. 1 shows an r/sd diagram for a special segment of a flight;

FIG. 2 shows multiple possible scales of the volume weight;

FIG. 3 shows a diagram relating to the specific volume consumption and the specific weight consumption in relation to the chargeable weight cw as a function of the scaled volume weight and/or as a function of the unscaled volume weight for cargo having volume weight values smaller than the standard volume weight;

FIG. 4 shows a diagram relating to the specific volume consumption and the specific weight consumption in relation to the chargeable weight cw as a function of the unscaled volume weight for cargo having volume weight values greater than the standard volume weight;

FIG. 5 shows a diagram relating to the specific volume consumption and the specific weight consumption in relation to the chargeable weight cw as a function of the scaled volume weight for cargo having volume weight values greater than the standard volume weight;

FIG. 6 shows an r/sd diagram, containing a bid price curve of a specific flight segment as a function of the scaled volume weight for cargo having volume weight values between the value zero and the value infinity;

FIG. 7 shows a cw/sd diagram (a primal graph), in which the probable unused remaining chargeable weight cw of a specific flight segment is plotted as a function of the scaled volume weight;

FIG. 8 shows a cw/sd diagram (a primal graph), in which the probable unused remaining chargeable weight cw of a specific flight segment is plotted as a function of the scaled volume weight;

FIG. 9 shows an r/sd diagram (a dual graph), in which the capacity access price (the bid price) of a specific flight segment is plotted as a function of the scaled volume weight; and

FIG. 10 shows an r/sd diagram (a dual graph), in which the capacity access price (the bid price) of a specific flight segment is plotted as a function of the scaled volume weight.

### DETAILED DESCRIPTION

Disclosed herein are systems and methods for optimizing the utilization of a cargo space and for maximizing the revenue from a cargo transport. In one exemplary embodiment, a method is provided in which
for a cargo transport, incoming transport requests for cargo units n are recorded, in particular for each transport request, with regard to its volume Vₙ, preferably in the unit m³, with regard to its weight Wₙ, preferably in the unit t, and, in given cases, with regard to its rate rₙ as price, preferably in an officially recognized currency unit, per chargeable weight unit cw, preferably in chargeable k_{g},
the volume weights dₙ of the cargo units n, preferably in m³/t, are determined in the course of which,
   if the weight Wₙ of the n^{th} cargo unit>0 and volume Vₙ of the n^{th} cargo unit≧0, then the volume weight dₙ=(Vₙ/Wₙ),
   if the weight Wₙ of the n^{th} cargo unit=0 and volume Vₙ of the n^{th} cargo unit>0, then the volume weight dₙ=∞, and
   if the weight Wₙ of the n^{th} cargo unit=0 and the volume Vₙ of the n^{th} cargo unit=0, then the volume weight dₙ is indeterminate,
based on the determined volume weight dₙ, the scaled volume weight sdₙ is determined, in which,
   if dₙ=0, then sdₙ=0,
   if 0<dₙ≦ds, then sdₙ=dₙ/2ds,
   if ds<dₙ<∞, then sdₙ=1−ds/2dₙ, and
   if dₙ=28 , then sdₙ=1,
in which ds is a given standard volume weight, preferably in m³/t, which may, in some embodiments, correspond to the standard volume weight ds_{IATA} of the IATA;
determining whether the scaled volume weight sdₙ of the transport request for the n^{th} cargo unit has an extremely scaled volume weight sdₙ, which lies in a range of 0≦sdₙ≦0.5 or of 0.5<sdₙ<1, preferably in a range of 0≦sdₙ≦0.4 or of 0.6≦sdₙ≦1 and particularly preferably, in a range of 0≦sdₙ≦0.2 or of 0.8≦sdₙ<1, and
accepting the transport request, if this exhibits an extremely scaled volume weight sdₙ, insofar as the maximum capacity of cargo volume Vₘₐₓ and the maximum capacity of cargo weight Wₘₐₓ is not exceeded with the acceptance of the n^{th} transport request.

In one embodiment, a transport request is additionally accepted only when, upon acceptance of this transport request for a cargo unit n, the remaining remainder volume Vᵣₑₘ and the remaining remainder weight Wᵣₑₘ, with reference to the total capacities Vₘₐₓ and Wₘₐₓ, allows a non-extremely scaled volume weight of the total loading, theoretically still possible and/or expected, which corresponds or comes close to the standard volume weight ds. Optimized booking or loading of a cargo transport with cargo units of mixed volume weights, i.e., cargo transport with a so-called density-mix that maximizes the chargeable weight, is managed in this manner.

For example, it is also conceivable for the ratio of the available remaining volume capacity Vᵣₑₘ to the available remaining weight capacity Wᵣₑₘ to change during the booking period, such that loading with a non-extremely scaled volume weight over all bookable cargo units is achievable only if either the cargo with very low, e.g., very extreme volume weight is combined with cargo that exhibits a scaled volume weight in the range of 0.5<sd<1, or if the cargo with very high, i.e., very extreme volume weight, is combined with cargo that exhibits a scaled volume weight in the range of 0≦sd<0.5.

Accordingly, one advantageous development of a method according to the present invention is distinguished in that
transport requests are recorded for a cargo transport for cargo units n, in particular for each transport request, with respect to its volume Vₙ, preferably in the unit m³, and its weight Wₙ, preferably in the unit t, and if necessary its rate rₙ as price, preferably in an officially recognized currency unit, is denoted preferably in chargeable kg, for every chargeable currency unit,
the volume weights dₙ of the cargo units n are determined, in the course of which
   if the weight Wₙ of the n^{th} cargo unit>0 and the volume Vₙ of the n^{th} cargo unit≧0, then the volume weight dₙ=(Vₙ/Wₙ),
   if the weight Wₙ of the n^{th} cargo unit=0 and volume Vₙ of the n^{th} cargo unit>0, then the volume weight dₙ=∞, and
   if the weight Wₙ of the n^{th} cargo unit=0 and the volume Vₙ of the n^{th} cargo unit=0, then the volume weight dₙ is indeterminate,
the scaled volume weight sdₙ is determined based on the determined volume weight dₙ, in which,
   if dₙ=0, then sdₙ=0,
   if 0<dₙ<ds, then sdₙ=dₙ/2ds,
   if ds<dₙ<∞, then sdₙ=1−ds/2dₙ, and
   if dₙ=∞, then sdₙ=1,
in which ds is a given standard volume weight, which may, in some embodiments, correspond to the standard volume weight ds_{IATA} of the IATA;
the capacity of volume Vᵣₑₘ still available is determined, while taking into consideration the maximum capacity of cargo volume Vₘₐₓ, and the capacity of weight Wᵣₑₘ still available is determined, while taking into consideration the maximum capacity of cargo weight Wₘₐₓ,

the volume weight dₖ of the capacity still available is calculated, via dₖ=Vᵣₑₘ/Wᵣₑₘ, with Vᵣₑₘ preferably in the unit m³ and Wᵣₑₘ preferably in the unit t, and
if dₖ=0, then sdₖ=0,
if 0<dₖ≦ds, then sdₖ=dₖ/2ds,
if ds<dₖ<∞, then sdₖ=1−ds/2dₖ, and
if dₖ=∞, then sdₖ=1, in which sdₖ represents the scaled volume weight of the capacity dₖ still available, and in which
   if the weight Wᵣₑₘ>0 and the volume Vᵣₑₘ≧0, then the volume weight dₖ=(Vᵣₑₘ/Wᵣₑₘ),
   if the weight Wᵣₑₘ=0 and the volume Vᵣₑₘ>0, then the volume weight dₖ=∞, and
   if the weight Wᵣₑₘ=0 and the volume Vᵣₑₘ=0, then the volume weight dₖ is indeterminate,
it is determined whether the scaled volume weight sdₖ of the capacity available is smaller, greater, or the same as 0.5, and
   if sdₖ<0.5, the transport request is accepted if sdₙ<sdₖ or if 0≦sdₙ<0.5, in particular 0≦sdₙ≦0.4 and particularly preferred 0≦sdₙ<0.2,
   if sdₖ>0.5, the transport request is accepted if sdₙ>sdₖ or if 0.5≦sdₙ<1, in particular 0.6≦sdₙ≦1 and particularly preferred 0.8≦sdₙ≦1 and
   if sdₖ=0.5, the transport request is accepted if 0≦sdₙ<0.5 or 0.5<sdₙ≦1, preferably 0≦sdₙ<0.4 or 0.6≦sdₙ≦1 and particularly preferred 0≦sdₙ≦0.2 or 0.8≦sdₙ≦1,
insofar as the maximum capacity of cargo volume Vₘₐₓ and the maximum capacity of cargo weight Wₘₐₓ is not exceeded with the acceptance of the n^{th} cargo transport request.

The standard volume weight may be set in an embodiment at 5 or 6 m³/t, which involves the standard volume weight currently established by the IATA. The standard volume weight plays such a great role because it represents the central determinants of the chargeable weight. Moreover, this value currently reflects the average actual conditions, i.e., experience shows that the ratio of volume to weight for air cargo goods is currently around 6 m³/t (possibly around 5 m³/t in the future). Correspondingly, even the cargo transporters are normally designed these days in such a way that they exhibit an available maximum volume capacity and an available maximum weight capacity, which is adapted to the previously mentioned value of the standard volume weight. For purposes of the present invention, the standard volume weight represents the volume weight value until the (inclusive) cargo is charged by weight or based on weight, and charged by volume above the cargo, in the present case expressed in chargeable weight, in particular in chargeable kilogram.

The volume weight dₖ of the capacity still available, i.e., of the capacity supply, is to be strictly differentiated from the standard volume weight ds and may be equal or not equal to ds. For example, it is possible for an available cargo transporter to not be designed from the start in such a way that it exhibits a ratio of available maximum volume capacity to available maximum weight capacity, which corresponds to the standard volume weight in accordance with the IATA.

A cargo unit for purposes of the present invention may be made up of a single cargo or several individual cargos that are supposed to be handled or transported as one unit, for example. The cargo space for purposes of the present invention consists of the cargo space of a cargo transport, e.g., of a cargo aircraft, just like the space remaining in passenger aircraft after taking the passenger baggage into account so that ordinary cargo can still be taken on.

Basically, in the context of the present invention, in the case of 0≦d<ds, one speaks of extreme, high volume weight d and in the case of ds<d≦∞, of an extreme, low volume weight. If d is equal to ds, as already set out, a non-extreme standard volume weight exists. In the present method, the volume weight of cargo shipments or cargo units of a grouping that optimally uses the resources is made accessible for the first time. For this, it is necessary to use the scaled volume weight instead of the volume weight. The success according to the present invention becomes apparent in particular when cargo units are combined for a cargo transport, the cargo units greatly diverging in their particular, scaled volume weights, as set out above. An optimized volume weight mix or density mix of cargo units to be taken on is regularly managed using the method according to the present invention.

In cargo transports, it may happen that the cargo transporter is used only on one route in the round-trip traffic. It is much more common for one or several intermediate stops to be inserted until the destination, during which time cargo is partially or completely unloaded and new cargo is loaded. The same applies to such transports in which the transporter arrives once again at the origin via several intermediate stops. The connection between two consecutive stops, i.e., the route between the possible or actual start of a transport from an origin or an intermediate stop and its next stop, is generally described as a leg, in particular in air cargo traffic. Correspondingly, transport with one or several intermediate stops may be subdivided into several consecutive legs. If cargo is transported via one or several such consecutive legs, each transport route is referred to as a segment. For example, a cargo flight from A to D via the stops B and C includes the three legs A-B, B-C and C-D as well as the six segments A-B, A-C, A-D, B-C, B-D and C-D. A (cargo) flight of a particular flight number may consequently be divided into legs, segments, and flight, provided that there is at least one intermediate stop.

In the same manner as the methods according to the present invention are applicable to legs, segments, and flights, even entire air route networks can be denoted with these labels. This involves at least two flights with differing flight numbers. Because even in the transport of cargo in an air route network, an advantage of the present invention becomes apparent in the use of the scaled volume weight or scaled density. The R_{F} revenue is regularly determined via the entire flight (single flight optimization) or the air route network (air route network optimization), while the capacity offer is estimated or calculated on the level of individual legs and the forecasted demand for cargo space for cargo units to be transported on the segment level, i.e., the origin and destination in terms of a flight number, or on the O&D-level, i.e., the origin and destination in terms of an air route network. Transport requests are correspondingly made regularly on a segment level, i.e., within a flight, or on an O&D level, i.e., within an air route network.

Methods and systems according to the present invention, as set out in the present description and the claims, essentially make use of the following primary units, insofar as not expressly defined otherwise:

| | |
|---|---|
| Chargeable weight cw | [chkg] |
| Weight G | [kg] |
| Volume V | [m³] |
| Currency | [currency unit]. |

Furthermore, the following actual and/or forecasted scales are used:

| | |
|---|---|
| Cargo revenue of the n^{th} cargo unit [currency unit] | rₙ |
| Cargo revenue of a flight or | R_{F} |
| of an air route network [currency unit] | |
| Volume [m³] or also [chargeable weight (chkg)] | V |
| Weight [kg] or also [chargeable weight (chkg)] | W |
| Volume weight [m³/t] | d |
| Rate [currency unit/chargeable weight (chkg)] | rₙ |
| Bid price [currency unit/chargeable weight (chkg)] | bp |
| Weight-bid-price | bpw |
| [Currency unit/chargeable weight (chkg)] | |
| Volume-bid-price | bpv |
| [Currency unit/chargeable weight (chkg)] | |
| Profitability | p |
| [Currency unit/chargeable weight (chkg)] | |

These above-specified primary and secondary units and scales may refer to a particular cargo transport demand forecast and a concrete transport request as well as to a leg, a segment, a flight, or an air route network. In the event that such concrete reference matters come up for the methods and systems according to the present invention, it is correspondingly indicated. In general, the cargo revenue is determined as far as an (entire) flight is concerned. In the transport request or forecasted demand, individual segments of a flight are regularly taken into account, on the other hand. The volume and weight capacities are in turn regularly determined as far as a leg is concerned. The above described allocations are preferably relevant even for the embodiments of the present invention.

The methods and systems according to the present invention may be applied to individual legs, to segments, as well as to the entire transport path from the origin to the destination.

Even though the present description principally takes into account the volume weight or the scaled volume weight of cargo or cargo units, their density or scaled density can of course also be brought into play in the same manner as a reference quantity. In such an event, all the particulars that refer to the volume weight are to be modified correspondingly to density particulars as a reference quantity. Since density and volume weight behave reciprocally to one another, the transition from volume weight to density and vice versa in the above claimed method and systems is well within the ability of one having ordinary skill in the art.

One exemplary embodiment of the present invention is furthermore provided by way of a method, in which
transport requests received for a cargo transport for cargo units n are denoted or shown with respect to its volume Vₙ, in particular in the unit m³, its weight transport Wₙ, in particular in the unit t, its chargeable weight cw, preferably in chargeable kg, and its rate rₙ per chargeable weight cw of the cargo unit n is denoted or shown
the volume weight d, of the cargo units n is determined, in the course of which
   if the weight Wₙ of the n^{th} cargo unit≧0 and the volume Vₙ of the n^{th} cargo unit is≧0, then the volume weight dₙ=(Vₙ/Wₙ),
   if the weight Wₙ of the n^{th} cargo unit is=0 and the volume Vₙ>0, then the volume weight dₙ=0,
   if the weight Wₙ of the n^{th} cargo unit is=0 and the volume Vₙ=0, then the volume weight dₙ is indeterminate,
based on the determined volume weight dₙ, the scaled volume weight sdₙ is determined, in which,
   if dₙ=0, then sdₙ=0,
   if 0<dₙ<ds, then sdₙ=dₙ/2ds,
   if ds<dₙ<∞, then sdₙ=1−ds/2dₙ, and
   if dₙ=∞, then sdₙ=1,
in which ds is a standard volume weight, which in some embodiments may correspond to the standard volume weight ds_{-IATA} of the IATA;
on the basis of the determined quantity of scaled volume weights sdₙ, at least two, in particular four, volume weight classes Kₓ with lower and upper class limits d_{g} are formed, in which no class Kₓ is formed, which exhibits a lower limit having an sd-value<0.5 and an upper limit having an sd value>0.5,
the volume weights of class limits d_{g} are calculated such that,
   if sd_{g}=0, then d_{g}=0,
   if 0<sd_{g}≦0.5, then d_{g}=2 sd_{g}×ds,
   if 0.5<sd_{g}<1, then d_{g}=ds/(2−2sd_{g}), and
   if sd_{g}=1, then d_{g}=∞, and
the cargo units n are allocated to the volume weight classes Kₓ(dₙ).

An embodiment of the above described method is distinguished in that through each class Kₓ, the chargeable overall weight is determined by adding the chargeable weight of the cargo units n classified in a class.

The class limits are preferably selected such that the class limits d_{g} are kept at the greatest distance possible from classes Kₓ, which do not contain any chargeable weight or to which no chargeable weight can be allocated.

In an alternative embodiment, the class limits are selected in distances that are essentially equidistant, based on the scaled volume weight. In particular, the formation of a maximum of 12 consecutive classes in the limits zero to one, with reference to the scaled volume weight sd, each with the same class width, has proven very suitable. Adjoining classes each exhibit a common class limit.

Furthermore, it is not detrimental if, in selecting equidistant class limits, one or several of these run through an accumulation or cluster of volume weight values sdₙ.

An exemplary embodiment of the present invention is furthermore provided by way of a method, in which
transport quantities forecasted for a cargo transport are recorded with respect to its volume Vₘ, in particular in the quantity unit m³, its weight Wₘ, in particular in the quantity unit t, and its request price rₘ for the chargeable weight cw, preferably in chargeable kg of the cargo quantity m,
the volume weight dₘ of the cargo quantities m is determined, in which
   if the weight Wₘ of the cargo quantity m≧0 and the volume Vₘ of the cargo quantity m≧0, then the volume weight dₘ=(Vₘ/Wₘ),
   if the weight Wₘ of the cargo quantity m=0 and the volume Vₘ>0, then the volume weight dₘ=∞, and
   if the weight Wₘ of the cargo quantity m=0 and the volume Vₘ=0, then the volume weight dₘ is indeterminate,
based on the determined volume weight dₘ, the scaled volume weight sdₘ is determined, in which,
   if dₘ=0, then sdₘ=0,
   if 0<dₘ≦ds, then sdₘ=dₘ/2ds,
   if ds<dₘ<∞, then sdₘ=1−ds/2dₘ, and
   if dₘ=∞, then sdₘ=1, in which ds is a standard volume weight, which in some embodiments may correspond to the standard volume weight ds_{IATA} of the IATA;
on the basis of the forecasted quantity, at least two, in particular four, volume weight classes K_{z} with the scaled volume quantities sdₘ, with lower and upper class limits d_{f} are formed, in which no class K_{z} is formed, which exhibits a lower limit having an sd-value<0.5 and an upper limit having an sd value>0.5,
the volume weights d_{f} of class limits are calculated such that,
   if sd_{f}=0, then d_{f}=0,
   if 0<sd_{f}≦0.5, then d_{f}=2 sd_{f}×ds,
   if 0.5<sd_{f}<1, then d_{f}=ds/(2−2sd_{f}), and
   if sd_{f}=1, then d_{f}=∞, and
the cargo quantities m to the determined volume weight classes K₂(dₘ).

An embodiment of the above described method is distinguished in that, through each class K₂, the chargeable overall weight of all cargo quantities m that are classifiable in a class is determined.

The class limits are preferably selected such that the class limits d_{f} are kept at the greatest distance possible from classes K_{z}, which do not contain any chargeable weight or to which no chargeable weight can be allocated. Furthermore, it is not detrimental if, in selecting equidistant class limits, one or several of these run through an accumulation or cluster of volume weight values sd_{f}.

For purposes of the present invention, the term cargo quantity m is used in connection with the forecasted or expected cargo. An expected cargo quantity may, for example, based on statistically prepared historical values, be classified with respect to its volume weight dₘ and its rate rₘ, in which these values are to be interpreted not as precise values but rather as rough values. Thus, it is likewise possible for a cargo quantity m to already define a class K_{z}.

The grouping according to the present invention of volume weights based on the scaled volume weight makes it possible for the first time to realistically take into account even transport requests or in particular transport updates for which a weight of 0 t or a volume of 0 m³ has been allocated. It is also possible, through the scaled volume weight, to determine the similarity or non-similarity of cargo charged by volume with cargo charged by weight. Optimized loading of a cargo transporter is facilitated in this manner. On the one hand, it can be reliably determined whether cargo units are to be classed similarly, and on the other hand, it can likewise be reliably determined whether the volume weights of cargo units sufficiently differ. An actual transport request may then be accepted if its subject is a cargo unit, whose volume weight is to be allocated to a volume weight class Kₓ or K_{z}, whose volume weight values are to be classified as extreme, provided that the maximum capacity of cargo volume Vₘₐₓ and the maximum capacity of cargo weight Wₘₐₓ is not exceeded with the acceptance of the n^{th} cargo transport request.

In accordance with one exemplary embodiment of the method according to the present invention, in particular to optimize the cargo revenue, it is provided for the chargeable weight cw or indirectly the rate rₙ to be determined for a cargo unit n based on the weight Gₙ, if the scaled volume weight sdₙ<0.5, and be determined based on the volume Vₙ, if the scaled volume weight sdₙ>0.5.

In accordance with the present invention, it may furthermore be provided for the chargeable weight cw to be defined as follows:
if the weight Wₙ in t is equal to 0 and the volume Vₙ in m³ is equal to 0, then cw=0,
if 0≦dₙ≦ds, then cw=Wₙ×1000 and
if ds<dₙ≦∞, then cw=Vₙ×1000/ds.

An exemplary embodiment of the present invention is furthermore provided by way of a method, in which
a quantity of incoming cargo transport requests is defined by the particular request volume Vₙ, request weights Wₙ and achievable rates rₙ, expressed as price of the chargeable weight cw, preferably in chargeable kg, as well as volume weight dₙ and the scaled volume weight sdₙ; in which
the volume weight dₙ of a cargo unit n is determined as follows:
   if the weight Wₙ of the n^{th} cargo unit>0 and the volume Vₙ of the n^{th} cargo unit≧0, then the volume weight dₙ=(Vₙ/Wₙ)
   if the weight Wₙ of the n^{th} cargo unit=0 and volume Vₙ of the n^{th} cargo unit≧0, then the volume weight dₙ=∞,
   if the weight Wₙ of the n^{th} cargo unit=0 and the volume Vₙ of the n^{th} cargo unit=0, then the volume weight dₙ is indefinite, and
based on the determined volume weight dₙ, the scaled volume weight sdₙ is determined, in which,
   if dₙ=0, then sdₙ=0,
   if 0<dₙ≦ds, then sdₙ=dₙ/2ds,
   if ds<dₙ<∞, then sdₙ=1−ds/2dₙ, and
   if dₙ=∞, then sdₙ=1,
in which ds is a given standard volume weight, which may correspond in some embodiments to the standard volume weight ds_{IATA} of the IATA;
a two-dimensional range is defined, including two intersecting coordinate axes, whose first dimension directly or indirectly represents the range of scaled volume weight sdₙ that may be requested in the cargo transport requests, and whose second dimension represents the request rate rₙ, defined as price per chargeable weight cw, in which
the sum of the chargeable or billable weight cw, preferably in chargeable kg, is defined as follows:
   if the weight Wₙ=0 and the volume Vₙ=0, then cw=0,
   if 0≦dₙ<ds, then cw=Wₙ×1000 and
   if ds<dₙ<∞, then cw=Vₙ×1000/ds,
in the two-dimensional region of the coordinate system formed by the coordinate axes, to each of the value pairs formed from the scaled volume weight sdₙ of a requested n^{th} cargo unit and its requested rate rₙ, assigning a corresponding value pair point and determining the distances between value pair points whose corresponding scaled volume weights sdₙ are in the range 0<sdₙ<0.5, as well as the distances between value pair points whose corresponding scaled volume weight sdₙ are in the range 0.5<sdₙ≦1, and grouping value pair points within these limits, in particular those at a small distance from one another, to form clusters and assigning each to a subregion (r/sd class) i with region limits within which there are value pairs of a cluster. According to a further development of the previously described method, for each subregion, the billable weights of the individual cargo requests which belong to this subregion are added and the total assigned to the corresponding subregion. In this way, for each subregion, which preferably contains one cluster but can also include an additional subdivided cluster, an historical evaluation of the requested total billable weight Dᵢ can be made. These historical data, in given cases also prepared statistically, can then be used as forecast values for the expected request Dᵢ in future transports, for example, transport flights, in order to be used as the basis for future booking decisions. Obviously, the forecast can also be accomplished in other ways. For example, currently foreseeable events or market activities can be taken into account in the preparation of a forecast, which then leads to a quite different result than with the use of the historical approach.

A problem underlying the invention is furthermore solved by a process according to which
for a cargo transport, forecasted cargo quantities m are recorded with regard to their volume Vₘ, in particular in the amount unit m³, with regard to their weight Wₘ, in particular in the unit t, with regard to their requested price rₘ expressed as price of the chargeable weight cw, preferably in chargeable kg, with regard to their volume weight dₘ, and with regard to their scaled volume weight sdₘ,
the volume weight dₘ of the cargo units is determined, where
   if the weight Wₘ of the cargo quantity m>0 and the volume Vₘ of the cargo quantity m≧0, then the volume weight dₘ=(Vₘ/Wₘ),
   if the weight Wₘ of the cargo quantity m=0 and the volume Vₘ of the cargo quantity m>0, then the volume weight dₘ=∞, and
   if the weight Wₘ of the cargo quantity m=0 and the volume Vₘ of the cargo quantity m=0, then the volume weight dₘ is indeterminate,
   based on the determined volume weight dₘ, the scaled volume weight sdₘ is determined, where,
      if dₘ=0, then sdₘ=0,
      if 0<dₘ≦ds, then sdₘ=dₘ/2ds,
      if ds<dₘ<∞, then sdₘ=1−ds/2dₘ, and
      if dₘ=∞, then sdₘ=1,
   where ds is a given standard volume weight which may in some cases conform to the standard volume weight ds_{IATA} of the IATA,
a two-dimensional region including two intersecting coordinate axes is defined, where the region's first dimension indirectly or directly represents the range of the scaled volume weight sd requested in the cargo transport requests and the region's second dimension represents the requested rate r defined as price of the chargeable weight cw, where the chargeable or billable weight cw, preferably in chargeable kg, is defined as follows:
   if Wₘ=0 and the volume Vₘ=0, then cw=0,
   if 0<dₘ≦ds, then cw=Wₘ×1000,
   if ds<dₘ≦∞, then cw=Vₘ×1000/ds,
the value pairs, calculated from the scaled volume weight sdₘ of a forecast cargo quantity m and its forecast demand rate rₘ, are each assigned to a corresponding value pair point in the two-dimensional region of the coordinate system formed by the coordinate axes and the distances between value pair points, whose associated scaled volume weight sdₘ is, in the range 0<sdₘ<0.5, and the distances between value pair points, whose associated scale volume weight sdₘ is in the range 0.5<sdₙ<1, are each determined and value pair points within these boundaries, in particular those which have a low distance to one another, are collected by forming clusters and each assigned to a subregion i (r/sd class) having region boundaries, within which the value pairs of a cluster lie.

In this case, according to the present invention, on the basis of the established clusters at least eight, particularly 16, r/sd subclasses i, particularly having equidistant volume weight class boundaries and/or having equidistant rate class boundaries, are calculated, no r/sd subclass i being formed which has a lower boundary having an sd value<0.5 and an upper boundary having an sd value>0.5. Accordingly, a preferred embodiment is distinguished in that all subclasses i in the coordinate system fill up approximately the same area. Neighboring classes each have a shared class boundary in this case. Furthermore, it is not harmful if, when selecting equidistant class boundaries, one or more of these run through an accumulation and/or a cluster of r/sd value pairs.

A refinement of the method described above is distinguished in that the chargeable total weight Dᵢ may be determined via each r/sd subclass i by adding the chargeable weight cw of the cargo units n and/or forecast cargo quantities m classified in a class.

In an alternative embodiment, sd and r subclass boundaries are selected in such a way that those subclasses to which no chargeable weight may be assigned occupy the largest possible area, in particular even if the subregions have parallel class boundaries.

In this case, in a further embodiment, neighboring subregions expediently have shared region boundaries and/or delimitation lines and all subregions continuously cover an area which is delimited by the intersecting coordinate axes. If these coordinate axes are perpendicular to one another, the subregions preferably occupy a rectangular or square area. If the coordinate axes are not perpendicular to one another, in contrast, the subregions preferably have the shape of a parallelogram. According to a pragmatic embodiment, the coordinate axes representing the scaled volume weight may be subdivided into at least four, particularly ten, preferably equally large sections, while the coordinate axes representing the rate may be subdivided into at least three, particularly at least five, for example, five to ten sections. In this way, for example, 20 to 100 subregions and/or r/sd classes result.

The use of the scaled volume weight according to the method according to the present invention is connected with the advantage that a two-dimensional coordinate system is obtained as a reference system and changes of the specific volume consumption and changes of the specific weight consumption may be imaged on the coordinates of the scale volume weight in a way comparable to one another. Thus, the specific weight consumption at volume weight values above the standard volume weight ds decrease proportionally to the increase of the specific volume consumption at volume weight values below the standard volume weight ds. Therefore, each movement on the coordinate, typically the abscissa, of the scaled volume weight—if it is only equally long—results in an equal dissimilarity of a chargeable kilogram in regard to its specific weight and volume consumption. For example, the movement from a volume weight having the value 9 to a value 12 produces the identical dissimilarity as the movement from a volume weight value 0 to a volume weight value of 1. This is because in the first case, the specific weight consumption sinks by ⅙ chargeable kilogram, and in the second case, the specific volume consumption rises by ⅙ chargeable kilogram, if a standard volume weight of 6 m³/t is used as a basis.

Known cluster methods may be used for determining suitable subregions and/or r/sd classes. For example, hierarchical cluster methods such as the clusters according to “average linkage,” “single linkage,” “complete linkage,” the centroid method, or the method of minimum variance according to Ward may be used. Furthermore, the K-means clustering to calculate subregions may be considered as a cluster method. The cluster methods described above are known to those skilled in the art and are described, for example, in JMP® Statistics and Graphics Guide, Version 4, (ISBN: 1-58025-631-7), from the SAS Institute Inc., Cary, N.C., USA, 2000. Taking the specifications cited above into consideration, for example, the forecast transport requests may be imaged in classes using these cluster methods, which may then be used for each newly arriving transport request for optimizing and/or maximizing the capacity, the revenue, the chargeable weight, the capacities, and/or the cargo space of a cargo transport.

Using the classification described above of the forecast cargo quantities into rates/scaled volume weight classes, it is possible to generate a comprehensible optimization problem, i.e., one not provided with too many variables, which nonetheless provides approximately exact solution values, e.g., for optimized revenue. In particular, the comprehensible number of classes is suitable for the purpose of being able to prepare request forecasts for each individual class instead of having to use an overall forecast. The forecast on the level of an isolated, specific transport request, in contrast, may also hardly be forecast reliably and would additionally require an disproportionately large computing outlay. The boundaries of the subregions (r/sd classes), also called domains, are to be selected in this case in such a way that subregions which are not too large and, in addition, are not too small, are formed. Too small subregions are cumbersome for effective optimization, while subregions which are selected too large no longer allow precise prediction of the demand in regard to the rate and the volume weight.

In particular, in the event of too small regions, the optimization is difficult because of the predictable quantities, which are typically very small, and the manifold variables. However, with small domains, both the bid price and the preferred extreme volume weight may be determined very accurately when maximizing the chargeable weight cw. In contrast, with large regions, the optimization and the forecast may be produced more easily, however, less exact specifications of the preferred extreme volume weights when maximizing the chargeable weight cw and less accurate bid prices and a less exact revenue are obtained.

The two-dimensional system described above may also be referred to as the rate/volume weight diagram and/or r/sd diagram, in particular when neighboring subregions, if they do not lie at the edges of the diagram, have adjoining boundary lines on all sides. Of course, for every cargo stream, whether it is on a flight comprising only one leg, whether it is on a flight comprising multiple legs, e.g., on a segment level, or whether it is on a flight network, a separate, characteristic rate/volume weight diagram, particularly having its own distribution of the domains, must typically be prepared and/or used.

More preferably, for a cargo unit n and/or a cargo quantity m having a weight Wₙ or Wₘ, respectively, each calculated in t, and volume Vₙ or Vₘ, respectively, each calculated in m³, the value, particularly in kg, which is the largest in absolute value of the following two values is used as the chargeable weight cw
W_{n/m}×1000 and (1)
V_{n/m}×1000/ds, (2)
ds being a standard volume weight which may, in some embodiments correspond to the standard volume weight ds_{IATA} of the IATA.

An embodiment of the present invention is also provided by a method, according to which
a two-dimensional region is defined, comprising two intersecting coordinate axes, whose first dimension directly or indirectly reflects the region of the scaled volume weight sd demandable in cargo transport requests and whose second dimension reflects the rate r, expressed as the price of the chargeable weight cw;
neighboring subregions i having shared boundary sections are formed in the two-dimensional region, which preferably form a continuous area which is delimited along two sides by the intersecting coordinate axes, the subregions i lying in the range 0<sd≦0.5 or in the range 0.5<sd≦1 in regard to their values for the scaled volume weight sd, and
the subregions i each being assigned an expected total value Dᵢ of chargeable weight cw, preferably in chargeable kg, which results from the sum of the expected individual cargo transport requests, whose associated value pairs, calculated from the rate r or chargeable weight cw and the scaled volume weight sd, being assignable to a subregion.

The total value Dᵢ of expected chargeable weight cw assignable to a subregion i may be determined from historical data, as described above, and/or on the basis of forecast values.

Using the calculation described above of r/sd subregions or domains i, the prediction of expected cargo bookings having a specific impression may be designed significantly more efficiently. This is because the subregion boundaries may be selected broadly enough that the problem to be solved in the event of the request, whether a transport request is to be rejected or accepted, may be solved with a comprehensible effort, and, in addition, the subregion boundaries are both to be selected sufficiently narrowly so that the expected value used as a basis still represents a practicable dimension and the bid price for the weight bpw and the bid price for the volume bpv are still to be determined accurately.

The formation of r/sd diagrams containing multiple r/sd subregions i is thus used for the purpose of making the expected request for transport orders on the segment or O&D level, if the transport is requested via multiple flights, handleable and/or for optimizing it. Accordingly, for example, a specific r/sd diagram may be used as the basis for each segment of a flight and/or each O&D of a flight network.

Furthermore, an embodiment of the present invention is provided in that
an incoming transport request for a cargo unit n is accepted if the rate rₙ to be expected is greater than the, particularly probable, lost profit bpₙ connected with the acceptance decision, i.e. the bid price, if the maximum capacity of cargo volume Vₘₐₓ and/or the remaining volume capacity Vᵣₑₘ, and the maximum capacity of cargo weight Wₘₐₓ, and/or the remaining weight capacity Wᵣₑₘ would not be exceeded by accepting the cargo but gained demand, and is otherwise rejected, the lost profit bpₙ being determined and/or estimated via the following equation
   bpₙ=wₙ×bpw+vₙ×pbv,
bpₙ standing for the bid price of a unit of a chargeable weight cw, particularly a chargeable kg, of the requested cargo unit and/or quantity, bpw standing for the price of a unit of a chargeable weight cw, particularly a chargeable kg, which only comprises weight, i.e., has a volume weight of d=0, bpv standing for the price of a unit of a chargeable weight cw, particularly of a chargeable kg, which only comprises volume, i.e., has a volume weight of d=∞, wₙ standing for the specific weight consumption and vₙ standing for the specific volume consumption, the specific weight consumption and/or the specific volume consumption being defined as follows:
if 0≦dₙ≦ds, then wₙ=1 and vₙ=dₙ/ds,
if ds<dₙ<∞, then wₙ=ds/dₙ and vₙ=1, and
if dₙ=∞, then wₙ=0 and vₙ=1,
dₙ reflecting the volume weight of a cargo unit and/or quantity and ds reflecting the standard volume weight, and bpw and bpv being determined by solving the following problem, particularly using linear programming:

$$minimize {R}_{F} = {W}_{r em} \times bpw + {V}_{r em} \times bpv + {\sum }_{i} {D}_{i} \times {p}_{i}$$
subject to
   wᵢ×bpw+vᵢ×bpv+pᵢ≧rᵢ,
   for all (i)
   bpv, bpw, pᵢ≧0,
   for all (i)
R_{F} specifying the revenue, Wᵣₑₘ specifying the still available weight capacity, expressed in chargeable weight cw, particularly chargeable kg, which preferably comprises only weight, i.e., has a volume weight of d=0, Vᵣₑₘ specifying the still available volume capacity, expressed in chargeable weight cw, particularly chargeable kg, which preferably comprises only volume, i.e., has a volume weight of d=∞, Dᵢ specifying the forecast request of the forecast domain and/or the subregion (r/sd class) i, expressed in chargeable weight cw, particularly chargeable kg, and pᵢ specifying the profitability of the forecast domain i, expressed in currency unit per chargeable weight cw, particularly chargeable kg, and rᵢ, expressed as a price, preferably in an officially recognized currency unit, per chargeable weight cw, particularly chargeable kg, specifying the rate of the forecast domain i, and the weight and volume coefficients wᵢ and vᵢ being defined as follows:
   if 0≦dᵢ≦ds, then wᵢ=1 and vᵢ=dᵢ/ds,
   if ds<dᵢ<∞, then wᵢ=ds/dᵢ and vᵢ=1, and
   it dᵢ=∞, then wᵢ=0 and vᵢ=1,
      dᵢ representing a volume weight value from the domain i, which may be a mean value or weighted mean value.

Using the method described above, the revenue from the utilization of the available weight and volume capacities may be maximized more effectively. Bid prices are to be understood as opportunity costs, i.e., bid prices represent the probable costs of the lost profit of an acceptance decision.

In an expedient embodiment, the bid price bpₙ of a possible cargo transport request n is applied as follows:
if rₙ≧bpₙ, the transport request n is to be accepted, if the maximum capacity of cargo volume Vₘₐₓ and/or the remaining volume capacity Vᵣₑₘ, and, the maximum capacity of cargo weight Wₘₐₓ and/or the remaining weight capacity Wᵣₑₘ, is not exceeded by accepting the n^{th} cargo transport request, and
if rₙ<bpₙ, the transport request n is to be rejected, the bid price bpₙ resulting as follows: wₙ×bpw+vₙ×bpv, and rₙ specifying the rate per chargeable weight, wₙ specifying the specific weight consumption and/or the weight coefficients of a transport request, vₙ specifying the specific volume consumption and/or the volume coefficients of a transport request, bpw specifying the price of a unit of a chargeable weight cw, which only comprises weight, and bpv specifying the price of a unit of a chargeable weight cw, which only comprises volume, and the weight and volume coefficients being determined as follows:
   if 0≦dₙ≦ds, then wₙ=1 and vₙ=dₙ/ds,
   if ds<dₙ<∞, then wₙ=ds/dₙ and vₙ=1, and
   if dₙ=∞, then wₙ=0 and vₙ=1.

Furthermore, a method according to the present invention is distinguished in that the bid price bp may be generally represented as a function of the volume weight as follows:
if 0≦d≦ds, then bp=bpw+(d/ds)×bpv,
if ds<d<∞, then bp=ds×bpw/d+bpv, and
if d=∞, then bp=bpv,
bp specifying the bid price, bpw specifying the price of a unit of a chargeable weight cw, expressed in units of a currency per chargeable weight, which only comprises weight, and bpv specifying the price of a unit of a chargeable weight cw, expressed in units of a currency per chargeable weight, which only comprises volume, d specifying the volume weight in general, and ds specifying the standard volume weight.

Alternatively, the bid price bp may also be represented as follows as a function of the scaled volume weight:
if 0≦sd≦0.5, then bp=bpw+2 sd×bpv,
if 0.5<sd<1, then bp=2(1−sd)bpw+bpv, and
if sd=1, then bp=bpv,
bp specifying the bid price, expressed in units of a currency per chargeable weight, bpw specifying the price of a unit of a chargeable weight cw, expressed in units of a currency per chargeable weight, which only comprises weight, and bpv specifying the price of a unit of a chargeable weight cw, expressed in units of a currency per chargeable weight, which only comprises volume, sd specifying the scaled volume weight in general, and ds specifying the standard volume weight.

In a preferred embodiment, the revenue R_{F} of a transport or cargo flight may be maximized as follows with the aid of linear optimization:

maximize

$${R}_{F} = {\sum }_{i} {r}_{i} {x}_{i}$$

subject to

$${\sum }_{i} {w}_{i} {x}_{i} \leq {W}_{re m}$$

$${\sum }_{i} {v}_{i} {x}_{i} \leq {V}_{re m}$$

xᵢ≦Dᵢ, for all (i) and
xᵢ≧0, for all (i),
the index i specifying the forecast domain and/or the subregion (r/sd class), xᵢ specifying the request of the forecast domain i to be accepted, expressed in chargeable weight cw, Dᵢ specifying the forecast demand of the forecast domain i, expressed in chargeable weight cw, wᵢ specifying the weight coefficients of the forecast domain i, vᵢ specifying the volume coefficients of the forecast domain i, Wᵣₑₘ specifying the still available weight capacity, expressed in chargeable weight cw, particularly chargeable kg, which preferably only comprises weight, i.e., has a volume weight of d=0, Vᵣₑₘ specifying the still available volume capacity, expressed in chargeable weight cw, particularly chargeable kg, which preferably only comprises volume, i.e., has a volume weight of d=∞, and rᵢ specifying the rate of the forecast domain i, particularly in the form of a mean value or a weighted mean value, expressed as a price, preferably in an officially recognized currency unit, per chargeable weight cw, particularly chargeable kg, and the weight and volume coefficients wᵢ and vᵢ being defined as follows:
   if 0≦dᵢ≦ds, then wᵢ=1 and vᵢ=dᵢ/ds,
   if ds<dᵢ<∞, then wᵢ=ds/dᵢ and vᵢ=1,
   if dᵢ=∞, then wᵢ=0 and vᵢ=1 and
dᵢ representing a volume weight value from the domain i, which may be a mean value or weighted mean value.

With introduction of slack variables sv and sw for the volume and/or weight calculation, the above problem may be represented as follows (LP problem I):

maximize

$${R}_{F} = {\sum }_{i} {r}_{i} {x}_{i}$$

subject to

$${\sum }_{i} {w}_{i} {x}_{i} + sw = {W}_{re m} , \\ {\sum }_{i} {v}_{i} {x}_{i} + sv = {V}_{re m} ,$$

xᵢ+sᵢ=Dᵢ,
for all (i) and
sᵢ, sv, SW, xᵢ>0,
for all (i),
R_{F} specifying the revenue over one leg of a transport, in particular flight, the index i specifying the forecast domain and/or the subregion (r/sd class), xᵢ specifying the request of the forecast domain i to be accepted, expressed in chargeable weight cw, Dᵢ specifying the forecast demand of the forecast domain i, expressed in chargeable weight cw, wᵢ specifying the weight coefficients of the forecast domain i, vᵢ specifying the volume coefficients of the forecast domain i, Wᵣₑₘ specifying the still available weight capacity, expressed in chargeable weight cw, particularly chargeable kg, which preferably only comprises weight, i.e., has a volume weight of d=0, Vᵣₑₘ specifying the still available volume capacity, expressed in chargeable weight cw, particularly chargeable kg, which preferably only comprises volume, i.e., has a volume weight of d=∞, sᵢ, sv, and sw specifying the slack variables for the request of the forecast domain i, the volume, particularly in the form of a chargeable weight, particularly a chargeable kg, which preferably only comprises volume, i.e., has a volume weight of d=∞, and/or the weight, particularly in the form of a chargeable weight cw, particularly a chargeable kg, which only comprises weight, i.e., has a volume weight of d=0, and rᵢ specifying the rate of the forecast domain i, particularly in the form of a mean value or a weighted mean value, expressed as a price, preferably in an officially recognized currency unit, per chargeable weight cw, particularly a chargeable kg, and
the weight and volume coefficients wᵢ and vᵢ being defined as follows:
   if 0≦dᵢ≦ds, then wᵢ=1 and vᵢ=dᵢ/ds,
   if ds<dᵢ<∞, then wᵢ=ds/dᵢ and vᵢ=1, and
   if dᵢ=∞, then wᵢ=0 and vᵢ=1,
dᵢ representing a volume weight value from the domain i, which may be a mean value or weighted mean value.

For this purpose, the expected demand for transport services of a specific rate/volume weight class i is Dᵢ. The rate corresponding to the rate/volume weight class i is rᵢ. This may assume any arbitrary value from the class i, but preferably represents a mean value or weighted mean value. This applies correspondingly for Dᵢ.

The value of the slack variables sv provides information about the unused capacity in weight to be expected and the value of the slack variables sw provides information about the unused capacity and volume to be expected, each expressed in the present case in chargeable weight of the volume weight 0 or ∞, respectively.

For the case that the cargo capacity has not yet been made use of at all, Wᵣₑₘ=Wₘₐₓ and Vᵣₑₘ=Vₘₐₓ.

Using the present invention, it is possible to select the above-mentioned request in regard to its rate and its specific weight and volume consumption in such a way that the revenue or the chargeable weight is maximal, and the available weight and the available volume are not exceeded. In principle, it is possible using the method described above to calculate and/or estimate the revenue and/or revenue of the still available cargo capacity based on the transport request to be expected. The empty capacities to be expected may also be calculated and/or estimated.

In a further embodiment, a method for optimizing the utilization and/or the maximization of the revenue of a cargo space of a cargo transport may be distinguished in that the revenue R_{F} for one leg of a transport or cargo flight and/or the bid price bpw for one unit of a chargeable weight cw, which only comprises weight, and/or the bid price bpv for one unit of a chargeable weight cw, which only comprises volume, may be determined as follows with the aid of linear optimization:

minimize

$${R}_{F} = {W}_{r em} \times bpw + {V}_{r em} \times bpv + {\sum }_{i} {D}_{i} \times {p}_{i}$$

subject to
wᵢ×bpw+vᵢ×bpv+pᵢ≧rᵢ,
for all (i)
bpv, bpw, pᵢ≧0,
for all (i)
R_{F} specifying the revenue, Wᵣₑₘ specifying the still available weight capacity, expressed in chargeable weight cw, particularly chargeable kg, which preferably comprises only weight, i.e., has a volume weight of d=0, Vᵣₑₘ specifying the still available volume capacity, expressed in chargeable weight cw, particularly chargeable kg, which preferably comprises only volume, i.e., has a volume weight of d=∞, bpw specifying the price of a unit of a chargeable weight cw, which only comprises weight, and bpv specifying the price of a unit of a chargeable weight cw, which only comprises volume, Dᵢ specifying the demand request of the forecast domain and/or the subregion (r/sd class) i, particularly determined according to the method according to the present invention, expressed in chargeable weight cw, particularly chargeable kg, wᵢ specifying the weight coefficients for the forecast domain i, vᵢ specifying the volume coefficients for the forecast domain i, pᵢ specifying the profitability of the forecast domain i, expressed in currency unit per chargeable weight cw, particularly chargeable kg, and rᵢ, expressed as a price, preferably in an officially recognized currency unit, per chargeable weight cw, particularly chargeable kg, specifying the rate of the forecast domain i, the weight and volume coefficients wᵢ and vᵢ being defined as follows:
   if 0≦dᵢ≦ds, then wᵢ=1 and vᵢ=dᵢ/ds,
   if ds<dᵢ<∞, then wᵢ=ds/dᵢ and vᵢ=1, and
   if dᵢ=∞, then wᵢ=0 and vᵢ=1,
dᵢ representing a volume weight value from the domain i, which may be a mean value or weighted mean value.

The method described immediately above represents a solution approach according to a dual model, while the previously described linear optimization problem provides a solution approach according to a primal model. The technique of linear optimization is well known to those skilled in the art and is described, for example, in H. A. Eiselt, G. Pederzoli, C. L. Sandblom in “Continuous Optimization Models (Operation Research: Theory, Techniques, Applications),” Walter de Gruyter, Inc., 1987, or in the article “Lineare Optimierung [Linear Optimization]” by H. G. Bartels in Handwörterbuch der Betriebswirtschaftslehre [Manual of Business Administration], Part 2, 5^{th} Edition, pages 2953 through 2968, Poeschel Verlag, 1993.

For the case that in the above the chargeable weight cw of a cargo unit having a volume weight d=0 is contrasted and/or compared to its actual weight in, for example, kg or that the cargo unit is not to be expressed in chargeable weight, but rather in actual weight, a chargeable kg corresponds to the actual weight, i.e. one kg. For the case that in the above for a cargo unit the chargeable weight cw of a cargo unit is set at a volume weight d=∞, a chargeable kg results from the product volume of the cargo unit in m³ x 1000, divided by the absolute value of the standard volume weight, which may be the standard volume weight ds_{IATA} of the IATA, which is currently 6. The conversion mode described above may particularly be used for a comparison of Vₙ and Vᵣₑₘ and of Wₙ and Wᵣₑₘ.

The method according to the present invention described above, e.g., using the primal or dual model, respectively, provides solutions for transport flights which comprise a flight having only one leg and therefore also having only one segment. Of course, this method may also be expanded without anything further so that it also considers a flight having multiple legs and therefore also multiple segments. The method according to the present invention may also be applied to multiple flights simultaneously and/or to a flight network, i.e., O&D controls. For example, a solution of the primal model for determining the expected free capacity for a cargo transport having multiple legs and segments can be represented as follows:

maximize

$${R}_{F} = {\sum }_{i} {\sum }_{j} {r}_{ij} {x}_{ij}$$

subject to

$${\sum }_{i} {\sum }_{j} {a}_{kj} {w}_{ij} {x}_{ij} + {sw}_{k} = {W}_{k - re m} , for all k$$

$${\sum }_{i} {\sum }_{j} {a}_{kj} {v}_{ij} {x}_{ij} + {sv}_{k} = {V}_{k - re m} , for all k$$

xᵢⱼ+sᵢⱼ=Dᵢⱼ,
for all (i, j) and
sᵢⱼ, svₖ, swₖ, xᵢⱼ>0,
for all (i, j) and k,
R_{F} specifying the revenue over one flight, the index k specifying the leg of a transport, in particular flight, j specifying the segment of a transport, i specifying the forecast domain and/or the subregion (r/d class) of a segment, xᵢⱼ specifying the request to be accepted for the forecast domain i of the segment j, expressed in chargeable weight cw, particularly chargeable kg, aₖⱼ specifying the forecast demand of the forecast domain i of the segment j, expressed in chargeable weight cw, particularly chargeable kg, aₖⱼ representing the index coefficients of the leg k on the segment j, aₖⱼ=0 if the leg k is not a component of the segment j and aₖⱼ=1 if the leg k is a component of the segment j, wᵢⱼ specifying the weight coefficients for the forecast domain i, vᵢⱼ specifying the volume coefficients for the forecast domain i of the segment j, Wₖ₋ᵣₑₘ specifying the still available weight capacity, expressed in chargeable weight cw, particularly chargeable kg, which preferably only comprises weight, i.e., has a volume weight of d=0, of the leg k and V_{k,rem} specifying the still available volume capacity, expressed in chargeable weight cw, particularly chargeable kg, which preferably only comprises volume, i.e., has a volume weight of d=∞, of the leg k and sᵢⱼ, svₖ, and swₖ specifying the slack variables for the request of the forecast domain i on the segment j, of the volume of the leg k, particularly in the form of a chargeable weight cw, particularly a chargeable kg, which preferably only comprises volume, i.e., has a volume weight of d=∞, and/or of the weight of the leg k, particularly in the form of a chargeable weight cw, particularly a chargeable kg, which preferably only comprises weight, i.e., has a volume weight of d=0, and rᵢⱼ specifying the rate of the forecast domain i of the segment j, expressed as a price, preferably in an officially recognized currency unit, for chargeable weight cw, particularly chargeable kg, the weight and volume coefficients wᵢⱼ and vᵢⱼ being defined as follows:
   if 0≦dᵢⱼ≦ds, then wᵢⱼ=1 and vᵢⱼ=dᵢⱼ/ds,
   if ds<dᵢⱼ<∞, then wᵢⱼ=ds/dᵢⱼ and vᵢⱼ=1, and
   if dᵢⱼ=∞, then wᵢⱼ=0 and vᵢⱼ=1,
dᵢⱼ representing a volume weight value from the domain i of the segment j, in particular a mean value or weighted mean value.

According to the method described above, in addition to the revenue R_{F}, the probable unused remaining capacity, particularly the probable unused weight and/or volume capacity may be determined for a transport or cargo flight having at least one segment.

The solution approach of the primal model described above also has a corresponding form in the following dual model, according to which the revenue R_{F} and/or the bid price, particularly the volume-specific bid price bpv and/or the weight-specific bid price bpw, for a transport or cargo flight having at least one segment may be determined as follows with the aid of linear optimization:

minimize

$${R}_{F} = {\sum }_{k} {W}_{k - re m} \times {bpw}_{k} + {\sum }_{k} {V}_{k - r em} \times {bpv}_{k} + {\sum }_{i} {\sum }_{j} {D}_{ij} \times {p}_{ij}$$

subject to
Σaₖⱼ wᵢⱼ×bpwₖ+Σ aₖⱼ vᵢⱼ×bpvk+pᵢⱼ≦4ᵢⱼ,
for all (i, j)
bpvₖ, bpwₖ, pᵢⱼ>0,
for all (i, j) and k,
RF specifying the revenue over one flight, Wₖ₋ᵣₑₘ specifying the still available weight capacity of the leg k, expressed in chargeable weight cw, particularly chargeable kg, which preferably only comprises weight, i.e., has a volume weight of d=0, and Vₖ₋ᵣₑₘ specifying the still available volume capacity of the leg k, expressed in chargeable weight cw, particularly chargeable kg, which preferably only comprises volume, i.e., has a volume weight of d=∞, bpwₖ specifying the bid price of the weight capacity of the leg k, bpvₖ specifying the bid price of the volume capacity of the leg k, Dᵢⱼ specifying the forecast demand of the forecast domain and/or subregion (r/d class) i of the segment j, expressed in chargeable weight cw, particularly chargeable kg, wᵢⱼ specifying the weight coefficients for the forecast domain i of the segment j, vᵢⱼ specifying the volume coefficients for the forecast domain i of the segment j, aₖⱼ representing the index coefficients of the leg k on the segment j, aₖⱼ=0 if the leg k is not a component of the segment j and aₖⱼ=1 if the leg k is a component of the segment j, and pᵢⱼ specifying the profitability of the forecast domain i of the segment j, expressed in chargeable weight cw, particularly chargeable kg and rᵢⱼ specifying the rate of the forecast domain i of the segment j, expressed as a price, preferably in an officially recognized currency unit, for chargeable weight cw, particularly chargeable kg, the weight and volume coefficients wᵢⱼ and vᵢⱼ being defined as follows:
   if 0≦dᵢⱼ≦ds, then wᵢⱼ=1 and vᵢⱼ=dᵢⱼ/ds,
   if ds<dᵢⱼ<28 , then wᵢⱼ=ds/dᵢⱼ and vᵢⱼ=1, and
   if dᵢⱼ=∞, then wᵢⱼ=0 and vᵢⱼ=1,
   dᵢⱼ representing a volume weight value from the domain i of the segment j,
   in particular a mean value or weighted mean value.
      Instead of plotting the established scaled volume weight values for the cargo units n on a coordinate of a two-dimensional coordinate system, for reasons of clarity, the unscaled volume weight values corresponding thereto may be reproduced. The distances between two volume weight values are still always based in this case on the difference of the corresponding scaled volume weights. In the same way, equidistant positions may be fixed on the volume weight coordinates to visualize the scaled volume weights. A preferred method is accordingly distinguished in that the unscaled volume weight is reproduced as follows:

i) the volume weight range 0 to ∞ (volume/weight) is assigned a whole, finite, equidistantly positioned number of 1 through p positions;

ii) a volume weight d_{Position} based on the scaled volume weight is assigned to each position on the scale at the location of the corresponding position,
position=1 d_{Position}=0,

1<position≦(p−1)2+1 d_{Position}=2 (position−1)/(p−1)×ds,
(p−1)/2+1≦position<p d_{Position}=[(p−1)/2(p−position)]×ds,
position=p dₚₒₛᵢₜₒₙ=∞.

A further method for optimizing the utilization and/or the maximization of the revenue of a cargo space of a cargo transport comprising at least one segment j having at least one leg k and determining the free capacity for a cargo transport, in relation to the volume weight of a cargo unit, is distinguished in that:
a) for incoming transport requests for cargo units n having the rate rₙ, the volume Vₙ, preferably in [m³], the weight Wₙ, preferably in [t], and the volume weight dₙ, the free capacity fcⱼ of a segment j is first determined as a function of the volume weight dₙ via:
   if 0<swⱼ≦svⱼ and 0≦dₙ≦ds, then fcⱼ=swⱼ,
   if 0<swⱼ≦svⱼ and ds<dₙ≦ds×(svⱼ/swⱼ), then fcⱼ=(d/ds)×swⱼ,
   if 0<swⱼ≦svⱼ and ds×(svⱼ/swⱼ)<dₙ<∞, then fcⱼ=svⱼ,
   if swⱼ>svⱼ>0 and 0≦dₙ≦ds×(svⱼ/swⱼ), then fcⱼ=swⱼ,
   if swⱼ>svⱼ>0 and ds×(svⱼ/swⱼ)<dₙ≦ds, then fcⱼ=(ds/dₙ)×svⱼ,
   if swⱼ>svⱼ>0 and ds<dₙ≦∞, then fcⱼ=svⱼ,
   if swⱼ=0 and svⱼ>0 and 0≦dₙ<∞, then fcⱼ=0,
   if swⱼ=0 and svⱼ>0 and dₙ=∞, then fcⱼ=svⱼ,
   if swⱼ>0 and svⱼ=0 and dₙ=0, then fcⱼ=swⱼ,
   if swⱼ>0 and svⱼ=0 and 0<dₙ≦∞, then fcⱼ=0, and
   if swⱼ=0 and svⱼ=0, then fcⱼ=0, the above parameters having the following meaning:
   swⱼ represents the expected unused weight capacity of a segment j, expressed in chargeable weight cw, particularly chargeable kg having the volume weight d=0, swⱼ being defined as Min {swₖ, for all k, for which akⱼ=1},
   svⱼ represents the expected unused volume capacity of a segment j, expressed in chargeable weight cw, particularly chargeable kg having the volume weight d=∞, svⱼ being defined as Min {svₖ, for all k, for which akⱼ=1},
      akⱼ=1 if the leg k is contained in the segment j and
      akⱼ=0 if the leg k is not contained in the segment j,
   cwₙ represents the chargeable weight cw of the transport requests n, expressed in chargeable kg,
   fcⱼ represents the free available capacity having the volume weight dₙ, expressed in chargeable weight cw, particularly chargeable kg,
   d represents the volume weight, preferably in m³/t,
   dₙ represents the volume weight of a cargo unit n, preferably in m³/t, which is determined as follows:
      if the weight Wₙ of the cargo unit n>0 and the volume Vₙ of the cargo unit n≧0, then the volume weight d_{n=(V}ₙ/Wₙ),
      if the weight Wₙ of the cargo unit=0 and the volume Vₙ of the cargo unit n>0, then the volume weight dₙ=∞, and
      if the weight Wₙ of the cargo unit=0 and the volume Vₙ of the cargo unit=0, then the volume weight dₙ is indeterminate,

ds represents the standard volume weight;
b) the chargeable weight cwₙ of the transport request n is determined as follows:
   if the weight Wₙ in t is equal to 0 and the volume Vₙ in m₃ is equal to 0, then cwₙ=0,
   if 0≦dₙ<ds, then cwₙ=Wₙ×1000 and
   if ds<dₙ<∞, then cwₙ Vₙ×1000/ds;
c) if the chargeable weight cwₙ<fcⱼ, the transport request is accepted and, if the chargeable weight cwₙ>fcⱼ, the transport request is accepted, if, for the transport request of a cargo unit n, the bid price bpₙ≦rₙ, and if Vₙ≦Vᵣₑₘ and Wₙ≦Wᵣₑₘ, and otherwise the transport request is rejected.

In this case, according to the present invention, the bid price bpⱼ may be determined via the following equation
bpⱼ=wₙ×bpwⱼ+vₙ×bpvⱼ,
bpⱼ standing for the bid price of a unit of a chargeable weight cw, particularly a chargeable kg, of the requested cargo unit and/or quantity for a segment j at a volume weight dₙ, bpwⱼ standing for the weight capacity access price of the segment j, expressed in price per chargeable weight cw, particularly per chargeable kg having the volume weight dₙ=0 (price of the weight capacity of the segment j), bpvⱼ standing for the volume capacity access price of the segment j, expressed in price per chargeable weight cw, particularly per chargeable kg, having the volume weight dₙ=0 (price of the volume capacity of the segment j), bpwⱼ being defined as the sum of the weight bid prices of all legs k which are on the segment j, i.e., bpwⱼ=Σₖ aₖⱼ×bpwₖ, and bpvⱼ being defined as the sum of the volume bid prices of all legs k which are on the segment j, i.e., bpvⱼ=Σₖ akⱼ×bpvₖ, akⱼ=1 if the leg k is contained in the segment j and akⱼ=0 if the leg k is not contained in the segment j, and wₙ standing for the specific weight consumption and vₙ standing for the specific volume consumption, the specific weight consumption and the specific volume consumption being defined as follows, respectively:
if 0≦dₙ≦ds, then wₙ=1 and vₙ=dₙ/ds,
if ds<dₙ<∞, then wₙ=ds/dₙ and vₙ=1, and
if dₙ=∞, then wₙ=0 and vₙ=1,

dₙ indicating the volume weight of a cargo unit and/or quantity and ds indicating the standard volume weight, and bpwₖ and bpvₖ being determined by solving the following problem, particularly using linear programming:

minimize

$${R}_{F} = {\sum }_{k} {W}_{k - re m} \times {bpw}_{k} + {\sum }_{k} {V}_{k - r em} \times {bpv}_{k} + {\sum }_{i} {\sum }_{j} {D}_{ij} \times {p}_{ij}$$

subject to
Σaₖⱼ wᵢⱼ×bpwₖ+Σaₖⱼ vᵢⱼ ×bpvₖ+pᵢⱼ≧rᵢⱼ,
for all (i, j)
bpvₖ, bpwₖ, pᵢⱼ>0,
for all (i, j) and k,

R_{F} specifying the revenue over one flight, Wₖ₋ᵣₑₘ specifying the still available weight capacity of the leg k, expressed in chargeable weight cw, particularly chargeable kg, which preferably only comprises weight, i.e., has a volume weight of d=0, Vₖ₋ᵣₑₘ specifying the still available volume capacity of the leg k, expressed in chargeable weight cw, particularly chargeable kg, which preferably only comprises volume, i.e., has a volume weight of d=∞, bpwₖ specifying the bid price of the weight capacity of the leg k, bpvₖ specifying the bid price of the volume capacity of the leg k, Dᵢⱼ specifying the forecast demand of the forecast domain i and/or subregion (r/d class) i of the segment j, expressed in chargeable weight cw, particularly chargeable kg, wᵢⱼ specifying the weight coefficients for the forecast domain i of the segment j, vᵢⱼ specifying the volume coefficients for the forecast domain i of the segment j, aₖⱼ representing the index coefficients of the leg k on the segment j, aₖⱼ=0 if the leg k is not a component of the segment j and aₖⱼ=1 if the leg k is a component of the segment j, and pᵢⱼ specifying the profitability of the forecast domain i of the segment j, expressed in chargeable weight cw, particularly chargeable kg and rᵢⱼ specifying the rate of the forecast domain i of the segment j, expressed as a price, preferably in an officially recognized currency unit, for chargeable weight cw, particularly chargeable kg, the weight and volume coefficients wᵢⱼ and vᵢⱼ being defined as follows:
if 0≦dᵢⱼ≦ds, then wᵢⱼ=1 and vᵢⱼ=dᵢⱼ/ds,
if ds<dᵢⱼ<∞, then wᵢⱼ=ds/dᵢⱼ and vᵢⱼ=1, and
if dᵢⱼ=∞, then wᵢⱼ=0 and vᵢⱼ=1,

dᵢⱼ representing a volume weight value from the domain i of the segment j, in particular a mean value or weighted mean value.

According to a further embodiment of the present invention, the expected unused weight capacity swⱼ of a segment j, expressed in chargeable weight cw, particularly chargeable kg having the volume weight d=0, and the expected unused volume capacity svⱼ of a segment j, expressed in chargeable weight cw, particularly chargeable kg having the volume weight d=∞, may be determined via Min {swₖ, for all k, for which akⱼ=1} and Min {svₖ, for all k, for which akⱼ=1}, and the values for swₖ and svₖ being determined by solving the following problem with the aid of linear optimization:

maximize

$${R}_{F} = {\sum }_{i} {\sum }_{j} {r}_{ij} {x}_{ij}$$

subject to

$${\sum }_{i} {\sum }_{j} {a}_{kj} {w}_{ij} {x}_{ij} + {sw}_{k} = {W}_{k - r em} , for all k$$

$${\sum }_{i} {\sum }_{j} {a}_{kj} {v}_{ij} {x}_{ij} + {sv}_{k} = {V}_{k - r em} , for all k$$

xᵢⱼ+sᵢⱼ=Dᵢⱼ,
for all (i, j) and
sᵢⱼ, svₖ, swₖ, xᵢⱼ>0,
for all (i, j) and k,

R_{F} specifying the revenue over one flight, the index k specifying the leg of a transport, in particular flight, j specifying the segment of a transport, i specifying the forecast domain and/or the subregion (r/d class) of the segment, xᵢⱼ specifying the request to be accepted for the forecast domain i of the segment j, expressed in chargeable weight cw, particularly chargeable kg, Dᵢⱼ specifying the forecast demand of the forecast domain i of the segment j, expressed in chargeable weight cw, particularly chargeable kg, aₖⱼ representing the index coefficients of the leg k on the segment j, aₖⱼ=0 if the leg k is not a component of the segment j and aₖⱼ=1 if the leg k is a component of the segment j, wᵢⱼ specifying the weight coefficients for the forecast domain i of the segment j, vᵢⱼ specifying the volume coefficients for the forecast domain i, Wₖ₋ᵣₑₘ specifying the still available weight capacity, expressed in chargeable weight cw, particularly chargeable kg, which preferably only comprises weight, i.e., has a volume weight of d=0, of the leg k and Vₖ₋ᵣₑₘ specifying the still available volume capacity, expressed in chargeable weight cw, particularly chargeable kg, which preferably only comprises volume, i.e., has a volume weight of d=∞, of the leg k and sᵢⱼ, svₖ, and swₖ specifying the slack variables for the request of the forecast domain i on the segment j, of the volume of the leg k, particularly in the form of a chargeable weight cw, in particular chargeable kg, which preferably only comprises volume, i.e., has a volume weight of d=∞, and/or of the weight of the leg k, particularly in the form of a chargeable weight cw, particularly a chargeable kg, which preferably only comprises weight, i.e., has a volume weight of d=0, and rᵢⱼ specifying the rate of the forecast domain i of the segment j, expressed as a price, preferably in an officially recognized currency unit, for chargeable weight cw, particularly chargeable kg,
the weight and volume coefficients wᵢⱼ and vᵢⱼ being defined as follows:
   if 0≦dᵢⱼ≦ds, then wᵢⱼ=1 and vᵢⱼ=dᵢⱼ/ds,
   if ds<dᵢⱼ<∞, then wᵢⱼ=ds/dᵢⱼ and vᵢⱼ=1, and
   if dᵢⱼ=∞, then wᵢⱼ=0 and vᵢⱼ=1,

dᵢⱼ representing a volume weight value from the domain i of the segment j, in particular a mean value or weighted mean value.

Furthermore, the utilization and/or the maximization of the revenue of a cargo space of a cargo transport comprising at least one segment j having at least one leg k may be optimized by determining the free capacity for a cargo transport, in relation to the scaled volume weight of a cargo unit, in that
a) for incoming transport requests for cargo units n having the rate r_{n,} the volume V_{n,} preferably in [m³], the weight Wₙ, preferably in [t], the chargeable weight cwₙ, the volume weight dₙ, and the scaled volume weight sdₙ, the free capacity fcⱼ of a segment is first determined as a function of the scaled volume weight sdₙ via:
   if 0<swⱼ≦svⱼ and 0≦sdₙ<0.5, then fcⱼ=swⱼ,
   if 0<swⱼ≦svⱼ and 0.5<sdₙ≦0.5×(svⱼ/swⱼ), then fcⱼ=swⱼ/(2(1−sdₙ)),
   if 0<swⱼ≦svⱼ and 0.5×(svⱼ/swⱼ)<sdₙ≦1, then fcⱼ=svⱼ,
   if swⱼ>svⱼ>0 and 0≦sdₙ<0.5×(svⱼ/swⱼ), then fcⱼ=swⱼ,
   if swⱼ>svⱼ>0 and 0.5×(svⱼ/swⱼ)<sdₙ≦0.5, then fcⱼ=svⱼ/2 sdₙ,
   if swⱼ>svⱼ>0 and 0.5<sdₙ≦1, then fcⱼ=svⱼ,
   if swⱼ=0 and svⱼ>0 and 0≦sdₙ≦1, then fcⱼ=0,
   if swⱼ=0 and svⱼ>0 and sdₙ=1, then fcⱼ=svⱼ,
   if swⱼ>0 and svⱼ=0 and sdₙ=0, then fcⱼ=swⱼ,
   if swⱼ>0 and svⱼ=0 and 0<sdₙ≦1, then fcⱼ=0,and
   if swⱼ=0 and svⱼ=0, then fcⱼ=0,
   the preceding parameters having the following meaning:
   swⱼ represents the expected unused weight capacity of a segment j, expressed in chargeable weight cw, particularly chargeable kg having the volume weight d=0, swⱼ being defined as Min {swₖ, for all k, for which akⱼ=1},
   svⱼ represents the expected unused volume capacity of a segment j, expressed in chargeable weight cw, particularly chargeable kg having the volume weight d=∞, svⱼ being defined as Min {svₖ, for all k, for which akⱼ=1},
   akⱼ=1 if the leg k is contained in the segment j and
   akⱼ=0 if the leg k is not contained in the segment j,
   cwₙ represents the chargeable weight cw of the transport requests n, expressed in chargeable kg,
   fcⱼ represents the free available capacity having the scaled volume weight sdₙ, expressed in chargeable weight cw, particularly chargeable kg,
   dₙ represents the volume weight of a cargo unit n, preferably in m³/t, which is determined as follows:
      if the weight Wₙ of the cargo unit>0 and the volume Vₙ of the cargo unit≧0, then the volume weight dₙ=(Vₙ/Wₙ),
      if the weight Wₙ of the cargo unit=0 and the volume Vₙ of the cargo unit n>0, then the volume weight dₙ=∞, and
      if the weight Wₙ of the cargo unit=0 and the volume Vₙ of the cargo unit=0, then the volume weight dₙ is indeterminate,
   on the basis of the established volume weight dₙ, the scaled volume weight sdₙ is determined,
      if dₙ=0, then sdₙ=0,
      if 0<dₙ≦ds, then sdₙ=dₙ/2ds,
      if ds<dₙ<∞, then sdₙ=1−ds/2dₙ, and
      if dₙ=∞, then sdₙ=1,
      ds being a given standard volume weight, preferably in m³/t, which may in some embodiments correspond to the standard volume weight ds_{IATA} of the IATA;
b) the chargeable weight cw is determined according to:
   if the weight Wₙ in t is equal to 0 and the volume Vₙ in m³ is equal to 0, then cwₙ=0,
   if 0≦sdₙ<0.5, then cwₙ=Wₙ×1000 and
   if 0.5<sdₙ<1, then cwₙ=Vₙ×1000/ds;
c) if the chargeable weight cwₙ<fcj, the transport request is accepted and, if the chargeable weight cwₙ>fcⱼ, the transport request is accepted, if, for the transport request of a cargo unit n, the bid price bpₙ<rₙ, and if Vₙ≦Vᵣₑₘ and Wₙ≦Wᵣₑₘ, and otherwise the transport request is rejected.

For this purpose, it is preferable that the volume capacity V, in particular the remaining volume capacity Vᵣₑₘ and/or the maximum volume capacity Vₘₐₓ, are expressed as chargeable weight cw, particularly chargeable kg, having the volume weight d=∞ and/or the weight capacity W, particularly the remaining weight capacity Wᵣₑₘ and/or the maximum weight capacity Wₘₐₓ, are expressed as chargeable weight cw, particularly chargeable kg, having the volume weight d=0.

Furthermore, the utilization and/or the maximization of the revenue of a cargo space of a cargo transport comprising at least one segment j having at least one leg k may be optimized by determining the revenue of the lowest-value subregions of expected cargo transport requests (bid price) for a segment as a function of the volume weight d, in that
a) for incoming transport requests for cargo units n having the rate rₙ, the volume Vₙ, the weight Wₙ, and the volume weight dₙ, the bid price bpj is determined as follows:
   if 0≦dₙ≦ds, then bpⱼ=bpwⱼ+(dₙ/ds)×bpvⱼ,
   if ds<dₙ<∞, then bpⱼ=(ds/dₙ)×bpwⱼ+bpvⱼ, and
   if dₙ=∞, then bpⱼ=bpvⱼ,

the preceding parameters having the following meaning:
dₙ is the volume weight of the transport request
ds is the standard volume weight
bpⱼ is the bid price of the segment j at a volume weight d,
bpwⱼ is the weight capacity access price of the segment j, expressed in price per chargeable weight cw, particularly per chargeable kg having the volume weight dₙ=0 (price of the weight capacity of the segment j),
bpvⱼ is the volume capacity access price of the segment j, expressed in price per chargeable weight cw, particularly per chargeable kg having the volume weight dₙ=0 (price of the volume capacity of the segment j),
bpwⱼ being defined as the sum of the weight bid prices of all legs k which are on the segment j, i.e., bpwⱼ=Σₖ aₖⱼ×bpwₖ, and bpvⱼ being defined as the sum of the volume bid prices of all legs k which are on the segment j, i.e., bpvⱼ=Σₖ aₖⱼ×bpvₖ,
akⱼ=1 if the leg k is contained in the segment j and
akⱼ=0 if the leg k is not contained in the segment j, and
representing the volume weight of a cargo unit n, preferably in m³/t and being determined as follows:
   if the weight Wₙ of the cargo unit>0 and the volume Vₙ of the cargo unit≧0, then the volume weight dₙ=(Vₙ/Wₙ)
   if the weight Wₙ of the cargo unit=0 and the volume Vₙ of the cargo unit>0, then the volume weight dₙ=∞,
   if the weight Wₙ of the cargo unit=0 and the volume Vₙ of the cargo unit=0, then the volume weight dₙ is indeterminate,
b) the chargeable weight cwₙ of the transport request n is determined as follows:
   if the weight Wₙ in t is equal to 0 and the volume Vₙ in m³ k is equal to 0, then cwₙ=0,
   if 0≦dₙ≦ds, then cwₙ=Wₙ×1000 and
   if ds<dₙ≦∞, then cwₙ=Vₙ×1000/ds;
c) if the rate rₙ≧bpⱼ and if Vₙ≦Vᵣₑₘ and Wₙ≦Wᵣₑₘ, the transport request is accepted and, if the rate rₙ<bpⱼ, the transport request is rejected.

Finally, according to the present invention, it is also possible to use the scaled volume weight sd to optimize the utilization and/or the maximization of the revenue of a cargo space of a cargo transport comprising at least one segment j having at least one leg k by determining the revenue from the lowest-value subregions of expected cargo transport requests. In this case,
a) for incoming transport requests for cargo units n having the rate rₙ, the volume Vₙ, the weight Wₙ, the volume weight dₙ, and the scaled volume weight sdₙ, the bid price bpⱼ may be determined as follows:
   if 0≦sdₙ<0.5, then bpⱼ=bpwⱼ+2 sdₙ×bpvⱼ,
   if 0.5<sdₙ<1, then bpⱼ=2(1−sdₙ)×bpwⱼ+bpvⱼ, and
   if dₙ=1, then bpⱼ=bpvⱼ,
   the preceding parameters having the following meanings:
   dₙ is the volume weight of the transport request
   sdₙ is the scaled volume weight of the transport request
   bpⱼ is the bid price of the segment j at a scaled volume weight sdₙ
   bpwⱼ is the weight capacity access price of the segment j, expressed in price per chargeable weight cw, particularly per chargeable kg having the volume weight dₙ=0 (price of the weight capacity of the segment j),
   bpvⱼ is the volume capacity access price of the segment j, expressed in price per chargeable weight cw, particularly per chargeable kg having the volume weight dₙ=∞ (price of the volume capacity of the segment j),
   bpwⱼ being defined as the sum of the weight bid prices of all legs k which are on the segment j, i.e., bpwⱼ=Σₖ aₖⱼ×bpwₖ, and bpvⱼ being defined as the sum of the volume bid prices of all legs k which are on the segment j, i.e., bpvⱼ=Σₖ aₖⱼ×bpvₖ,
   akⱼ=1 if the leg k is contained in the segment j and
   akⱼ=0 if the leg k is not contained in the segment j, and
   representing the volume weight of a cargo unit n, preferably in m³/t and being determined as follows:
      if the weight Wₙ of the cargo unit>0 and the volume Vₙ of the cargo unit≧0, then the volume weight dₙ=(Vₙ/Wₙ),
      if the weight Wₙ of the cargo unit=0 and the volume Vₙ of the cargo unit>0, then the volume weight dₙ=∞,
      if the weight Wₙ of the cargo unit=0 and the volume Vₙ of the cargo unit=0, then the volume weight dₙ is indeterminate, and
      on the basis of the established volume weight d, the scaled volume weight sdₙ is determined as follows:
         if dₙ=0, then sdₙ=0,
         if 0<dₙ≦dₛ, then sdₙ=dₙ/2ds,
         if ds<dₙ<∞, then sdₙ=1−ds/2dₙ, and
         if dₙ=∞, then sdₙ=1,
      ds being a given standard volume weight, preferably in m³/t, which may in some embodiments correspond to the standard volume weight ds_{IATA} of the IATA;
b) the chargeable weight cwₙ of the transport request n is determined as follows:
   if the weight Wₙ in t is equal to 0 and the volume Vₙ in m³ is equal to 0, then cwₙ=0,
   if 0≦sdₙ<0.5, then cwₙ=Wₙ×1000 and
   if 0.5<sdₙ<1, then cwₙ=Vₙ×1000/ds;
c) if the rate rₙ≦bpⱼ and if Vₙ<Vᵣₑₘ and Wₙ<Wᵣₑₘ, the transport request is accepted and, if the rate rₙ<bpⱼ, the transport request is rejected.

The methods according to the present invention are, of course, accessible to computer-aided and/or computer-implemented processing and may be provided on a computer system and/or implemented using such a system. Accordingly, such systems, which implement and/or embody the methods described above, are also included by the present invention.

The present invention also comprises a computer program having program code means to perform all steps according to the method according to the present invention when the program is executed on a computer. The present invention further comprises a computer program having the program code means described above, which are stored on a computer-readable medium or other computer-readable data carrier. Finally, the present invention relates to a computer program product having program code means stored on a machine-readable medium or carrier to perform all steps according to the method according to the present invention when the program is executed on a computer.

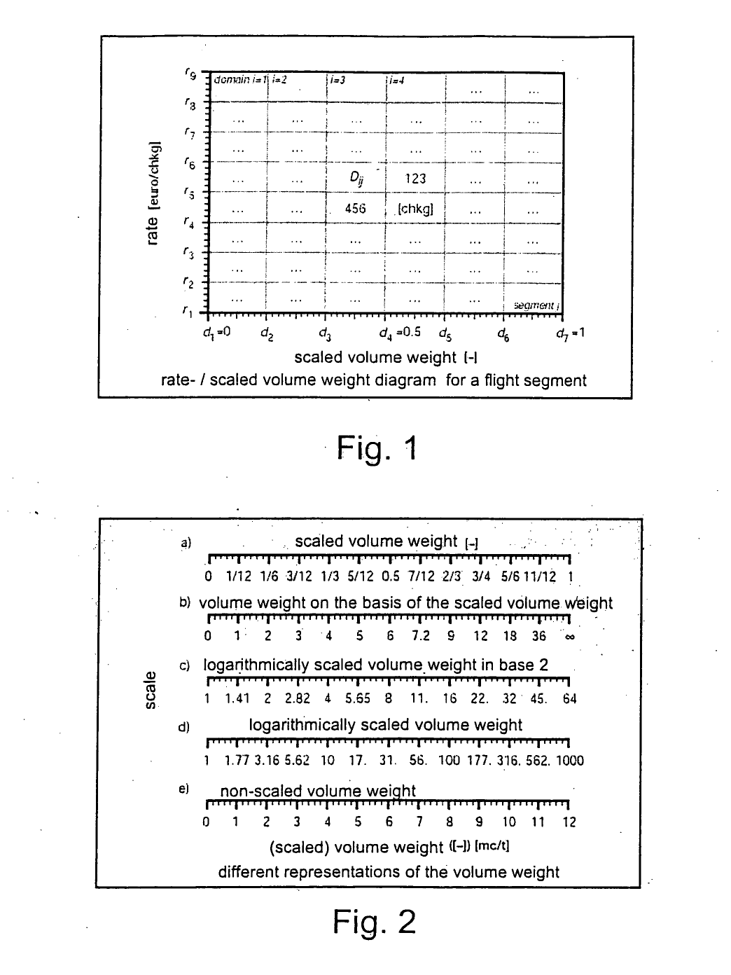

FIGS. 1-10 illustrate exemplary embodiments of the present invention that aid in an understanding of the disclosure provided above but do not limit the invention to the precise forms disclosed or illustrated. FIG. 1 shows an r/sd diagram for segment of a flight. The scaled volume weight is plotted on the abscissa, while the ordinate shows the rate of cargo units in the unit euro per chargeable kg. For better illustration, only selected values of the scaled volume weight are shown on the abscissa (d₁=0, d₄=0.5, d₇=1). The placeholders d₂ and d₃ and/or d₅ and d₆ for the scaled volume weight values d are shown in between at equal intervals, which form the boundary values for selected subregions. As a result, the intervals between subregion boundaries on the abscissa are based on the scaled volume weight and not on the volume weight.

Overall, the r/sd diagram shown is divided by the selection of the subregions d₁ through d₇ into eight columns. By fixing boundary values for the rate r on the ordinate, in the present case a total of 48 subregions i, which all have an identical rectangular shape, are obtained. It is especially favorable if no subregion i of sd values is delimited which contains the value 0.5, representing the standard volume weight. Accordingly, the subregion boundaries run along the value 0.5, i.e., no subregion simultaneously includes cargo units of lower and higher density.

An expected total demand Dᵢ of chargeable weight cw to be transported for a segment may now be assigned to the individual subregions i. In the present exemplary embodiment, the value 123 chargeable kg is assigned to the subregion 22, i.e., it is assumed that cargo transport requests relating to cargo units having a scaled volume weight in the boundaries of d₄ and d₅ having a rate in the boundaries r₅ and r₆ will make up a total of 123 chargeable kg for the segment under discussion. Of course, there may also be subregions i in the diagram, to which the value 0 chargeable kg is assigned. For this case, no cargo is expected having a scaled volume weight and a rate which may be assigned to this subregion.

The expected total demand capacity Dᵢ of a subregion i may be derived from historical data, in particular even from a statistical analysis. For example, the boundaries of the particular subregions may be placed in such a way that they image and/or enclose the value pair clusters. However, the values Dᵢ may also be estimated and/or predefined on the basis of other, e.g., current conditions. For cargo flights, typically a maximum of 100 subregions are sufficient in order to image value pair clusters coming into consideration sufficiently precisely. If one considers that a cargo flight typically comprises not more than 15 segments, a total of 1500 subregions i are available for a cargo flight.

Multiple abscissa illustrations are shown one on top of another in FIG. 2, which show the volume weight of the cargo in different ways. Line a) shows the volume weight as the scaled volume weight; line b) shows the unscaled volume weight, aligned to the corresponding values of line a), a standard volume weight of 6 m³ per ton being used for the purpose of calculation. Lines c) and d) show the logarithmically scaled volume weight, while the unscaled volume weight is shown in e).

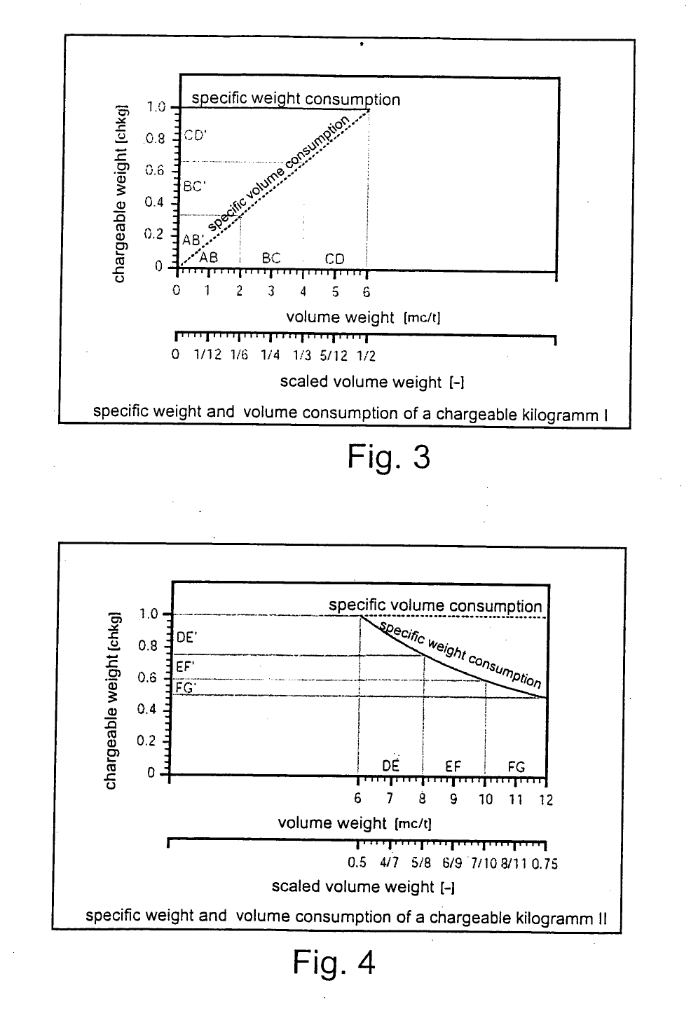

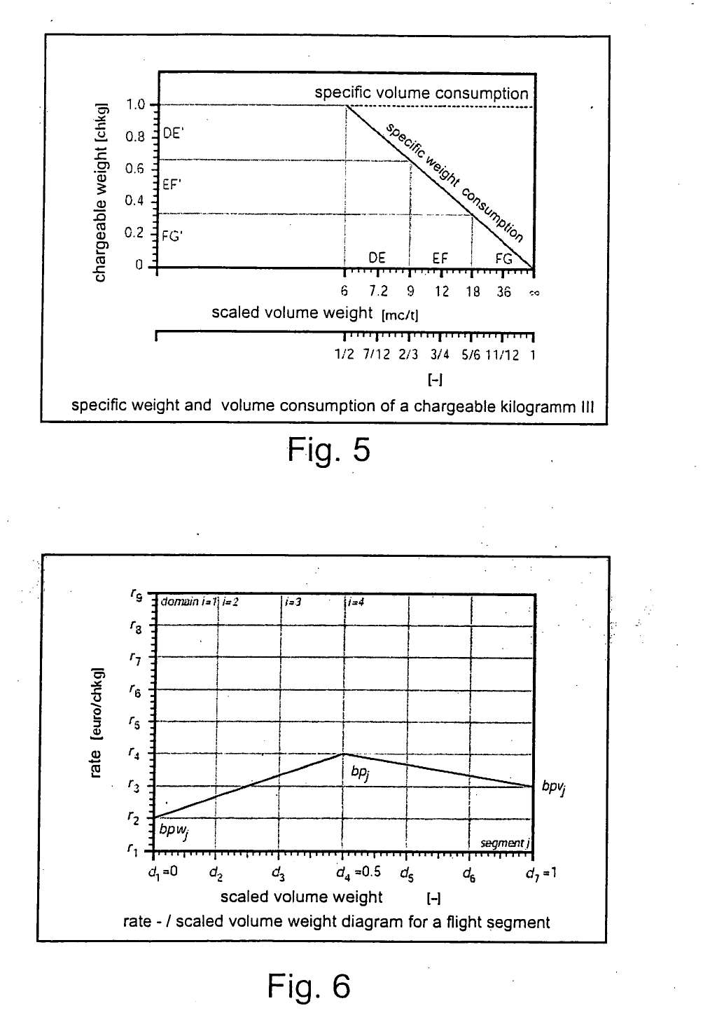

FIG. 3 shows a diagram in which the volume weight is illustrated on the abscissa and the corresponding scaled volume weight is illustrated parallel thereto, and in which both the weight consumption and the volume consumption of a chargeable kilogram are shown on the ordinate. For reasons of equal treatment of weight and volume, the specific consumption is specified in each case in chargeable kilograms (instead of in kilograms and cubic meters). As long as the cargo has a volume weight which is less than or equal to the standard volume weight (in the present case 6 m³ per ton), the specific volume consumption runs linearly, and the specific weight consumption is always 1 chargeable kilogram having the volume weight 0. If one also uses the unscaled volume weight as the basis for cargo having volume weight values which are greater than the standard volume weight, with increasing volume weight, the specific weight consumption does not fall linearly (see also FIG. 4). Only when the scaled volume weight values are used for this cargo having high volume weight, using which even infinite volume weight may be imaged adequately, a linear drop for the specific weight consumption results, as shown in FIG. 5.

FIG. 6 represents a r/sd diagram, in which a bid price curve prepared with the aid of linear programming using the dual model has been drawn. Accordingly, cargo transport requests, whose value pair points comprising rate and scaled volume weight lie on or below this bid price curve are to be rejected, and all other transport requests may be accepted, as long as the maximum weight and volume capacities are not exceeded. Using the diagram shown in FIG. 6, it is easily possible to represent the bid price as a function of the scaled volume weight. In this case, the intersections of this bid price curve with the coordinate axis at a scaled volume weight of 0 provide the bid price bpw of a segment for cargo which only comprises weight, and, at a scaled volume weight of 1, provide the bid price bpv of a segment for cargo which only comprises volume.

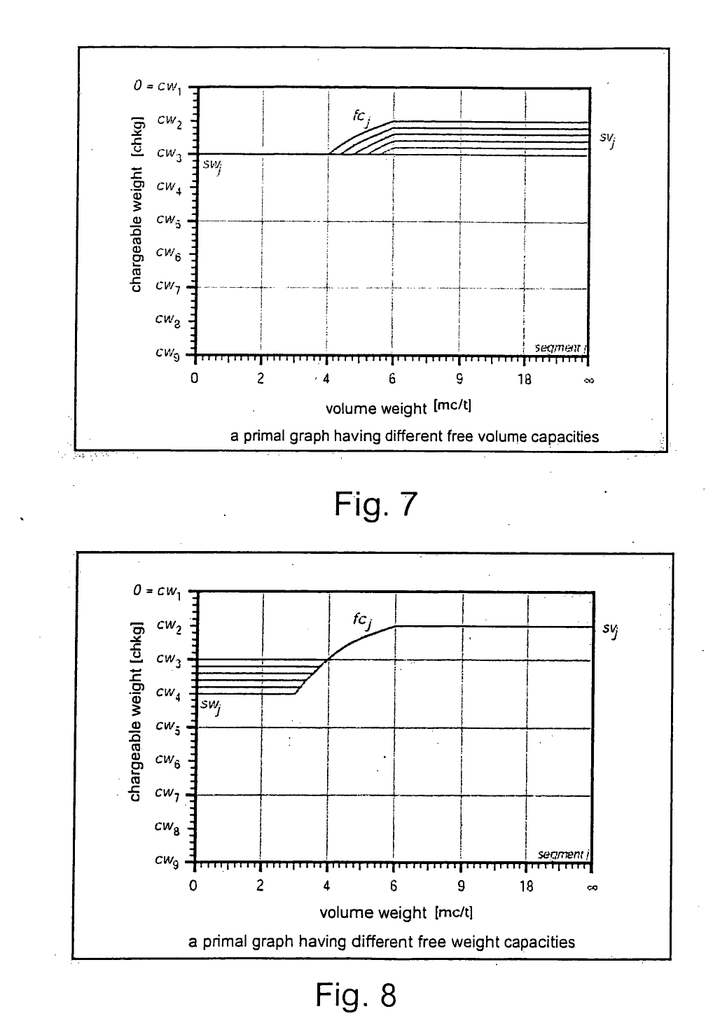

FIGS. 7 and 8 each represent a diagram in which decision curves prepared with the aid of linear programming using the primal model have been drawn. The decision curve results with the aid, for example, of the LP problem solution according to application claims 27, 30, 32 and/or 33 as filed herewith and provides information about the probable unused remaining chargeable weight as a function of its volume weight. Cargo transport requests, whose value pair points comprising its chargeable weight and its scaled volume weight lie on or above this decision curve, are always to be accepted. Using the diagram shown in FIGS. 7 and 8 it is easily possible to decide during the running booking period which cargo transport requests are always to be accepted and which are always to be rejected. The cargo transport requests which are always to be accepted according to this rule are to be considered advantageous, since they may be booked in the capacity which would otherwise probably remain unused.

The difference between FIG. 7 and FIG. 8 is that, for demonstration purposes, in FIG. 7 the probable unused remaining volume capacity was varied, while in FIG. 8 the probable remaining unused weight capacity was varied. Of course, the abscissas of FIGS. 7 and 8, which show the volume weight, are based on the scale of the scaled volume weight, corresponding to lines a) and b) of FIG. 2. Because in FIG. 7 the probable unused remaining chargeable weight is composed of the probable unused remaining weight and the probable unused remaining volume, the function is plotted for different values of the probable unused remaining volume. In this way, an overview of possible function curves is obtained as a function of the parameter of the probable unused remaining volume. Because in FIG. 8 the probable unused remaining chargeable weight is composed of the probable unused remaining weight and the probable unused remaining volume, the function is plotted for different values of the probable unused remaining weight. In this way, an overview of possible function curves is obtained as a function of the probable unused remaining weight.

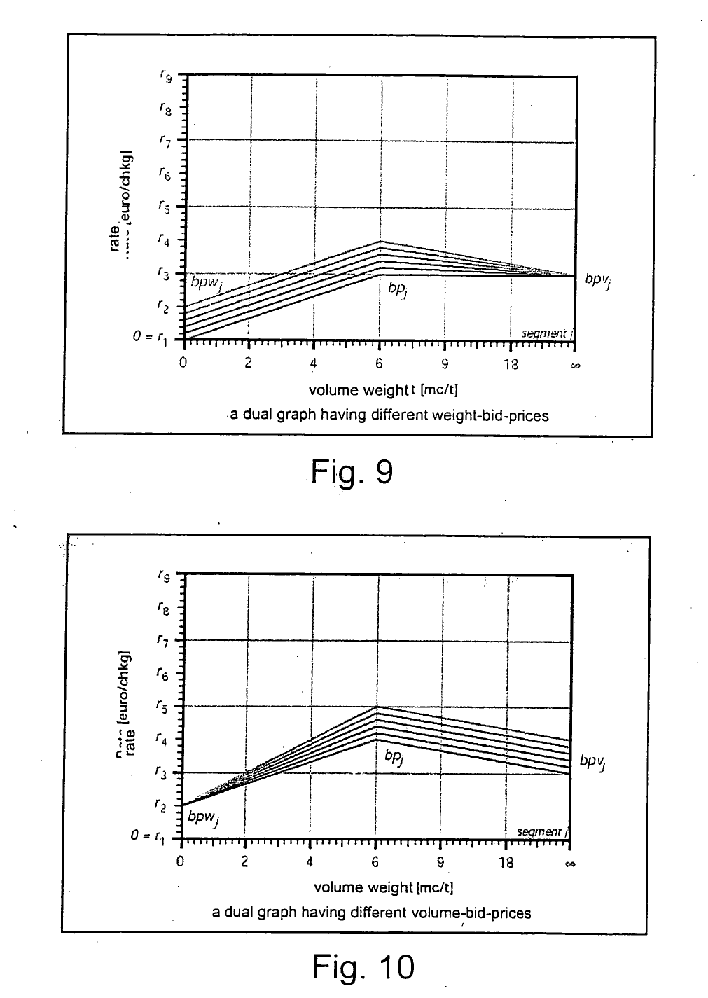

FIGS. 9 and 10 each represent a diagram in which decision curves prepared with the aid of linear programming using the dual model have been drawn. The decision curve results, for example, with the aid of the LP problem solution according to application claims 28, 31, 35, and/or 36 as filed herewith and provides information about the optimum capacity access price of a chargeable kilogram as a function of its volume weight. Cargo transport requests whose value pair points, comprising its rate for chargeable weight and its scaled volume weight, lie on or above this decision curve are always to be accepted. Using the diagram shown in FIGS. 9 and 10, it is easily possible to decide during the running booking period which cargo transport queries are always to be accepted (if the maximum volume and weight capacity may be maintained) and which are always to be rejected. The cargo transport requests which are always to be accepted according to this rule are to be considered advantageous, since their rate per chargeable weight is above the bid price per chargeable weight (which represents the probable displacement costs).

The difference between FIG. 9 and FIG. 10 is that, for demonstration purposes, in FIG. 9 the bid price weight was varied, while in FIG. 10 the bid price volume was varied. Of course, the abscissas of FIGS. 9 and 10, which show the volume weight, are based on the scale of the scaled volume weight, corresponding to lines a) and b) and of FIG. 2. Because in FIG. 9 the capacity access price is composed of the capacity access price weight and the capacity access price volume, the function is plotted for different values of the capacity access price weight. In this way, an overview of possible function curves is obtained as a function of the parameter of the capacity access price weight. Because in FIG. 10 the capacity access price is composed of the capacity access price weight and the capacity access price volume, the function is plotted for different values of the capacity access price volume. In this way, an overview of possible function curves is obtained as a function of the parameter of the capacity access price volume.

The features of the present invention disclosed in the above description, in the claims, and in the drawings, and all equivalents thereof, may be used both individually and in any arbitrary combination for implementing the present invention in its various embodiments.

1. A method for optimizing the utilization of and/or maximizing revenue from a cargo space for a cargo transport, comprising:
recording incoming transport requests for cargo units n, and for each transport request, with regard to its volume Vₙ, its weight Wₙ, and, in given cases its rate rₙ as price per chargeable weight unit cw,
determining the volume weights dₙ of the cargo units n, where
if the weight Wₙ of the n^{th} cargo unit>0 and the volume Vₙ of the n^{th} cargo unit≧0, then the volume weight dₙ=(Vₙ/Wₙ),
if the weight Wₙ of the n^{th} cargo unit=0 and the volume Vₙ of the n^{th} cargo unit>0, then the volume weight dₙ=∞, and
if the weight Wₙ of the n^{th} cargo unit=0 and the volume Vₙ of the n^{th} cargo unit=0, then the volume weight dₙ is indeterminate,
based on the determined volume weight dₙ, determining the scaled volume weight sdₙ, where,
if dₙ=0, then sdₙ=0,
if 0<dₙ≦ds, then sdₙ=dₙ/2ds,
if ds<dₙ<∞, then sdₙ=1−ds/2dₙ, and
if dₙ=∞, then sdₙ=1,
where dₛ is a given standard volume weight;
determining whether the scaled volume weight sdₙ of the transport request for the n^{th} cargo unit has an extreme scaled volume weight sdₙ which is in a range of 0≦sdₙ<0.5 or of 0.5 <sdₙ≦1, and
accepting the transport request if it has an extreme scaled volume weight sdₙ, insofar as the maximum capacity of cargo volume Vₘₐₓ and the maximum capacity of cargo weight Wₘₐₓ will not be exceeded on acceptance of the n^{th} transport request.

2. (canceled)

3. The method according to claim 1, wherein
incoming transport requests for cargo units n are recorded, and for each transport request, with regard to its volume Vₙ, its weight Wₙ, and, in given cases, its rate rₙ as price per chargeable weight unit cw,
the volume weights dₙ of the cargo units are determined, where
if the weight Wₙ of the n^{th} cargo unit>0 and the volume Vₙ of the n^{th} cargo unit≧0, then the volume weight dₙ=(Vₙ/Wₙ),
if the weight Wₙ of the n^{th} cargo unit=0 and the volume Vₙ of the n^{th} cargo unit>0, then the volume weight dₙ=∞, and
if the weight Wₙ of the n^{th} cargo unit=0 and the volume Vₙ of the n^{th} cargo unit=0, then the volume weight dₙ is indeterminate,
wherein based on the determined volume weight dₙ, the scaled volume weight sdₙ is determined, where,
if dₙ=0, then sdₙ=0,
if 0<dₙ≦ds, then sdₙ=dₙ/2ds,
if ds<dₙ<∞, then sdₙ=1−ds/2dₙ, and
if dₙ=∞, then sdₙ=1,
where ds is a given standard volume weight;
further comprising determining a still available capacity of volume Vᵣₑₘ, taking into account the maximum capacity of cargo volume Vₘₐₓ, and the still available capacity of weight Wᵣₑₘ, taking into account the maximum capacity of cargo weight Wₘₐₓ,
calculating the volume weight dₖ of the still available capacity via dₖ=Vᵣₑₘ/Wᵣₑₘ, and
if dₖ=0, then sdₖ=0,
if 0<dₖ≦ds, then sdₖ=dₖ/2ds,
if ds<dₖ<∞, then sdₖ=1−ds/2dₙ, and
if dₖ=∞, then sdₖ=1, in which sdₖ represents the scaled volume weight of the still available capacity dₖ and where
if the weight Wᵣₑₘ>0 and the volume Vᵣₑₘ≦0, then the volume weight dₖ=(Vᵣₑₘ/Wᵣₑₘ),
if the weight Wᵣₑₘ=0 and the volume Vᵣₑₘ<0, then the volume weight dₖ=∞, and
if the weight Wᵣₑₘ=0 and the volume Vᵣₑₘ=0, then the volume weight dₖ is indeterminate,
determining whether the scaled volume weight sdₖ of the available capacity is smaller than, greater than, or the same as 0.5, and
if sdₖ<0.5, the transport request is accepted if sdₙ<sdₖ or if 0≦sdₙ≦0.5,
if sdₖ>0.5, the transport request is accepted if sdₙ>sdₖ or if 0.5≦s_{dn}≦1, and
if sdₖ=0.5, the transport request is accepted if 0≦sdₙ<0.5 or 0.5<sdₙ≦1,
insofar as the maximum capacity of cargo volume Vₘₐₓ and the maximum capacity of cargo weight Wₘₐₓ will not be exceeded on acceptance of the n^{th} transport request.

4-5. (canceled)

6. The method according to claim 1, wherein
incoming transport requests for cargo units n are recorded with regard to their volume Vₙ, their weight Wₙ, their chargeable weight unit cw, and their rate rₙ per chargeable weight unit cw of the cargo unit n,
determining the volume weight dₙ of the cargo units, where
if the weight Wₙ of the n^{th} cargo unit≧0 and the volume Vₙ of the n^{th} cargo unit≧0, then the volume weight dₙ=(Vₙ/Wₙ),
if the weight Wₙ of the n^{th} cargo unit=0 and the volume Vₙ of>0, then
the volume weight dₙ=∞, and
if the weight Wₙ of the n^{th} cargo unit=0 and the volume Vₙ of the n^{th} cargo unit=0, then the volume weight dₙ is indeterminate,
based on the determined volume weight dₙ, determining the scaled volume weight sdₙ, where,
if dₙ=0, then s_{d}=0,
if 0<dₙ≦ds, then sdₙ=dₙ/2ds,
if ds<dₙ<∞, then sdₙ=1−ds/2dₙ, and
if dₙ=∞, then sdₙ=1,
where ds is a standard volume weight,
on the basis of the determined amount of scaled volume weights sdₙ, forming at least two volume weight classes Kₓ with lower and upper classes limits d_{g}, where no class Kₓ is formed which has a lower limit with an sd value<0.5 and an upper limit with an sd value>0.5,
calculating the volume weights of the class limits d_{g} in such a manner that
if sd_{g}=0, then d_{g}=0,
if 0<sd_{g}≦0.5, then d_{g}=2 sd_{g}×ds,
if 0.5<sd_{g}<1, then d_{g}=ds/(2−2 sd_{g}), and
if sd_{g}=1, then d_{g}=∞, and
assigning the cargo units n to the volume weight classes Kₓ(dₙ).

7. The method according to claim 1, further comprising:
recording forecasted cargo quantities with regard to their volume Vₘ, their weight Wₘ, their requested price rₘ for the chargeable weight cw, of the cargo quantity m,
determining the volume weight dₘ of the cargo units, where
if the weight Wₘ of the cargo quantity m≧0 and the volume Vₘ of the cargo quantity m≧0, then the volume weight dₘ=(Vₘ/Wₘ),
if the weight Wₘ of the cargo quantity m=0 and the volume Vₘ>0, then the volume weight dₘ=∞, and
if the weight Wₘ of the cargo quantity m=0 and the volume Vₘ=0, then the volume weight dₘ is indeterminate,
based on the determined volume weight dₘ, determining the scaled volume weight sdₘ, where,
if dₘ=0, then sdₘ=0,
if 0<dₘ≦ds, then sdₘ=dₘ/2ds,
if ds<dₘ<∞, then sdₘ=1−ds/2dₘ, and
if dₘ=∞, then sdₘ=1,
where ds is a given standard volume weight,
on the basis of the forecasted amount with the scaled volume weights sdₘ, forming at least two volume weight classes K_{z} with lower and upper classes limits d_{f}, where no class K_{z} is formed which has a lower limit with an sd value<0.5 and an upper limit with an sd value>0.5,
calculating the volume weights d_{f} of the class limits in such a manner that
if sd_{f}=0, then d_{f}=0,
if 0<sd_{f}≦0.5, then d_{f}=2 sd_{f}×ds,
if 0.5<sd_{f}<1, then d_{f}=ds/(2−2 sd_{f}), and
if sd_{f}=1, then d_{f}=∞, and
assigning the cargo amounts m to the volume weight classes K_{z}(dₘ).

8-9. (canceled)

10. The method according to claim 1, further comprising:
defining an amount of incoming cargo transport requests via their respective requested volumes Vₙ, requested weights Wₙ, their attainable rates rₙ expressed as price per chargeable weight unit cw, the volume weight dₙ, and the scaled volume weight sdₙ, where
the volume weight dₙ of a cargo unit n is determined as follows, where
if the weight Wₙ of the n^{th} cargo unit>0 and the volume Vₙ of the n^{th} cargo unit≧0, then the volume weight dₙ=(Vₙ/Wₙ),
if the weight Wₙ of the n^{th} cargo unit=0 and the volume Vₙ of the n^{th} cargo unit>0, then the volume weight dₙ=∞, and
if the weight Wₙ of the n^{th} cargo unit=0 and the volume Vₙ of the n^{th} cargo unit=0, then the volume weight dₙ is indeterminate,
based on the determined volume weight dₙ, determining the scaled volume weight sdₙ, where,
if dₙ=0, then sdₙ=0,
if 0<dₙ≦ds, then sdₙ=dₙ/2ds,
if ds<dₙ<∞, then sdₙ=1−ds/2dₙ, and
if dₙ=∞, then sdₙ=1,
where ds is a given standard volume weight,
defining a two-dimensional region including two intersecting coordinate axes, where the region's first dimension indirectly or directly represents the range of the scaled volume weight sdₙ requested in the transport requests and the region's second dimension represents the requested rate rₙ defined as price of the chargeable weight cw, where
the amount of the chargeable weight cw is defined as follows:
if Wₙ=0 and the volume Vₙ=0, then cw=0,
if 0<dₙ≦ds, then cw=Wₙ×1000, and
if ds<dₙ≦∞, then cw=Vₙ×1000/ds,
and in the two-dimensional region of the coordinate system formed by the coordinate axes, to each of the value pairs formed from the scaled volume weight sdₙ of a requested n^{th} cargo unit and its requested rate rₙ, assigning a corresponding value pair point and determining the distances between value pair points whose corresponding scaled volume weight sdₙ are in the range 0<sdₙ<0.5, as well as the distances between value pair points whose corresponding scaled volume weight sdₙ is in the range 0.5<sdₙ≦1, and value pair points within these limits, in particular those at a small distance from one another, are grouped to form clusters and each assigned to a subregion i (r/sd class) with region limits within which there are value pairs of a cluster.

11-14. (canceled)

15. The method according to claim 1, further comprising:
defining forecasted cargo quantities with regard to their volume Vₘ, their weight Wₘ, their requested price rₘ expressed as price of the chargeable weight cw, their volume weight dₘ, and their scaled volume weight sdₘ,
determining the volume weight dₘ of the cargo units, where
if the weight Wₘ of the cargo quantity m>0 and the volume Vₘ of the cargo quantity m≧0, then the volume weight dₘ=(Vₘ/Wₘ),
if the weight Wₘ of the cargo quantity m=0 and the volume Vₘ of the cargo quantity m>0, then the volume weight dₘ=∞, and
if the weight Wₘ of the cargo quantity m=0 and the volume Vₘ of the cargo quantity m=0, then the volume weight dₘ is indeterminate,
based on the determined volume weight dₘ, determining the scaled volume weight sdₘ, where,
if dₘ=0, then sdₘ=0,
if 0<dₘ≦ds, then sdₘ=dₘ/2ds,
if ds<dₘ<∞, then sdₘ=1−ds/2dₘ, and
if dₘ=∞, then sdₘ=1,
where ds is a given standard volume weight,
defining a two-dimensional region including two intersecting coordinate axes, where the region's first dimension indirectly or directly represents the range of the scaled volume weight sd requested in the transport requests and the region's second dimension represents the requested rate r defined as price of the chargeable weight cw, where the chargeable or billing weight cw is defined as follows:
if Wₘ=0 and the volume Vₘ=0, then cw=0,
if 0<dₘ≦ds, then cw=Wₘ×1000, and
if ds<dₘ≦∞, then cw=Vₘ×1000/ds,
and in the two-dimensional region of the coordinate system formed by the coordinate axes, to each of the value pairs formed from the scaled volume weight sdₘ of a forecasted cargo quantity m and its forecasted rate rₘ, assigning a corresponding value pair point and determining the distances between value pair points whose corresponding scaled volume weight sdₙ is in the range 0<sdₘ≦0.5, as well as the distances between value pair points whose corresponding scaled volume weight sdₘ is in the range 0.5<sdₙ<1, and value pair points within these limits, in particular those at a small distance from one another, are grouped to form clusters and each assigned to a subregion (r/sd class) i with region limits within which there are value pairs of a cluster.

16. The method according to claim 10, wherein for a cargo unit n or a cargo quantity m with a weight Wₙ or Wₘ and a volume Vₙ or Vₘ, as chargeable weight cw of that value, is set, which, in amount, is the greater of the following two values
W_{n/m}×1000 and (1)
V_{n/m}×1000/ds, (2)
where ds is a standard volume weight.

17. The method according to claim 1, further comprising:
defining a two-dimensional region including two intersecting coordinate axes, where the region's first dimension indirectly or directly represents the range of the scaled volume weight sd requested in the transport requests and the region's second dimension represents the requested rate r defined as price of the chargeable weight cw,
forming adjacent regions i with common boundary section in the two-dimensional region which form a continuous surface which is bounded along two sides by the intersecting coordinate axes, where the subregions i are, with regard to their values for the scaled volume weight sd, within the range 0<sd≦0.5 or in the range 0.5<sd<1, and
assigning an expected total value Dᵢ in chargeable weight cw to each of the subregions i, said expected total value being the sum of the expected individual cargo transport requests whose corresponding value pairs, formed by the rate r per chargeable weight cw and the scaled volume weight sd, can be assigned to the scaled volume weight sd.

18. (canceled)

19. The method according to claim 1, further comprising:
accepting an incoming transport request for a cargo unit n if the rate to be expected rₙ is greater than the expected associated lost profit bpₙ, that is, the bid price, insofar as the maximum capacity of cargo volume Vₘₐₓ or the remaining volume capacity Vᵣₑₘ and the maximum capacity of cargo weight Wₘₐₓ or the remaining weight capacity Wᵣₑₘ will not be exceeded on acceptance of the transport request, and otherwise rejected, where the lost profit bpₙ is determined or estimated via the equation
bpₙ=wₙ×bpw+vₙ×pbv,
where
bpₙ stands for the bid price of a unit of a chargeable weight cw of the requested cargo unit, bpw stands for the price of a chargeable weight cw which consists only of weight, that is, has a volume weight d=0, bpv stands for the price of a unit of a chargeable weight cw which consists only of volume, that is, has a volume weight d=∞, wₙ stands for the specific weight consumption and vₙ for the specific volume consumption, where the specific weight consumption or volume consumption is defined as follows:
if 0≦dₙ≦ds, then wₙ=1 and vₙ=dₙ/dₛ,
if ds<dₙ<∞, then wₙ=ds/dₙ and vₙ=1, and
if dₙ=∞, then wₙ=0 and vₙ=1,
where dₙ represents the volume weight of a cargo unit and ds represents the standard volume weight, and where bpw and bpv are determined by solving of the following problem, in particular by means of linear programming:
minimize
$${R}_{F} = {W}_{re m} \times bpw + {V}_{re m} \times bpv + {\sum }_{i} {D}_{i} \times {p}_{i}$$
subject to
wᵢ×bpw+vᵢ×bpv+pᵢ≧rᵢ,
for all the (i)
bpv, bpw, pᵢ≧0,
for all the (i)
where R_{F} stands for the revenue, Wᵣₑₘ stands for the still available weight capacity expressed in chargeable weight cw which consists only of weight, that is, has a volume weight d=0, Vᵣₑₘ stands for the still available volume capacity, expressed in a chargeable weight cw which consists only of volume, that is, has a volume weight d=∞, Dᵢ specifies the forecasted demand for the forecast domain or the subregion (r/sd class) i, expressed in chargeable weight cw, pᵢ specifies the profitability of the forecast domain i, expressed in currency unit per chargeable weight cw, and rᵢ expressed as price per chargeable weight cw specifies the rate of the forecast domain i, and where
the weight and volume coefficient wᵢ and v; are defined as follows:
if 0<dᵢ≦ds, then wᵢ=1 and vᵢ=dᵢ/ds,
if ds<dᵢ<∞, then wᵢ=dᵢ/ds and vᵢ=1, and
if dᵢ=∞, then wᵢ=0 and vᵢ=1, where
dᵢ represents the volume weight value from the domain i, in particular an average value or weighted average value.

20. The method according to claim 19, further comprising applying the bid price bpₙ of a transport request n as follows:
if rₙ≧bpₙ, then the transport request n is to be accepted insofar as the maximum capacity of cargo volume Vₘₐₓ or the remaining volume capacity Vᵣₑₘ and the maximum capacity of cargo weight Wₘₐₓ or the remaining weight capacity Wᵣₑₘ will not be exceeded on acceptance of the n^{th} transport request, and
if rₙ<bpₙ, then the transport request n is to be rejected,
where the bid price bpₙ is derived as follows: wₙ×bpw+vₙ×bpv, and
where rₙ specifies the rate expressed as price per unit of chargeable weight cw, wₙ specifies the specific weight consumption or the weight coefficients of a transport request, vₙ specifies the specific volume consumption or the volume coefficients of a transport request, bpw specifies the price of a unit of a chargeable weight cw which consists only of weight, and bpv specifies the price of a unit of a chargeable weight cw which consists only of volume, and where the weight and volume coefficients are determined as follows:
if 0≦dₙ≦ds, then wₙ=1 and vₙ=dₙ/dₛ,
if ds<dₙ<∞, then wₙ=ds/dₙ and vₙ=1, and
if dₙ=∞, then wₙ=0 and vₙ=1.

21. The method according to claim 19, wherein the bid price bp is represented as a function of the volume weight as follows:
if 0≦d≦ds, then bp=bpw+(d/ds×bpv),
if ds<d<∞, then bp=ds×bpw/d+bpv, and
if d=∞, then bp=bpv,
where bp specifies the bid price of a unit of a chargeable weight cw of the requested cargo unit, bpw specifies the price of a unit of a chargeable weight cw which consists only of weight, bpv specifies the price of a unit of a chargeable weight cw which consists only of volume, d specifies the volume weight, and ds specifies the standard volume weight.

22. The method according to claim 19, wherein the bid price bp is represented as a function of the scaled volume weight as follows:
if 0≦sd≦0.5, then bp=bpw+2sd ×bpv,
if 0.5<sd<1, then bp=2(1−sd)bpw+bpv, and
if sd=1, then bp=bpv,
where bp specifies the bid price, bpw specifies the price of a unit of a chargeable weight cw which consists only of weight, bpv specifies the price of a unit of a chargeable weight cw which consists only of volume, sd specifies the scale volume weight, and ds specifies the standard volume weight.

23. The method according to any one of claims 19-22, wherein the revenue R_{F} of a transport is maximized with the aid of linear optimization as follows:
maximize
$${R}_{F} = {\sum }_{i} {r}_{i} {x}_{i}$$
subject to
$${\sum }_{i} {w}_{i} {x}_{i} \leq {W}_{r em}$$
$${\sum }_{i} {v}_{i} {x}_{i} \leq {V}_{r em}$$
xᵢ≦Dᵢ, for all the (i) and
xᵢ≧0 for all the (i),
where the index i specifies the forecast domain or the subregion (r/sd class), xᵢ specifies to request to be accepted for the forecast domain i expressed in chargeable weight cw, Dᵢ specifies the forecasted demand for the forecast domain i expressed in chargeable weight cw, wᵢ specifies the weight coefficients of the forecast domain i, vᵢ specifies the volume coefficients of the forecast domain i, Wᵣₑₘ specifies the still available weight capacity expressed in chargeable weight cw which consists only of weight, that is, has a volume weight d=0, Vᵣₑₘ specifies the still available volume capacity expressed in chargeable weight cw which consists only of volume, that is, has a volume weight d=∞, and rᵢ specifies the rate of the forecast domain i, in particular in the form of an average value or weighted average value expressed as price per chargeable weight cw, and where
the weight and volume coefficient wᵢ and vᵢ are defined as follows:
if 0≦dᵢ≦ds, then wᵢ=1 and vᵢ=dᵢ/ds,
if ds<dᵢ<∞, then wᵢ=ds/dᵢ and vᵢ=1, and
if dᵢ=∞ then wᵢ=0 and vᵢ=1, where
dᵢ represents the volume weight value from the domain i, in particular an average value or weighted average value.

24. The method according to any one of claims 19-22, wherein the revenue R_{F} and/or the remaining capacity which is expected to be unused, in particular the volume capacity and/or weight capacity which is expected to be unused, of a leg for a transport is determined with the aid of linear optimization as follows:
maximize
$${R}_{F} = {\sum }_{i} {r}_{i} {x}_{i}$$
subject to
$${\sum }_{i} {w}_{i} {x}_{i} + sw = {W}_{re m}$$
$${\sum }_{i} {v}_{i} {x}_{i} + sv = {V}_{re m}$$
xᵢ+sᵢ=Dᵢ,
for all the (i) and
sᵢ, sv, sw, xᵢ≧0
for all the (i),
where R_{F} specifies the revenue over one leg of a transport, the index i specifies the forecast domain or the subregion (r/sd class), xᵢ specifies to request to be accepted for the forecast domain i expressed in chargeable weight cw, Dᵢ specifies the forecasted demand for the forecast domain i expressed in chargeable weight cw, wᵢ specifies the weight coefficients of the forecast domain i, vᵢ specifies the volume coefficients of the forecast domain i, Wᵣₑₘ specifies the still available weight capacity expressed in chargeable weight cw which preferably consists only of weight, that is, has a volume weight d=0, Vᵣₑₘ specifies the still available volume capacity expressed in a chargeable weight cw which preferably consists only of volume, that is, has a volume weight d=∞, sᵢ, sv, and sw specify the slack variables for the request for the forecast domain i of the volume, in particular in the form of a chargeable weight which preferably consists only of volume, that is, has a volume weight d=∞, or of the weight, in particular in the form of a chargeable weight cw which preferably consists only of weight, that is, has a volume weight d=0, and rᵢ specifies the rate of the forecast domain i, in particular in the form of an average value or weighted average value expressed as price per chargeable weight cw, and where
the weight and volume coefficient wᵢ and vᵢ are defined as follows:
if 0≦dᵢ≦ds, then wᵢ=1 and vᵢ=dᵢ/ds,
if ds<dᵢ<∞, then wᵢ=ds/dᵢ and vᵢ=1, and
if dᵢ=∞, then wᵢ=0 and vᵢ=1, where
dᵢ represents the volume weight value from the domain i, in particular an average value or weighted average value.

25. The method according to claim 24, wherein the expected demand for transport at a certain rate/volume weight class i is represented by Dᵢ and the rate and volume weight which correspond to the rate/volume weight class i are represented by rᵢ and dᵢ, respectively.

26. The method according to claim 1, further comprising determining the revenue R_{F} for a leg for a transport, and/or the bid price bpw for a unit of a chargeable weight cw which consists only of weight, and/or the bid price bpv for a unit of a chargeable weight cw which consists only of volume, with the aid of linear optimization as follows:
minimize
$${R}_{F} = {W}_{re m} \times bpw + {V}_{re m} \times bpv + {\sum }_{i} {D}_{i} \times {p}_{i}$$
subject to
wᵢ×bpw+vᵢ×bpv+pᵢ≧rᵢ,
for all the (i)
bpv, bpw, pᵢ≧0,
for all the (i)
where R_{F} specifies the revenue, Wᵣₑₘ specifies the still available weight capacity expressed in chargeable weight cw which preferably consists only of weight, that is, has a volume weight d=0, Vᵣₑₘ specifies the still available volume capacity expressed in chargeable weight cw which preferably consists only of volume, that is, has a volume weight d=∞, bpw specifies the price of a unit of a chargeable weight cw which consists only of weight, bpv specifies the price of a unit of a chargeable weight cw which consists only of volume, Dᵢ specifies the forecasted demand for the forecast domain or the subregion (r/sd class) i expressed in chargeable weight cw, wᵢ specifies the weight coefficients of the forecast domain i, vᵢ specifies the volume coefficients of the forecast domain i, pᵢ specifies the profitability of the forecast domain i expressed in currency unit per chargeable weight cw, and rᵢ, expressed as price per chargeable weight cw specifies the rate of the forecast domain i, where
the weight and volume coefficient wᵢ and vᵢ are defined as follows:
if 0≦dᵢ≦ds, then wᵢ=1 and vᵢ=dᵢ/ds,
if ds<dᵢ<∞, then wᵢ=ds/dᵢ and vᵢ=1, and
if dᵢ=∞, then wᵢ=0 and vᵢ=1, where
dᵢ represents the volume weight value from the domain i, in particular an average value or weighted average value.

27. The method according to claim 19, further comprising determining the revenue R_{F} and/or the remaining capacity which is expected to be unused, in particular volume capacity and/or weight capacity which is expected to be unused, for a transport with at least one segment by solving the following problems with the aid of linear optimization as follows:
maximize
$${R}_{F} = {\sum }_{i} {\sum }_{j} {r}_{ij} {x}_{ij}$$
subject to
$${\sum }_{i} {\sum }_{j} {a}_{kj} {w}_{ij} {x}_{ij} + {sw}_{k} = {W}_{k - r em} , for all k$$
$${\sum }_{i} {\sum }_{j} {a}_{kj} {v}_{ij} {x}_{ij} + {sv}_{k} = {V}_{k - r em} , for all k$$
xᵢⱼ+sᵢⱼ=Dᵢⱼ,
for all the (i, j) and
sᵢⱼ, svₖ, swₖ, xᵢⱼ>0,
for all the (i, j) and k,
where R_{F} specifies the revenue over a transport, the index k specifies the leg of a transport, j specifies the segment of a transport, i specifies the forecast domain or the subregion (r/sd class) of a segment, xᵢⱼ specifies the request to be accepted for the forecast domain i of the segment j expressed in chargeable weight cw, Dᵢⱼ specifies the forecasted demand for the forecast domain i of the segment j expressed in chargeable weight cw, aₖⱼ represents the index coefficient of the leg k on the segment j, where aₖⱼ=0 if the leg k is not a component of the segment j, and where aₖⱼ=1 if the leg k is a component of the segment j, wᵢⱼ specifies the weight coefficients for the forecast domain i of the segment j, vᵢⱼ specifies the volume coefficients for the forecast domain i, Wₖ₋ᵣₑₘ specifies the still available weight capacity expressed in chargeable weight cw which preferably consists only of weight, that is, has a volume weight d=0, of the leg k and Vₖ₋ᵣₑₘ specifies the still available volume capacity expressed in chargeable weight cw which preferably consists only of volume, that is, has a volume weight d=∞, of the leg k, sᵢⱼ, svₖ, and swₖ specify the slack variables for the request for the forecast domain i on the segment j of the volume of the leg k in the form of a chargeable weight cw which preferably consists only of volume, that is, has a volume weight d=∞, or of the weight of the leg k in the form of a chargeable weight cw which preferably consists only of weight, that is, has a volume weight d=0, and rᵢⱼ specifies the rate of the forecast domain i of the segment j expressed as price per chargeable weight cw, and where
the weight and volume coefficient wᵢⱼ and vᵢⱼ are defined as follows:
if 0<dᵢⱼ≦ds, then wᵢⱼ=1 and vᵢⱼ=dᵢⱼ/ds,
if ds<dᵢⱼ<∞, then wᵢⱼ=ds/dᵢⱼ and vᵢⱼ=1, and
if dᵢⱼ=∞, then wᵢⱼ=0 and vᵢⱼ=1, where
dᵢⱼ represents the volume weight value from the domain i of the segment j, in particular an average value or weighted average value.

28. The method according to claim 1, further comprising determining the revenue R_{F} and/or the bid price, in particular the volume-specific bid price bpv and/or the weight-specific bid price bpw, for a transport with at least one segment with the aid of linear optimization as follows:
minimize
$${R}_{F} = {\sum }_{k} {W}_{k - r em} \times {bpw}_{k} + {\sum }_{k} {V}_{k - r em} \times {bvp}_{k} + {\sum }_{i} {\sum }_{j} {D}_{ij} \times {p}_{ij}$$
subject to
Σ aₖⱼ wᵢⱼ×bpwₖ+Σ aₖⱼ vᵢⱼ×bpvₖ+pᵢⱼ≧rᵢⱼ,
for all the (i, j)
bpvₖ, bpwₖ, pᵢⱼ>0,
for all the (i, j) and k,
where R_{F} specifies the revenue over a transport, Wₖ₋ᵣₑₘ specifies the still available weight capacity of the leg k expressed in chargeable weight cw which preferably consists only of weight, that is, has a volume weight d=0, Vₖ₋ᵣₑₘ specifies the still available volume capacity of the leg k expressed in chargeable weight cw which preferably consists only of volume, that is, has a volume weight d=∞, bpwₖ specifies the bid price of the weight capacity of the leg k, bpvₖ specifies the bid price of the volume capacity of the leg k, Dᵢⱼ specifies the forecasted demand for the forecast domain or the subregion (r/d class) i of the segment j expressed in chargeable weight cw, wᵢⱼ specifies the weight coefficients of the forecast domain i of the segment j, vᵢⱼ specifies the volume coefficients of the forecast domain i of the segment j, aₖⱼ represents the index coefficient of the leg k on the segment j where aₖⱼ=0 if the leg k is not a component of the segment j and where aₖⱼ=1 if the leg k is a component of the segment j, and pᵢⱼ specifies the profitability of the forecast domain i of the segment j expressed in chargeable weight cw, and rᵢⱼ specifies the rate of the forecast domain i of the segment j, expressed as price per chargeable weight cw, where
the weight and volume coefficients wᵢⱼ and vᵢⱼ are determined as follows:
if 0≦dᵢⱼ≦ds, then wᵢⱼ=1 and vᵢⱼ=dᵢⱼ/ds,
if ds<dᵢⱼ<∞, then wᵢⱼ=ds/dᵢⱼ and vᵢⱼ=1, and
if dᵢⱼ=∞, then wᵢⱼ=0 and vᵢⱼ=1, where
dᵢⱼ represents the volume weight value from the domain i of the segment j, in particular an average value or weighted average value.

29. (canceled)

30. The method according to claim 1, wherein the cargo transport comprises at least one segment j with at least one leg k, the method further comprising determining the free capacity for a cargo transport relative to the volume weight of a cargo unit, including:
a) for incoming transport requests for cargo units n with the rate rₙ, the volume Vₙ, the weight Wₙ, and the volume weight dₙ, first determining the free capacity fcⱼ of a segment j as a function of the volume weight dₙ via:
if 0<swⱼ≦svⱼ and 0≦dₙ≦ds, then fcⱼ=swⱼ,
if 0<swⱼ≦svⱼ and ds<dₙ≦ds×(svⱼ/swⱼ), then fcⱼ=(d/ds)×swⱼ,
0<swⱼ≦svⱼ and ds×(svⱼ/swⱼ)<dₙ≦∞, then fcⱼ=svⱼ,
if swⱼ>svⱼ>0 and 0≦dₙ≦ds×(svⱼ/swⱼ), then fcⱼ=swⱼ,
if swⱼ>svⱼ>0 and ds×(svⱼ/swⱼ)<dₙ≦ds, then fcⱼ=(ds/dₙ)×svⱼ,
if swⱼ>svⱼ>0 and ds<dₙ≦∞, then fcⱼ=svⱼ,
if swⱼ=0 and svⱼ>0 and 0≦dₙ<∞, then fcⱼ=0,
if swⱼ=0 and svⱼ>0 and dₙ=∞, then fcⱼ=svⱼ,
if swⱼ>0 and svⱼ=0 and dₙ=0, then fcⱼ=swⱼ,
if swⱼ>0 and svⱼ=0 and 0<dₙ≦∞, then fcⱼ=0, and
if swⱼ=0 and svⱼ=0, then fcⱼ=0,
where the preceding parameters have the following meanings:
swⱼ represents the expected unused weight capacity of a segment j expressed in chargeable weight cw with the volume weight d=0, where swⱼ is defined as Min {swₖ, for all k, for which akⱼ=1},
svⱼ represents the expected unused volume capacity of a segment j expressed in chargeable weight cw with the volume weight d=∞, where svⱼ is defined as Min {svₖ, for all k, for which akⱼ=1 }, where
akⱼ=1 if the leg k is contained in the segment j and where
akⱼ=0 if the leg k is not contained in the segment j, and where
cwₙ represents the chargeable weight cw of the transport request n,
fcⱼ represents the free available capacity with the volume weight dₙ, expressed in chargeable weight cw, and
d represents the volume weight,
dₙ represents the volume weight of a cargo unit n which is determined as follows:
if the weight Wₙ of the cargo unit n>0 and the volume Vₙ of the cargo unit n≧0, then the volume weight dₙ=(Vₙ/Wₙ),
if the weight Wₙ of the cargo unit=0 and the volume Vₙ of the cargo unit n>0, then the volume weight dₙ=∞, and
if the weight Wₙ of the cargo unit=0 and the volume Vₙ of the cargo unit=0, then the volume weight dₙ is indeterminate,
ds represents the standard volume weight;
b) determining the chargeable weight cwₙ of the transport request n according to:
if the weight Wₙ in t is equal to 0 and the volume Vₙ in m³ is equal to 0, then cwₙ=0,
if 0≦dₙ≦ds, then cwₙ=Wₙ×1000 and
if ds<dₙ≦∞, then cwₙ=Vₙ1000/ds; and
c) if the chargeable weight cwₙ<fcⱼ, the transport request is accepted and, if the chargeable weight cwₙ>fcⱼ, the transport request is accepted, if, for the transport request of a cargo unit n, the bid price bpₙ≦rₙ, and if Vₙ≦Vᵣₑₘ and Wₙ≦Wᵣₑₘ, and otherwise the transport request is rejected.

31. The method according to claim 30, wherein the bid price bpⱼ is determined via the equation
bpⱼ=wₙ×bpwⱼ+vₙ×bpvⱼ,
where
bpⱼ stands for the bid price of a unit of the chargeable weight cw, in particular of a chargeable kg, of the requested cargo unit or cargo amounts for a segment j with a volume weight dₙ, bpwⱼ stands for the weight capacity access price of the segment j, expressed in price per chargeable weight cw, in particular per chargeable kg, with the volume weight dₙ=0, bpvⱼ stands for the volume capacity access price of the segment j, expressed in price per chargeable weight cw, in particular per chargeable kg, with the volume weight dₙ=∞, where bpwⱼ is defined as the sum of the weight bid prices of all the legs k which are on the segment j, that is, bpwⱼ=Σₖ aₖⱼ×bpwₖ, and where bpvⱼ is defined as the sum of the volume bid prices of all the legs k which are on the segment j, that is, bpvⱼ=Σₖⱼ×aₖⱼ×bpvₖ, where akⱼ=1, if the leg k is contained in the segment j and where akⱼ=0, if the leg k is not contained in the segment j, and where wₙ stand for the specific weight consumption and where vₙ stand for the specific volume consumption, where the specific weight consumption or the specific volume consumption is defined as follows:
if 0≦dₙ≦ds, then wₙ=1 and vₙ=dₙ/ds,
if ds<dₙ<∞, then wₙ=ds/dₙ and vₙ=1,
if dₙ=∞, then wₙ=0 and vₙ=1 and
dₙ represents the volume weight of a cargo unit or cargo amount and ds represents the standard volume weight, and where the bpwₖ and bpvₖ are determined by solving the following problem, in particular by means of linear programming:
minimize
$${R}_{F} = {\sum }_{k} {W}_{k - r em} \times {bpw}_{k} + {\sum }_{k} {V}_{k - r em} \times {bvp}_{k} + {\sum }_{i} {\sum }_{j} {D}_{ij} \times {p}_{ij}$$
subject to
Σ aₖⱼ wᵢⱼ×bpwₖ+Σ aₖⱼ vᵢⱼ×bpvₖ+pᵢⱼ≧rᵢⱼ,
for all the (i, j)
bpvₖ, bpwₖ, pᵢⱼ≧0,
for all the (i, j) and k,
where R_{F} specifies the revenue over a transport, Wₖ₋ᵣₑₘ specifies the still available weight capacity of the leg k expressed in chargeable weight cw which only consists of weight, that is, has a volume weight d=0, and Vₖ₋ᵣₑₘ specifies the still available volume capacity of the leg k expressed in chargeable weight cw which only consists of volume, that is, has a volume weight d=∞, bpwₖ specifies for the bid price of the weight capacity of the leg k, bpvₖ specifies the bid price of the volume capacity of the leg k, Dᵢⱼ specifies the forecasted demand for the forecast domain or the subregion (r/d class) i of segment the j expressed in chargeable weight cw, wᵢⱼ specify the weight coefficients of the forecast domain i of the segment j, vᵢⱼ specify the volume coefficients of the forecast domain i of the segment j, aₖⱼ represents the index coefficient of the leg k on the segment j, where aₖⱼ=0 if the leg k is not a component of the segment j and where aₖⱼ=1 if the leg k is a component of the segment j, and pᵢⱼ specifies the profitability of the forecast domain i of the segment j, expressed in chargeable weight cw, and rᵢⱼ, in particular in the form of an average value or weighted average value, specifies the rate of the forecast domain i of the segment j expressed as price per chargeable weight cw, where
the weight and volume coefficients wᵢⱼ and vᵢⱼ are defined as follows:
if 0≦dᵢⱼ≦ds, then wᵢⱼ=1 and vᵢⱼ=dᵢⱼ/ds,
if ds<dᵢⱼ<∞, then wᵢⱼ=ds/dᵢⱼ and vᵢⱼ=1, and
if dᵢⱼ=∞, then wᵢⱼ=0 and vᵢⱼ=1, where
dᵢⱼ represents a volume weight value from the domain i of the segment j, in particular an average value or weighted average value.

32. The method according to claim 30, wherein the expected unused weight capacity swⱼ of a segment j expressed in chargeable weight cw with the volume weight d=0, and the expected unused volume capacity svⱼ of a segment j expressed in chargeable weight cw with the volume weight d=∞ are determined via Min {swₖ, for all k, for which akⱼ=1 } and Min {svₖ, for all k, for which akⱼ=1 }, and where the values for swₖ and svₖ are determined by solving the following problems with the aid of linear optimization:
maximize
$${R}_{F} = {\sum }_{i} {\sum }_{j} {r}_{ij} {x}_{ij}$$
subject to
$${\sum }_{i} {\sum }_{j} {a}_{kj} {w}_{ij} {x}_{ij} + {sw}_{k} = {W}_{k - re m} , for all the k$$
$${\sum }_{i} {\sum }_{j} {a}_{kj} {v}_{ij} {x}_{ij} + {sv}_{k} = {V}_{k - re m} , for all the k$$
$${x}_{ij} + {s}_{ij} = {D}_{ij} , for all the ( i , j ) and$$
$${s}_{ij} , {sv}_{k} , {sw}_{k} , {x}_{ij} \geq 0 , for all the ( i , j ) and k ,$$
where R_{F} specifies the revenue over a transport, the index k specifies the leg of a transport, j specifies the segment of a transport, i specifies the forecast domain and/or the subregion (r/d class) of a segment, xᵢⱼ specifies the request to be accepted for the forecast domain i of the segment j expressed in chargeable weight cw, Dᵢⱼ specifies the forecast demand for the forecast domain i of the segment j expressed in chargeable weight cw, aₖⱼ represents the index coefficients of the leg k on the segment j, where aₖⱼ=0 if the leg k is not a component of the segment j and where aₖⱼ=1 if the leg k is a component of the segment j, wᵢⱼ specifies the weight coefficients for the forecast domain i of the segment j, vᵢⱼ specifies the volume coefficients for the forecast domain i, Wₖ₋ᵣₑₘ specifies the still available weight capacity expressed in chargeable weight cw which only consists of weight, that is, has a volume weight d=0 of the leg k, and Vₖ₋ᵣₑₘ specifies the still available volume capacity expressed in chargeable weight cw which only consists of volume, that is, has a volume weight d=∞, of the leg k, and sᵢⱼ, svₖ, and swₖ specify the slack variables for the request for the forecast domain i on the segment j of the volume of the leg k, in particular in the form of a chargeable weight cw which only consists of volume, that is, has a volume weight of d=∞, or of the weight of the leg k, in particular in the form of a chargeable weight cw which only consists of weight, that is, has a volume weight d=0, and rᵢⱼ specify the rate of the forecast domain i of the segment j, in particular in the form of an average value or weighted average value, expressed as a price per chargeable weight cw, where the weight and volume coefficients wᵢⱼ and vᵢⱼ are defined as follows:
if 0≦dᵢⱼ≦ds, then wᵢⱼ=1 and vᵢⱼ=dᵢⱼ/ds,
if ds<dᵢⱼ<∞, then wᵢⱼ=ds/dᵢⱼ and vᵢⱼ=1, and
if dᵢⱼ=∞, then wᵢⱼ=0 and vᵢⱼ=1, where
dᵢⱼ represents a volume weight value from the domain i of the segment j in particular an average value or weighted average value.

33. The method according to claim 1, wherein the cargo transport comprises at least one segment j with at least one leg k, the method further comprising determining the free capacity for a cargo transport relative to the scaled volume weight of a cargo unit, including:
a) for incoming transport requests for cargo units n with the rate rₙ, the volume Vₙ, the weight Wₙ, the chargeable weight cwₙ, the volume weight dₙ, and the scaled volume weight sdₙ, first determining the free capacity fcⱼ of a segment j as a function of the scaled volume weight sdₙ via:
if 0<swⱼ≦svⱼ and 0≦sdₙ≦0.5, then fcⱼ=swⱼ,
if 0<swⱼ≦svⱼ and 0.5<sdₙ≦0.5×(svⱼ/swⱼ), then fcⱼ=swⱼ/(2(1−sdₙ)),
if 0<swⱼ≦svⱼ and 0.5×(svⱼ/swⱼ)<sdₙ≦1, then fcⱼ=svⱼ,
if swⱼ>svⱼ>0 and 0≦sdₙ<0.5×(svⱼ/swⱼ), then fcⱼ=swⱼ,
if swⱼ>svⱼ>0 and 0.5×(svⱼ/swⱼ)<sdₙ≦0.5, then fcⱼ=svⱼ/2 sdₙ,
if swⱼ>svⱼ>0 and 0.5<sdₙ≦1, then fcⱼ=svⱼ,
if swⱼ=0 and svⱼ>0 and 0≦sdₙ<1, then fcⱼ=0,
if swⱼ=0 and svⱼ>0 and sdₙ=1, then fcⱼ=svⱼ,
if swⱼ>0 and svⱼ=0 and sdₙ=0, then fcⱼ=swⱼ,
if swⱼ>0 and svⱼ=0 and 0<sdₙ≦1, then fcⱼ=0, and
if swⱼ=0 and svⱼ=0, then fcⱼ=0,
where the preceding parameters have the following meanings:
swⱼ represents the expected unused weight capacity of a segment j expressed in chargeable weight cw with the volume weight d=0, where swⱼ is defined as Min {swₖ, for all k, for which akⱼ=1},
svⱼ represents the expected unused volume capacity of a segment j expressed in chargeable weight cw with the volume weight d=∞, where svⱼ is defined as Min {svₖ, for all k, for which akⱼ=1}, where
akⱼ=1 if the leg k is contained in the segment j and where
akⱼ=0 if the leg k is not contained in the segment j, and where
cwₙ represents the chargeable weight cw of the transport request n,
fcⱼ represents the free available capacity with the scaled volume weight sdₙ, expressed in chargeable weight cw, and
dₙ represents the volume weight of a cargo unit n which is determined as follows:
if the weight Wₙ of the cargo unit n>0 and the volume Vₙ of the cargo unit n≧0, then the volume weight dₙ=(Vₙ/Wₙ),
if the weight Wₙ of the cargo unit=0 and the volume Vₙ of the cargo unit n>0, then the volume weight dₙ=0 and
if the weight Wₙ of the cargo unit=0 and the volume Vₙ of the cargo unit=0, then the volume weight dₙ is indeterminate,
based on the determined volume weight dₙ, determining the scaled volume weight sdₙ, where,
if dₙ=0, then sdₙ=0,
if 0<dₙ≦ds, then sdₙ=dₙ/2ds,
if ds<dₙ<∞, then sdₙ=1−ds/2dₙ, and
if dₙ=∞, then sdₙ=1,
where ds is a given standard volume weight;
b) the chargeable weight cw is determined according to:
if the weight Wₙ in t is equal to 0 and the volume Vₙ in m³ is equal to 0, then cwₙ=0,
if 0≦sdₙ≦0.5, then cwₙ=Wₙ×1000 and
if 0.5<sdₙ≦1, then cwₙ=Vₙ1000/ds; and
c) if the chargeable weight cwₙ≦fcⱼ, the transport request is accepted and, if the chargeable weight cwₙ>fcⱼ, the transport request is accepted, if, the bid price determined for the transport request of a cargo unit n, bpₙ, ≦rₙ, and if Vₙ≦Vᵣₑₘ and Wₙ≦Wᵣₑₘ, and otherwise the transport request is rejected.

34. (canceled)

35. The method according to claim 1, wherein the cargo transport comprises at least one segment j with at least one leg k, the method further comprising determining the revenue from the lowest-valued subregion of expected transport request (bid price) for a segment as a function of the volume weight d, wherein
a) for incoming transport requests for cargo units n with the rate rₙ, the volume Vₙ, the weight Wₙ, and the volume weight dₙ, the bid price bpⱼ is determined as follows:
if 0≦dₙ≦ds, then bpⱼ=bpwⱼ+(dₙ/ds)×bpvⱼ,
if ds<dₙ<∞, then bpⱼ=(ds/dₙ)×bpwⱼ+bpvⱼ, and
if dₙ=∞, then bpⱼ=bpvⱼ,
where the preceding parameters have the following meaning:
dₙ volume weight of the transport request,
ds standard volume weight,
bpⱼ bid price of the segment j at a volume weight dₙ,
bpwⱼ weight capacity access price of the segment j expressed in price per chargeable weight cw with the volume weight dₙ=0 (price of the weight capacity of the segment i),
bpvⱼ volume capacity access price of the segment j expressed in price per chargeable weight cw with the volume weight dₙ=∞ (price of the volume capacity of the segment j),
where bpwⱼ is defined as the sum of the weight bid prices of all the legs k which are on the segment j, that is, bpwⱼ=Σₖ aₖⱼ×bpwₖ, and where bpvⱼ is defined as the sum of the volume bid prices of all the legs k which are on the segment j, that is, bpvⱼ=Σₖ aₖⱼ×bpvₖ,
akⱼ=1 if the leg k is contained in the segment j and where
akⱼ=0 if the leg k is not contained in the segment j, and where
the volume weight of a cargo unit n is determined as follows:
if the weight Wₙ of the cargo unit>0 and the volume Vₙ of the cargo unit≧0, then the volume weight dₙ=(Vₙ/Wₙ),
if the weight Wₙ of the cargo unit=0 and the volume Vₙ of the cargo unit n>0, then the volume weight dₙ=∞,
if the weight Wₙ of the cargo unit=0 and the volume Vₙ of the cargo unit=0, then the volume weight dₙ is indeterminate,
b) the chargeable weight cwₙ of the transport request n is determined as follows:
if the weight Wₙ in t is equal to 0 and the volume Vₙ in m³ is equal to 0, then cwₙ=0,
if 0≦dₙ≦ds, then cwₙ=Wₙ×1000 and
if ds<dₙ≦∞, then cwₙ=Vₙ×1000/ds;
c) if the rate rₙ≧bpⱼ and if Vₙ≦Vᵣₑₘ and Wₙ≦Wᵣₑₘ, the transport request is accepted and, if the rate rₙ<bpⱼ, the transport request is rejected.

36. The method according to claim 1, wherein the cargo transport comprises at least one segment j with at least one leg k, the method further comprising determining the revenue from the lowest-valued subregion of expected transport request (bid price) for a segment as a function of the scaled volume weight sd, wherein
a) for incoming transport requests for cargo units n with the rate rₙ, the volume Vₙ, the weight Wₙ, the volume weight dₙ, and the scaled volume weight sdₙ, the bid price bpⱼ is determined as follows:
if 0≦sdₙ<0.5, then bpⱼ=bpwⱼ+2 sdₙ×bpvⱼ,
if 0.5<sdₙ<1, then bpⱼ=2(1−sdₙ)×bpwⱼ+bpvⱼ, and
if dₙ=1, then bpⱼ=bpvⱼ,
where the preceding parameters have the following meaning:
dₙ volume weight of the transport request
sdₙ scaled volume weight of the transport request
bpⱼ bid price of the segment j at a scaled volume weight sdₙ
bpwⱼ weight capacity access price of the segment j, expressed in price per chargeable weight cw, in particular per chargeable kg with the volume weight dₙ=0 (price of the weight capacity of the segment j),
bpvⱼ volume capacity access price of the segment j, expressed in price per chargeable weight cw, in particular per chargeable kg with the volume weight dₙ=∞ (price of the volume capacity of the segment j),
where bpwⱼ is defined as the sum of the weight bid prices of all the legs k which are on the segment j, that is, bpwⱼ=Σₖ aₖⱼ×bpwₖ, and where bpvⱼ is defined as the sum of the volume bid prices of all the legs k which are on the segment j, that is, bpvⱼ=Σₖ akⱼ×bpvₖ,
akⱼ=1 if the leg k is contained in the segment j and where
akⱼ=0 if the leg k is not contained in the segment j,
and where
the volume weight of a cargo unit n is determined as follows:
if the weight Wₙ of the cargo unit>0 and the volume Vₙ of the cargo unit≧0, then the volume weight dₙ=(Vₙ/Wₙ),
if the weight Wₙ of the cargo unit=0 and the volume Vₙ of the cargo unit n>0, then the volume weight dₙ=∞,
if the weight Wₙ of the cargo unit=0 and the volume Vₙ of the cargo unit=0, then the volume weight dₙ is indeterminate,
based on the determined volume weight d, determining the scaled volume weight sdₙ, where,
if dₙ=0, then sdₙ=0,
if 0<dₙ≦ds, then sdₙ=dₙ/2ds,
if ds<dₙ<∞, then sdₙ=1−ds/2dₙ, and
if dₙ=∞, then sdₙ=1,
where ds is a given standard volume weight;
b) the chargeable weight cwₙ of the transport request n is determined as follows:
if the weight Wₙ in t is equal to 0 and the volume Vₙ in m³ is equal to 0, then cwₙ=0, if 0≦sdₙ≦0.5, then cwₙ=Wₙ×1000 and
if 0.5<sdₙ≦1, then cwₙ=Vₙ×1000/ds; and
c) if the rate rₙ≧2bpⱼ and if Vₙ≦Vᵣₑₘ and Wₙ≦Wᵣₑₘ, the transport request is accepted and, if the rate rₙ<bpⱼ, the transport request is rejected.

37. A system for optimizing the utilization of and/or maximizing revenue from a cargo space for a cargo transport, said system comprising a processor configured to:
record incoming transport requests for cargo units n, and for each transport request, with regard to its volume Vₙ, its weight Wₙ, and, in given cases its rate rₙ as price per chargeable weight unit cw,
determine the volume weights dₙ of the cargo units n, where
if the weight Wₙ of the n^{th} cargo unit>0 and the volume Vₙ of the n^{th} cargo unit≧0, then the volume weight dₙ=(Vₙ/Wₙ),
if the weight Wₙ of the n^{th} cargo unit=0 and the volume Vₙ of the n^{th} cargo unit>0, then the volume weight dₙ=∞, and
if the weight Wₙ of the n^{th} cargo unit=0 and the volume Vₙ of the n^{th} cargo unit=0, then the volume weight dₙ is indeterminate,
based on the determined volume weight dₙ, determine the scaled volume weight sdₙ, where,
if dₙ=0, then sdₙ=0,
if 0<dₙ≦ds, then sdₙ=dₙ/2ds,
if ds<dₙ<∞, then sdₙ=1−ds/2dₙ, and
if dₙ=∞, then sdₙ=1,
where ds is a given standard volume weight;
determine whether the scaled volume weight sdₙ of the transport request for the n^{th} cargo unit has an extreme scaled volume weight sdₙ which is in a range of 0≦sdₙ<0.5 or of 0.5<sdₙ≦1, and
accept the transport request if it has an extreme scaled volume weight sdₙ, insofar as the maximum capacity of cargo volume Vₘₐₓ and the maximum capacity of cargo weight Wₘₐₓ will not be exceeded on acceptance of the n^{th} transport request.

38. (canceled)

39. The system according to claim 37, wherein the processor is further configured to:
record incoming transport requests for cargo units n, and for each transport request, with regard to its volume Vₙ, its weight Wₙ, and, in given cases, its rate rₙ as price per chargeable weight unit cw,
determine the volume weights dₙ of the cargo units, where
if the weight Wₙ of the n^{th} cargo unit>0 and the volume Vₙ of the n^{th} cargo unit≧0, then the volume weight dₙ=(Vₙ/Wₙ),
if the weight Wₙ of the n^{th} cargo unit=0 and the volume Vₙ of the n^{th} cargo unit>0, then the volume weight dₙ=∞, and
if the weight Wₙ of the n^{th} cargo unit=0 and the volume Vₙ of the n^{th} cargo unit=0, then the volume weight dₙ is indeterminate,
based on the determined volume weight dₙ, determine the scaled volume weight sdₙ, where,
if dₙ=0, then sdₙ=0,
if 0<dₙ<ds, then sdₙ=dₙ/2ds,
if ds<dₙ<∞, then sdₙ=1−ds/2dₙ, and
if dₙ=∞, then sdₙ=1,
where ds is a given standard volume weight;
determine a still available capacity of volume Vᵣₑₘ, taking into account the maximum capacity of cargo volume Vₘₐₓ, and the still available capacity of weight Wᵣₑₘ, taking into account the maximum capacity of cargo weight Wₘₐₓ,
calculate the volume weight dₖ of the still available capacity via dₖ=Vᵣₑₘ/Wᵣₑₘ, and
if dₖ=0, then sdₖ=0,
if 0<dₖ≦ds, then sdₖ=dₖ/2ds,
if ds<dₖ<∞, then sdₖ=1−ds/2dₖ, and
if dₖ=∞, then sdₖ=1, in which sdₖ represents the scaled volume weight of the still available capacity dₖ and where
if the weight Wᵣₑₘ>0 and the volume Vᵣₑₘ>0, then the volume weight dₖ=(Vᵣₑₘ/Wᵣₑₘ),
if the weight Wᵣₑₘ=0 and the volume Vᵣₑₘ>0, then the volume weight dₖ=∞, and
if the weight Wᵣₑₘ=0 and the volume Vᵣₑₘ=0, then the volume weight dₖ is indeterminate,
determine whether the scaled volume weight sdₖ of the available capacity is smaller than, greater than, or the same as 0.5, and
if sdₖ<0.5, accept the transport request if sdₙ<sdₖ or if 0≦sdₙ≦0.5,
if sdₖ>0.5, accept the transport request if sdₙ>sdₖ or if 0.5≦sdₙ≦1, and
if sdₖ=0.5, accept the transport request if 0≦sdₙ<0.5 or 0.5<sdₙ≦1,
insofar as the maximum capacity of cargo volume Vₘₐₓ and the maximum capacity of cargo weight Wₘₐₓ will not be exceeded on acceptance of the n^{th} transport request.

40-41. (canceled)

42. The system according to claim 37, wherein the processor is further configured to:
record incoming transport requests for cargo units n with regard to their volume Vₙ, their weight Wₙ, their chargeable weight unit cw, and their rate rₙ per chargeable weight unit cw of the cargo unit n,
determine the volume weight dₙ of the cargo units, where
if the weight Wₙ of the n^{th} cargo unit≧0 and the volume Vₙ of the n^{th} cargo unit≧0, then the volume weight dₙ=(Vₙ/Wₙ),
if the weight Wₙ of the n^{th} cargo unit=0 and the volume Vₙ of>0, then the volume weight dₙ=∞, and
if the weight Wₙ of the n^{th} cargo unit=0 and the volume Vₙ of the n^{th} cargo unit=0, then the volume weight dₙ is indeterminate,
based on the determined volume weight dₙ, determine the scaled volume weight sdₙ, where,
if dₙ=0, then sdₙ=0,
if 0<dₙ≦ds, then sdₙ=dₙ/2ds,
if dₛ<dₙ<∞, then sdₙ=1−ds/2dₙ, and
if dₙ=∞, then sdₙ=1,
where ds is a standard volume weight,
on the basis of the determined amount of scaled volume weights sdₙ, form at least two volume weight classes Kₓ with lower and upper classes limits d_{g}, where no class Kₓ is formed which has a lower limit with an sd value<0.5 and an upper limit with an sd value>0.5,
calculate the volume weights of the class limits d_{g} in such a manner that
if sd_{g}=0, then d_{g}=0,
if 0<sd_{g}<0.5, then d_{g}=2 sd_{g}×ds,
if 0.5<sd_{g}<1, then d_{g}=ds/(2−2 sd_{g}), and
if sd_{g}=1, then d_{g}=∞, and
assign the cargo units n to the volume weight classes Kₓ(dₙ).

43. The system according to claim 37, wherein the processor is further configured to:
record forecasted cargo quantities with regard to their volume Vₘ, their weight Wₘ, their requested price rₘ for the chargeable weight cw, of the cargo quantity m,
determine the volume weight dₘ of the cargo units, where
if the weight Wₘ of the cargo quantity m≧0 and the volume Vₘ of the cargo quantity m≧0, then the volume weight dₘ=(Vₘ/Wₘ),
if the weight Wₘ of the cargo quantity m=0 and the volume Vₘ>0, then the volume weight dₘ=∞, and
if the weight Wₘ of the cargo quantity m=0 and the volume Vₘ=0, then the volume weight dₘ is indeterminate,
based on the determined volume weight dₘ, determine the scaled volume weight sdₘ, where,
if dₘ=0, then sdₘ=0,
if 0<dₘ≦ds, then sdₘ=dₘ/2ds,
if ds<dₘ<∞, then sdₘ=1−ds/2dₘ, and
if dₘ=∞, then sdₘ=1,
where ds is a given standard volume weight,
on the basis of the forecasted amount with the scaled volume weights sdₘ, form at least two volume weight classes K_{z} with lower and upper classes limits d_{f}, where no class K_{z} is formed which has a lower limit with an sd value<0.5 and an upper limit with an sd value>0.5,
calculate the volume weights d_{f} of the class limits in such a manner that
if sd_{f}=0, then d_{f}=0,
if 0<sd_{f}≦0.5, then d_{f}=2 sd_{f}×ds,
if 0.5<sd_{f}<1, then d_{f}=ds/(2−2 sd_{f}), and
if sd_{f}=1, then d_{f}=∞, and
assign the cargo amounts m to the volume weight classes K_{z}(dₘ).

44-45. (canceled)

46. The system according to claim 37, wherein the processor is further configured to:
define an amount of incoming cargo transport requests via their respective requested volumes Vₙ, requested weights Wₙ, their attainable rates rₙ expressed as price per chargeable weight unit cw, the volume weight dₙ, and the scaled volume weight sdₙ,
determine the volume weight dₙ of a cargo unit n as follows, where
if the weight Wₙ of the n^{th} cargo unit>0 and the volume Vₙ of the n^{th} cargo unit≧0, then the volume weight dₙ=(Vₙ/Wₙ),
if the weight Wₙ of the n^{th} cargo unit=0 and the volume Vₙ of the n^{th} cargo unit>0, then the volume weight dₙ=∞, and
if the weight Wₙ of the n^{th} cargo unit=0 and the volume Vₙ of the n^{th} cargo unit=0, then the volume weight dₙ is indeterminate,
based on the determined volume weight dₙ determine the scaled volume weight sdₙ, where,
if dₙ=0, then sdₙ=0,
if 0<dₙ≦ds, then sdₙ=dₙ/2ds,
if ds<dₙ<∞, then sdₙ=1−ds/2dₙ, and
if dₙ=∞, then sdₙ=1,
where ds is a given standard volume weight,
define a two-dimensional region including two intersecting coordinate axes, where the region's first dimension indirectly or directly represents the range of the scaled volume weight sdₙ requested in the transport requests and the region's second dimension represents the requested rate rₙ defined as price of the chargeable weight cw, where
the amount of the chargeable weight cw is defined as follows:
if Wₙ=0 and the volume Vₙ=0, then cw=0,
if 0<dₙ≦ds, then cw=Wₙ×1000, and
if ds<dₙ≦∞, then cw=Vₙ×1000/ds,
and in the two-dimensional region of the coordinate system formed by the coordinate axes, to each of the value pairs formed from the scaled volume weight sdₙ of a requested n^{th} cargo unit and its requested rate rₙ, assign a corresponding value pair point and determine the distances between value pair points whose corresponding scaled volume weight sdₙ are in the range 0<sdₙ≦0.5, as well as the distances between value pair points whose corresponding scaled volume weight sd, is in the range 0.5<sdₙ≦1, and group value pair points within these limits, in particular those at a small distance from one another, to form clusters and each assigned to a subregion i (r/sd class) with region limits within which there are value pairs of a cluster.

47-50. (canceled)

51. The system according to claim 37, wherein the processor is further configured to:
define forecasted cargo quantities with regard to their volume Vₘ, their weight Wₘ, their requested price rₘ expressed as price of the chargeable weight cw, their volume weight dₘ, and their scaled volume weight sdₘ,
determine the volume weight dₘ of the cargo units, where
if the weight Wₘ of the cargo quantity m>0 and the volume Vₘ of the cargo quantity m≧0, then the volume weight dₘ=(Vₘ/Wₘ),
if the weight Wₘ of the cargo quantity m=0 and the volume Vₘ of the cargo quantity m>0, then the volume weight dₘ=∞, and
if the weight Wₘ of the cargo quantity m=0 and the volume Vₘ of the cargo quantity m=0, then the volume weight dₘ is indeterminate,
based on the determined volume weight dₘ, determine the scaled volume weight sdₘ, where,
if dₘ=0, then sdₘ=0,
if 0<dₘ≦ds, then sdₘ=dₘ/2ds,
if ds<dₘ<∞, then sdₘ=1−ds/2dₘ, and
if dₘ=∞, then sdₘ=1,
where ds is a given standard volume weight,
define a two-dimensional region including two intersecting coordinate axes, where the region's first dimension indirectly or directly represents the range of the scaled volume weight sd requested in the transport requests and the region's second dimension represents the requested rate r defined as price of the chargeable weight cw, where the chargeable weight cw is defined as follows:
if Wₘ=0 and the volume Vₘ=0, then cw=0,
if 0<dₘ≦ds, then cw=Wₘ×1000, and
if ds<dₘ≦∞, then cw=Vₘ×1000/ds,
and in the two-dimensional region of the coordinate system formed by the coordinate axes, to each of the value pairs formed from the scaled volume weight sdₘ of a forecasted cargo quantity m and its forecasted rate rₘ, assign a corresponding value pair point and determine the distances between value pair points whose corresponding scaled volume weight sdₙ is in the range 0<sdₘ≦0.5, as well as the distances between value pair points whose corresponding scaled volume weight sdₘ is in the range 0.5<sdₙ<1, and group value pair points within these limits, in particular those at a small distance from one another, to form clusters and each assigned to a subregion (r/sd class) i with region limits within which there are value pairs of a cluster.

52. The system according to claims 46, wherein for a cargo unit n or a cargo quantity m with a weight Wₙ or Wₘ and a volume Vₙ or Vₘ, as chargeable weight cw of that value, is set, which, in amount, is the greater of the following two values
W_{n/m}×1000 (1)
and
V_{n/m}×1000/ds, (2)
where ds is a standard volume weight.

53. The system according to claim 37, wherein the processor is further configured to:
define a two-dimensional region including two intersecting coordinate axes, where the region's first dimension indirectly or directly represents the range of the scaled volume weight sd requested in the transport requests and the region's second dimension represents the requested rate r defined as price of the chargeable weight cw,
form adjacent regions i with common boundary section in the two-dimensional region which form a continuous surface which is bounded along two sides by the intersecting coordinate axes, where the subregions i are, with regard to their values for the scaled volume weight sd, within the range 0<sd≦0.5 or in the range 0.5<sd<1, and
assign an expected total value Dᵢ in chargeable weight cw to each of the subregions i, said expected total value being the sum of the expected individual cargo transport requests whose corresponding value pairs, formed by the rate r per chargeable weight cw and the scaled volume weight sd, can be assigned to the scaled volume weight sd.

54. (canceled)

55. The system according to claim 37, wherein the processor is further configured to:
accept an incoming transport request for a cargo unit n if the rate to be expected rₙ is greater than the expected associated lost profit bpₙ, that is, the bid price, insofar as the maximum capacity of cargo volume Vₘₐₓ or the remaining volume capacity Vᵣₑₘ and the maximum capacity of cargo weight Wₘₐₓ or the remaining weight capacity Wᵣₑₘ will not be exceeded on acceptance of the transport request, and otherwise rejected, where the lost profit bpₙ is determined or estimated via the equation
bpₙ=wₙ×bpw+vₙ×pbv,
where
bpₙ stands for the bid price of a unit of a chargeable weight cw of the requested cargo unit, bpw stands for the price of a chargeable weight cw which consists only of weight, that is, has a volume weight d=0, bpv stands for the price of a unit of a chargeable weight cw which consists only of volume, that is, has a volume weight d=∞, wₙ stands for the specific weight consumption and vₙ for the specific volume consumption, where the specific weight consumption or volume consumption is defined as follows:
if 0≦dₙ≦ds, then wₙ=1 and vₙ=dₙ/ds,
if ds<dₙ<∞, then wₙ=ds/dₙ and vₙ=1, and
if dₙ=∞, then wₙ=0 and vₙ=1,
where dₙ represents the volume weight of a cargo unit and ds represents the standard volume weight, and where bpw and bpv are determined by solving of the following problem, in particular by means of linear programming:
minimize
$${R}_{F} = {W}_{r em} \times bpw + {V}_{re m} \times bpv + {\sum }_{i} {D}_{i} \times {p}_{i}$$
subject to
wᵢ×bpw+vᵢ×bpv+pᵢ≧rᵢ,
for all the (i)
bpv, bpw, pᵢ≧0,
for all the (i)
where R_{F} stands for the revenue, Wᵣₑₘ stands for the still available weight capacity expressed in chargeable weight cw which consists only of weight, that is, has a volume weight d=0, Vᵣₑₘ stands for the still available volume capacity, expressed in a chargeable weight cw which consists only of volume, that is, has a volume weight d=∞, Dᵢ specifies the forecasted demand for the forecast domain or the subregion (r/sd class) i, expressed in chargeable weight cw, pᵢ specifies the profitability of the forecast domain i, expressed in currency unit per chargeable weight cw, and rᵢ expressed as price per chargeable weight cw specifies the rate of the forecast domain i, and where
the weight and volume coefficient wᵢ and vᵢ are defined as follows:
if 0<dᵢ≦ds, then wᵢ=1 and vᵢ=dᵢ/ds,
if ds<dᵢ<∞, then wᵢ=dᵢ/ds and vᵢ=1, and
if dᵢ=∞, then wᵢ=0 and vᵢ=1, where
dᵢ represents the volume weight value from the domain i, in particular an average value or weighted average value.

56. The system according to claim 55, wherein the processor is further configured to apply the bid price bpₙ of a transport request n as follows:
if rₙ≧bpₙ, then accept the transport request n insofar as the maximum capacity of cargo volume Vₘₐₓ or the remaining volume capacity Vᵣₑₘ and the maximum capacity of cargo weight Wₘₐₓ or the remaining weight capacity Wᵣₑₘ will not be exceeded on acceptance of the n^{th} transport request, and
if rₙ<bpₙ, then reject the transport request n,
where the bid price bpₙ is derived as follows: wₙ×bpw+vₙ×bpv, and
where rₙ specifies the rate expressed as price per unit of chargeable weight cw, wₙ specifies the specific weight consumption or the weight coefficients of a transport request, vₙ specifies the specific volume consumption or the volume coefficients of a transport request, bpw specifies the price of a unit of a chargeable weight cw which consists only of weight, and bpv specifies the price of a unit of a chargeable weight cw which consists only of volume, and where the weight and volume coefficients are determined as follows:
if 0≦dₙ≦ds, then wₙ=1 and vₙ=dₙ/ds,
if ds<dₙ<∞, then wₙ=ds/dₙ and vₙ=1, and
if dₙ=∞, then wₙ=0 and vₙ=1.

57. The system according to claim 55, wherein the bid price bp is represented as a function of the volume weight as follows:
if 0≦d≦ds, then bp=bpw+(d/ds×bpv),
if ds<d<∞, then bp=ds×bpw/d+bpv, and
if d=∞, then bp=bpv,
where bp specifies the bid price of a unit of a chargeable weight cw of the requested cargo unit, bpw specifies the price of a unit of a chargeable weight cw which consists only of weight, bpv specifies the price of a unit of a chargeable weight cw which consists only of volume, d specifies the volume weight, and ds specifies the standard volume weight.

58. The system according to claim 55, wherein the bid price bp is represented as a function of the scaled volume weight as follows:
if 0≦sd≦0.5, then bp=bpw+2 sd×bpv,
if 0.5<sd<1, then bp=2(1−sd)bpw+bpv, and
if sd=1, then bp=bpv,
where bp specifies the bid price, bpw specifies the price of a unit of a chargeable weight cw which consists only of weight, bpv specifies the price of a unit of a chargeable weight cw which consists only of volume, sd specifies the scale volume weight, and ds specifies the standard volume weight.

59. The system according to any one of claims 55-58, wherein the processor is further configured to maximize the revenue R_{F} of a transport with the aid of linear optimization as follows:
maximize
$${R}_{F} = {\sum }_{i} {r}_{i} {x}_{i}$$
subject to
$${\sum }_{i} {w}_{i} {x}_{i} \leq {W}_{r em}$$
$${\sum }_{i} {v}_{i} {x}_{i} \leq {V}_{r em}$$
$${x}_{i} \leq {D}_{i} , for all the ( i ) and$$
$${x}_{i} \geq 0 for all the ( i ) ,$$
where the index i specifies the forecast domain or the subregion (r/sd class), xᵢ specifies to request to be accepted for the forecast domain i expressed in chargeable weight cw, Dᵢ specifies the forecasted demand for the forecast domain i expressed in chargeable weight cw, wᵢ specifies the weight coefficients of the forecast domain i, vᵢ specifies the volume coefficients of the forecast domain i, Wᵣₑₘ specifies the still available weight capacity expressed in chargeable weight cw which consists only of weight, that is, has a volume weight d=0, Vᵣₑₘ specifies the still available volume capacity expressed in chargeable weight cw which consists only of volume, that is, has a volume weight d=∞, and rᵢ specifies the rate of the forecast domain i, in particular in the form of an average value or weighted average value expressed as price per chargeable weight cw, and where
the weight and volume coefficient wᵢ and vᵢ are defined as follows:
if 0≦dᵢ≦ds, then wᵢ=1 and v_{i =d}ᵢ/ds,
if ds<dᵢ<∞, then wᵢ=ds/dᵢ and vᵢ=1, and
if dᵢ=∞, then wᵢ=0 and vᵢ=1, where
dᵢ represents the volume weight value from the domain i, in particular an average value or weighted average value.

60. The system according to any one of claims 55-58, wherein the processor is further configured to determine the revenue R_{F} and/or the remaining capacity which is expected to be unused, in particular the volume capacity and/or weight capacity which is expected to be unused, of a leg for a transport, with the aid of linear optimization as follows:
maximize
$${R}_{F} = {\sum }_{i} {r}_{i} {x}_{i}$$
subject to
$${\sum }_{i} {w}_{i} {x}_{i} + sw = {W}_{r em}$$
$${\sum }_{i} {v}_{i} {x}_{i} + sv = {V}_{r em}$$
xᵢ+sᵢ=Dᵢ,
for all the (i) and
sᵢ, sv, sw, xᵢ23 0
for all the (i)
where R_{F} specifies the revenue over one leg of a transport, the index i specifies the forecast domain or the subregion (r/sd class), xᵢ specifies to request to be accepted for the forecast domain i expressed in chargeable weight cw, Dᵢ specifies the forecasted demand for the forecast domain i expressed in chargeable weight cw, wᵢ specifies the weight coefficients of the forecast domain i, vᵢ specifies the volume coefficients of the forecast domain i, Wᵣₑₘ specifies the still available weight capacity expressed in chargeable weight cw which preferably consists only of weight, that is, has a volume weight d=0, Vᵣₑₘ specifies the still available volume capacity expressed in a chargeable weight cw which preferably consists only of volume, that is, has a volume weight d=∞, sᵢ, sv, and sw specify the slack variables for the request for the forecast domain i of the volume, in particular in the form of a chargeable weight which preferably consists only of volume, that is, has a volume weight d=∞, or of the weight, in particular in the form of a chargeable weight cw which preferably consists only of weight, that is, has a volume weight d=0, and rᵢ specifies the rate of the forecast domain i, in particular in the form of an average value or weighted average value expressed as price per chargeable weight cw, and where
the weight and volume coefficient wᵢ and vᵢ are defined as follows:
if 0≦di≦ds, then wᵢ=1 and vᵢ=dᵢ/ds,
if ds<dᵢ<∞, then wᵢ=ds/dᵢ and vᵢ=1, and
if dᵢ=∞, then wᵢ=0 and vᵢ=1, where
dᵢ represents the volume weight value from the domain i, in particular an average value or weighted average value.

61. The system according to claim 60, wherein the expected demand for transport at a certain rate/volume weight class i is represented by Dᵢ and the rate and volume weight which correspond to the rate/volume weight class i are represented by rᵢ and dᵢ, respectively.

62. The system according to claim 37, wherein the processor is further configured to determine the revenue R_{F} for a leg for a transport, and/or the bid price bpw for a unit of a chargeable weight cw which consists only of weight, and/or the bid price bpv for a unit of a chargeable weight cw which consists only of volume, with the aid of linear optimization as follows:
minimize
$${R}_{F} = {W}_{r em} \times bpw + {V}_{re m} \times bpv + {\sum }_{i} {D}_{i} \times {p}_{i}$$
subject to
wᵢ×bpw+vᵢ×bpv+pᵢ≧rᵢ,
for all the (i)
bpv, bpw, pᵢ≧0,
for all the (i)
where R_{F} specifies the revenue, Wᵣₑₘ specifies the still available weight capacity expressed in chargeable weight cw which preferably consists only of weight, that is, has a volume weight d=0, Vᵣₑₘ specifies the still available volume capacity expressed in chargeable weight cw which preferably consists only of volume, that is, has a volume weight d=∞, bpw specifies the price of a unit of a chargeable weight cw which consists only of weight, bpv specifies the price of a unit of a chargeable weight cw which consists only of volume, Dᵢ specifies the forecasted demand for the forecast domain or the subregion (r/sd class) i expressed in chargeable weight cw, wᵢ specifies the weight coefficients of the forecast domain i, vᵢ specifies the volume coefficients of the forecast domain i, pᵢ specifies the profitability of the forecast domain i expressed in currency unit per chargeable weight cw, and rᵢ, expressed as price per chargeable weight cw specifies the rate of the forecast domain i, where
the weight and volume coefficient wᵢ and vᵢ are defined as follows:
if 0≦dᵢ≦ds, then wᵢ=1 and vᵢ=dᵢ/ds,
if ds<dᵢ<∞, then wᵢ=ds/dᵢ and vᵢ=1, and
if dᵢ=∞, then wᵢ=0 and vᵢ=1, where
dᵢ represents the volume weight value from the domain i, in particular an average value or weighted average value.

63. The system according to claim 55, wherein the processor is further configured to determine the revenue R_{F} and/or the remaining capacity which is expected to be unused, in particular volume capacity and/or weight capacity which is expected to be unused, for a transport with at least one segment, by solving the following problems with the aid of linear optimization as follows:
maximize
$${R}_{F} = {\sum }_{i} {\sum }_{j} {r}_{ij} {x}_{ij}$$
subject to
$${\sum }_{i} {\sum }_{j} {a}_{kj} {w}_{ij} {x}_{ij} + s {w}_{k} = {W}_{k - r em} , for all the k$$
$${\sum }_{i} {\sum }_{j} {a}_{kj} {v}_{ij} {x}_{ij} + s {v}_{k} = {V}_{k - r em} , for all the k$$
xᵢⱼ+sᵢⱼ=Dᵢⱼ,
for all the (i, j) and
sᵢⱼ, svₖ, swₖ, xᵢⱼ≧0,
for all the (i, j) and k,
where R_{F} specifies the revenue over a transport, the index k specifies the leg of a transport, j specifies the segment of a transport, i specifies the forecast domain or the subregion (r/sd class) of a segment, xᵢⱼ specifies the request to be accepted for the forecast domain i of the segment j expressed in chargeable weight cw, Dᵢⱼ specifies the forecasted demand for the forecast domain i of the segment j expressed in chargeable weight cw, aₖⱼ represents the index coefficient of the leg k on the segment j, where aₖⱼ=0 if the leg k is not a component of the segment j, and where aₖⱼ=1 if the leg k is a component of the segment j, wᵢⱼ specifies the weight coefficients for the forecast domain i of the segment j, vᵢⱼ specifies the volume coefficients for the forecast domain i, Wₖ₋ᵣₑₘ specifies the still available weight capacity expressed in chargeable weight cw which preferably consists only of weight, that is, has a volume weight d=0, of the leg k and Vₖ₋ᵣₑₘ specifies the still available volume capacity expressed in chargeable weight cw which preferably consists only of volume, that is, has a volume weight d=∞, of the leg k, sᵢⱼ, svₖ, and swₖ specify the slack variables for the request for the forecast domain i on the segment j of the volume of the leg k in the form of a chargeable weight cw which preferably consists only of volume, that is, has a volume weight d=∞, or of the weight of the leg k in the form of a chargeable weight cw which preferably consists only of weight, that is, has a volume weight d=0, and rᵢⱼ specifies the rate of the forecast domain i of the segment j expressed as price per chargeable weight cw, and where
the weight and volume coefficient wᵢⱼ and vᵢⱼ are defined as follows:
if 0<dᵢⱼ≦ds, then wᵢⱼ=1 and vᵢⱼ=dᵢⱼ/ds,
if ds<dᵢⱼ<∞, then wᵢⱼ=ds/dᵢⱼ and vᵢⱼ=1, and
if dᵢⱼ=∞m then wᵢⱼ=0 and vᵢⱼ=1, where
dᵢⱼ represents the volume weight value from the domain i of the segment j, in particular an average value or weighted average value.

64. The system according to claim 37, wherein the processor is further configured to determine the revenue R_{F} and/or the bid price, in particular the volume-specific bid price bpv and/or the weight-specific bid price bpw, for a transport with at least one segment, with the aid of linear optimization as follows:
minimize
$${R}_{F} = {\sum }_{k} {W}_{k - re m} \times b p {w}_{k} + {\sum }_{k} {V}_{k - r em} \times b p {v}_{k} + {\sum }_{i} {\sum }_{j} {D}_{ij} \times {p}_{ij}$$
subject to
Σ aₖⱼ wᵢⱼ×bpwₖ+Σ aₖⱼ vᵢⱼ×bpvₖ+pᵢⱼ≧rᵢⱼ,
for all the (i, j)
bpvₖ, bpwₖ, pᵢⱼ≧0,
for all the (i, j) and k,
where R_{F} specifies the revenue over a transport, Wₖ₋ᵣₑₘ specifies the still available weight capacity of the leg k expressed in chargeable weight cw which preferably consists only of weight, that is, has a volume weight d=0, Vₖ₋ᵣₑₘ specifies the still available volume capacity of the leg k expressed in chargeable weight cw which preferably consists only of volume, that is, has a volume weight d=∞,1 bpwₖ specifies the bid price of the weight capacity of the leg k, bpvₖ specifies the bid price of the volume capacity of the leg k, Dᵢⱼ specifies the forecasted demand for the forecast domain or the subregion (r/d class) i of the segment j expressed in chargeable weight cw, wᵢⱼ specifies the weight coefficients of the forecast domain i of the segment j, vᵢⱼ specifies the volume coefficients of the forecast domain i of the segment j, aₖⱼ represents the index coefficient of the leg k on the segment j where aₖⱼ=0 if the leg k is not a component of the segment j and where aₖⱼ=1 if the leg k is a component of the segment j, and pᵢⱼ specifies the profitability of the forecast domain i of the segment j expressed in chargeable weight cw, and rᵢⱼ specifies the rate of the forecast domain i of the segment j, expressed as price per chargeable weight cw, where
the weight and volume coefficients wᵢⱼ and vᵢⱼ are determined as follows:
if 0≦dᵢⱼ≦ds, then wᵢⱼ=1 and vᵢⱼ=dᵢⱼ/ds,
if ds<dᵢⱼ<∞, then wᵢⱼ=ds/dᵢⱼ and vᵢⱼ=1, and
if dᵢⱼ=∞, then wᵢⱼ=0 and vᵢⱼ=1, where
dᵢⱼ represents the volume weight value from the domain i of the segment j, in particular an average value or weighted average value.

65. (canceled)

66. The system according to claim 37, wherein the cargo transport comprises at least one segment j with at least one leg k, in which the processor is further configured to determine the free capacity for a cargo transport relative to the volume weight of a cargo unit, in which the processor is configured to:
a) for incoming transport requests for cargo units n with the rate rₙ, the volume Vₙ, the weight Wₙ, and the volume weight dₙ, first determine the free capacity fcⱼ of a segment j as a function of the volume weight dₙ via:
if 0<swⱼ≦svⱼ and 0≦dₙ≦ds, then fcⱼ=swⱼ,
if 0<swⱼ≦svⱼ and ds<dₙ≦ds×(svⱼ/swⱼ), then fcⱼ=(d/ds)×swⱼ,
if 0<swⱼ≦svⱼ and ds×(svⱼ/swⱼ)<dₙ≦∞, then fcⱼ=svⱼ,
if swⱼ>svⱼ>0 and 0≦dₙ≦ds×(svⱼ/swⱼ), then fcⱼ=swⱼ,
if swⱼ>svⱼ>0 and ds×(svⱼ/swⱼ)<dₙ≦ds, then fcⱼ=(ds/dₙ)×svⱼ,
if swⱼ>svⱼ>0 and ds<dₙ≦∞, then fcⱼ=svⱼ,
if swⱼ=0 and svⱼ>0 and 0≦dₙ<∞, then fcⱼ=0,
if swⱼ=0 and svⱼ>0 and dₙ=∞, then fcⱼ=svⱼ,
if swⱼ>0 and svⱼ=0 and dₙ=0, then fcⱼ=swⱼ,
if swⱼ>0 and svⱼ=0 and 0<dₙ≦∞, then fcⱼ=0, and
if swⱼ=0 and svⱼ=0, then fcⱼ=0,
where the preceding parameters have the following meanings:
swⱼ represents the expected unused weight capacity of a segment j expressed in chargeable weight cw with the volume weight d=0, where swⱼ is defined as Min {swₖ, for all k, for which akⱼ=1},
svⱼ represents the expected unused volume capacity of a segment j expressed in chargeable weight cw with the volume weight d=∞, where svⱼ is defined as Min {svₖ, for all k, for which akⱼ=1 }, where
akⱼ=1 if the leg k is contained in the segment j and where
akⱼ=0 if the leg k is not contained in the segment j,
cwₙ represents the chargeable weight cw of the transport request n,
fcⱼ represents the free available capacity with the volume weight dₙ, expressed in chargeable weight cw,
d represents the volume weight,
dₙ represents the volume weight of a cargo unit n which is determined as follows:
if the weight Wₙ of the cargo unit n>0 and the volume Vₙ of the cargo unit n≧0, then the volume weight dₙ=(Vₙ/Wₙ),
if the weight Wₙ of the cargo unit=0 and the volume Vₙ of the cargo unit n≧0, then the volume weight dₙ=∞, and
if the weight Wₙ of the cargo unit=0 and the volume Vₙ of the cargo unit=0, then the volume weight dₙ is indeterminate,
ds represents the standard volume weight;
b) determine the chargeable weight cwₙ of the transport request n according to:
if the weight Wₙ in t is equal to 0 and the volume Vₙ in m³ is equal to 0, then cwₙ=0,
if 0≦dₙ≦ds, then cwₙ=Wₙ×1000 and
if ds<dₙ≦∞, then cwₙ=Vₙ×1000/ds; and
c) if the chargeable weight cwₙ≦fcⱼ, accept the transport request and, if the chargeable weight cwₙ>fcⱼ, accept the transport request if, for the transport request of a cargo unit n, the bid price bpₙ≦rₙ, and if Vₙ≦Vᵣₑₘ and Wₙ≦Wᵣₑₘ, and otherwise reject the transport request.

67. The system according to claim 66, wherein the bid price bpⱼ is determined via the equation
bpⱼ=wₙ×bpwⱼ+vₙ×bpvⱼ,
where
bpⱼ stands for the bid price of a unit of the chargeable weight cw, in particular of a chargeable kg, of the requested cargo unit or cargo amounts for a segment j with a volume weight dₙ, bpwⱼ stands for the weight capacity access price of the segment j, expressed in price per chargeable weight cw, in particular per chargeable kg, with the volume weight dₙ=0, bpvⱼ stands for the volume capacity access price of the segment j, expressed in price per chargeable weight cw, in particular per chargeable kg, with the volume weight dₙ=∞, where bpwⱼ is defined as the sum of the weight bid prices of all the legs k which are on the segment j, that is, bpwⱼ=Σₖ akⱼ×bpwₖ, and where bpvⱼ is defined as the sum of the volume bid prices of all the legs k which are on the segment j, that is, bpvⱼ=Σₖ aₖⱼ×bpvₖ, where akⱼ=1, if the leg k is contained in the segment j and where akⱼ=0, if the leg k is not contained in the segment j, and where wₙ stand for the specific weight consumption and where vₙ stand for the specific volume consumption, where the specific weight consumption or the specific volume consumption is defined as follows:
if 0≦dₙ≦ds, then wₙ=1 and vₙ=dₙ/dₛ,
if ds<dₙ<∞, then wₙ=ds/dₙ and vₙ=1,
if dₙ=∞, then wₙ=0 and vₙ=1 and
dₙ represents the volume weight of a cargo unit or cargo amount and ds represents the standard volume weight, and where the bpwₖ and bpvₖ are determined by solving the following problem, in particular by means of linear programming:
minimize
$${R}_{F} = {\sum }_{k} {W}_{k - re m} \times b p {w}_{k} + {\sum }_{k} {V}_{k - r em} \times b p {v}_{k} + {\sum }_{i} {\sum }_{j} {D}_{ij} \times {p}_{ij}$$
subject to
Σ akⱼ wᵢⱼ×bpwₖ+Σ aₖⱼ vᵢⱼ×bpvₖ+pᵢⱼ≧rᵢⱼ,
for all the (i, j)
bpvₖ, bpwₖ, pᵢⱼ≧0,
for all the (i, j) and k,
where R_{F} specifies the revenue over a transport, Wₖ₋ᵣₑₘ specifies the still available weight capacity of the leg k expressed in chargeable weight cw which only consists of weight, that is, has a volume weight d=0, and Vₖ₋ᵣₑₘ specifies the still available volume capacity of the leg k expressed in chargeable weight cw which only consists of volume, that is, has a volume weight d=∞, bpwₖ specifies for the bid price of the weight capacity of the leg k, bpvₖ specifies the bid price of the volume capacity of the leg k, Dᵢⱼ specifies the forecasted demand for the forecast domain or the subregion (r/d class) i of segment the j expressed in chargeable weight cw, wᵢⱼ specify the weight coefficients of the forecast domain i of the segment j, vᵢⱼ specify the volume coefficients of the forecast domain i of the segment j, aₖⱼ represents the index coefficient of the leg k on the segment j, where aₖⱼ=0 if the leg k is not a component of the segment j and where aₖⱼ=1 if the leg k is a component of the segment j, and pᵢⱼ specifies the profitability of the forecast domain i of the segment j, expressed in chargeable weight cw, and rᵢⱼ, in particular in the form of an average value or weighted average value, specifies the rate of the forecast domain i of the segment j expressed as price per chargeable weight cw, where
the weight and volume coefficients wᵢⱼ and vᵢⱼ are defined as follows:
if 0≦dᵢⱼ≦ds, then wⱼ=1 and vᵢⱼ=dᵢⱼ/ds,
if ds<dᵢⱼ<∞, then wᵢⱼ=ds/dᵢⱼ and vᵢⱼ=1, and
if dᵢⱼ=∞, then wᵢⱼ=0 and vᵢⱼ=1, where
dᵢⱼ represents a volume weight value from the domain i of the segment j, in particular an average value or weighted average value.

68. The system according to claim 66, wherein the expected unused weight capacity swⱼ of a segment j expressed in chargeable weight cw with the volume weight d=0, and the expected unused volume capacity svⱼ of a segment j expressed in chargeable weight cw with the volume weight d=∞ are determined via Min {swₖ, for all k, for which akⱼ=1} and Min {svₖ, for all k, for which akⱼ=1}, and where the values for swₖ and svₖ are determined by solving the following problems with the aid of linear optimization:
maximize
$${R}_{F} = {\sum }_{i} {\sum }_{j} {r}_{ij} {x}_{ij}$$
subject to
$${\sum }_{i} {\sum }_{j} {a}_{kj} {w}_{ij} {x}_{ij} + s {w}_{k} = {W}_{k - r em} , for all the k$$
$${\sum }_{i} {\sum }_{j} {a}_{kj} {v}_{ij} {x}_{ij} + s {v}_{k} = {V}_{k - r em} , for all the k$$
xᵢⱼ+sᵢⱼ=Dᵢⱼ,
for all the (i, j) and
sᵢⱼ, svₖ, swₖ, xᵢⱼ≧0,
for all the (i, j) and k,
where R_{F} specifies the revenue over a transport, the index k specifies the leg of a transport, j specifies the segment of a transport, i specifies the forecast domain and/or the subregion (r/d class) of a segment, xᵢⱼ specifies the request to be accepted for the forecast domain i of the segment j expressed in chargeable weight cw, Dᵢⱼ specifies the forecast demand for the forecast domain i of the segment j expressed in chargeable weight cw, aₖⱼ represents the index coefficients of the leg k on the segment j, where aₖⱼ=0 if the leg k is not a component of the segment j and where aₖⱼ=1 if the leg k is a component of the segment j, wᵢⱼ specifies the weight coefficients for the forecast domain i of the segment j, vᵢⱼ specifies the volume coefficients for the forecast domain i, Wₖ₋ᵣₑₘ specifies the still available weight capacity expressed in chargeable weight cw which only consists of weight, that is, has a volume weight d=0 of the leg k, and Vₖ₋ᵣₑₘ specifies the still available volume capacity expressed in chargeable weight cw which only consists of volume, that is, has a volume weight d=∞, of the leg k, and sᵢⱼ, svₖ, and swₖ specify the slack variables for the request for the forecast domain i on the segment j of the volume of the leg k, in particular in the form of a chargeable weight cw which only consists of volume, that is, has a volume weight of d=∞, or of the weight of the leg k, in particular in the form of a chargeable weight cw which only consists of weight, that is, has a volume weight d=0, and rᵢⱼ specify the rate of the forecast domain i of the segment j, in particular in the form of an average value or weighted average value, expressed as a price per chargeable weight cw, where the weight and volume coefficients wᵢⱼ and vᵢⱼ are defined as follows:
if 0≦dᵢⱼ≦ds, then wᵢⱼ=1 and vᵢⱼ=dᵢⱼ/ds,
if ds<dᵢⱼ<∞, then wᵢⱼ=ds/dᵢⱼ and vᵢⱼ=1, and
if dᵢⱼ=∞, then wᵢⱼ=0 and vᵢⱼ=1, where
dᵢⱼ represents a volume weight value from the domain i of the segment j in particular an average value or weighted average value.

69. The system according to claim 37, wherein the cargo transport comprises at least one segment j with at least one leg k, in which the processor is further configured to determine the free capacity for a cargo transport relative to the scaled volume weight of a cargo unit, in which the processor is configured to:
a) for incoming transport requests for cargo units n with the rate rₙ, the volume Vₙ, the weight Wₙ, the chargeable weight cwₙ, the volume weight dₙ, and the scaled volume weight sdₙ, first determine the free capacity fcⱼ of a segment j as a function of the scaled volume weight sdₙ via:
if 0<swⱼ≦svⱼ and 0≦sdₙ≦0.5, then fcⱼ=swⱼ,
if 0<swⱼ≦svⱼ and 0.5<sdₙ≦0.5×(svⱼ/swⱼ), then fcⱼ=swⱼ/(2(1−sdₙ)),
if 0<swⱼ≦svⱼ and 0.5×(svⱼ/swⱼ)<sdₙ≦1, then fcⱼ=svⱼ,
if swⱼ>svⱼ>0 and 0≦sdₙ≦0.5×(svⱼ/swⱼ), then fcⱼ=swⱼ,
if swⱼ>svⱼ>0 and 0.5×(svⱼ/swⱼ)<sdₙ≦0.5, then fcⱼ=svⱼ/2 sdₙ,
if swⱼ>svⱼ>0 and 0.5<sdₙ≦1, then fcⱼ=svⱼ,
if swⱼ=0 and svⱼ>0 and 0≦sdₙ<1, then fcⱼ=0,
if swⱼ=0 and svⱼ>0 and sdₙ=1, then fcⱼ=svⱼ,
if swⱼ>0 and svⱼ=0 and sdₙ=0, then fcⱼ=swⱼ,
if swⱼ>0 and svⱼ=0 and 0<sdₙ≦1, then fcⱼ=0, and
if swⱼ=0 and svⱼ=0, then fcⱼ=0,
where the preceding parameters have the following meanings:
swⱼ represents the expected unused weight capacity of a segment j expressed in chargeable weight cw with the volume weight d=0, where swⱼ is defined as Min {swₖ, for all k, for which akⱼ=1},
svⱼ represents the expected unused volume capacity of a segment j expressed in chargeable weight cw with the volume weight d=∞, where svⱼ is defined as Min {svₖ, for all k, for which akⱼ=1}, where
akⱼ=1 if the leg k is contained in the segment j and where
akⱼ=0 if the leg k is not contained in the segment j,
cwₙ represents the chargeable weight cw of the transport request n,
fcⱼ represents the free available capacity with the scaled volume weight sdₙ, expressed in chargeable weight cw,
dₙ represents the volume weight of a cargo unit n which is determined as follows:
if the weight Wₙ of the cargo unit n>0 and the volume Vₙ of the cargo unit n≧0, then the volume weight dₙ=(Vₙ/Wₙ),
if the weight Wₙ of the cargo unit=0 and the volume Vₙ of the cargo unit n>0, then the volume weight dₙ=∞, and
if the weight Wₙ of the cargo unit=0 and the volume Vₙ of the cargo unit=0, then the volume weight d, is indeterminate,
based on the determined volume weight dₙ, determine the scaled volume weight sdₙ, where,
if dₙ=0, then sdₙ=0,
if 0<dₙ≦ds, then sdₙ=dₙ/2ds,
if ds<dₙ<∞, then sdₙ=1−ds/2dₙ, and
if dₙ=∞, then sdₙ=1,
where ds is a given standard volume weight;
b) determine the chargeable weight cw according to:
if the weight Wₙ in t is equal to 0 and the volume Vₙ in m³ is equal to 0, then cwₙ=0,
if 0≦dₙ≦0.5, then cwₙ=Wₙ×1000 and
if 0.5<sdₙ≦1, then cwₙ=Vₙ×1000/ds; and
c) if the chargeable weight cwₙ≦fcⱼ, accept the transport request and, if the chargeable weight cwₙ>fcⱼ, accept the transport request if the bid price determined for the transport request of a cargo unit n, bpₙ,≦rₙ, and if Vₙ≦Vᵣₑₘ and Wₙ≦Wᵣₑₘ, and otherwise reject the transport request.

70. (canceled)

71. The system according to claim 37, wherein the cargo transport comprises at least one segment j with at least one leg k, in which the processor is further configured to determine the revenue from the lowest-valued subregion of expected transport request (bid price) for a segment as a function of the volume weight d, in which the processor is configured to:
a) for incoming transport requests for cargo units n with the rate rₙ, determine the volume Vₙ, the weight Wₙ, and the volume weight dₙ, the bid price bpⱼ as follows:
if 0≦dₙ≦ds, then bpⱼ=bpwⱼ+(dₙ/ds)×bpvⱼ,
if ds<dₙ<∞, then bpⱼ=(ds/dₙ)×bpwⱼ+bpvⱼ, and
if dₙ=∞, then bpⱼ=bpvⱼ,
where the preceding parameters have the following meaning:
dₙ volume weight of the transport request,
ds standard volume weight,
bpⱼ bid price of the segment j at a volume weight dₙ,
bpwⱼ weight capacity access price of the segment j expressed in price per chargeable weight cw with the volume weight dₙ=0 (price of the weight capacity of the segment
bpvⱼ volume capacity access price of the segment j expressed in price per chargeable weight cw with the volume weight dₙ=∞ (price of the volume capacity of the segment j),
where bpwⱼ is defined as the sum of the weight bid prices of all the legs k which are on the segment j, that is, bpwⱼ=Σₖ aₖⱼ×bpwₖ, and where bpvⱼ is defined as the sum of the volume bid prices of all the legs k which are on the segment j, that is, bpvⱼ=Σₖ akⱼ×bpvₖ,
akⱼ=1 if the leg k is contained in the segment j and where
akⱼ=0 if the leg k is not contained in the segment j,
the volume weight of a cargo unit n is determined as follows:
if the weight Wₙ of the cargo unit>0 and the volume Vₙ of the cargo unit≧0, then the volume weight dₙ=(Vₙ/Wₙ),
if the weight Wₙ of the cargo unit=0 and the volume Vₙ of the cargo unit n>0, then the volume weight dₙ=∞,
if the weight Wₙ of the cargo unit=0 and the volume Vₙ of the cargo unit=0, then the volume weight dₙ is indeterminate,
b) determine the chargeable weight cwₙ of the transport request n as follows:
if the weight Wₙ in t is equal to 0 and the volume Vₙ in m³ is equal to 0, then cwₙ=0,
if 0≦dₙ≦ds, then cwₙ=Wₙ×1000 and
if ds<dₙ≦∞, then cwₙ=Vₙ×1000/ds; and
c) if the rate rₙ≧bpⱼ and if Vₙ≦Vᵣₑₘ and Wₙ≦Wᵣₑₘ, accept the transport request and, if the rate rₙ<bₚⱼ, reject the transport request.

72. The system according to claim 37, wherein the cargo transport comprises at least one segment j with at least one leg k, in which the processor is further configured to determine the revenue from the lowest-valued subregion of expected transport request (bid price) for a segment as a function of the scaled volume weight sd, in which the processor is configured to:
a) for incoming transport requests for cargo units n with the rate rₙ, the volume Vₙ, the weight Wₙ, the volume weight dₙ, and the scaled volume weight sdₙ, determine the bid price bpⱼ as follows:
if 0≦sdₙ≦0.5, then bpⱼ=bpwⱼ+2 sdₙ×bpvⱼ,
if 0.5<sdₙ<1, then bpⱼ=2(1−sdₙ)×bpwⱼ+bpvⱼ, and
if dₙ=1, then bpⱼ=bpvⱼ,
where the preceding parameters have the following meaning:
dₙ volume weight of the transport request
sdₙ scaled volume weight of the transport request
bpⱼ bid price of the segment j at a scaled volume weight sdₙ
bpwⱼ weight capacity access price of the segment j, expressed in price per chargeable weight cw, in particular per chargeable kg with the volume weight dₙ=0 (price of the weight capacity of the segment j),
bpvⱼ volume capacity access price of the segment j, expressed in price per chargeable weight cw, in particular per chargeable kg with the volume weight dₙ=∞ (price of the volume capacity of the segment j),
where bpwⱼ is defined as the sum of the weight bid prices of all the legs k which are on the segment j, that is, bpwⱼ=Σₖ aₖⱼ×bpwₖ, and where bpvⱼ is defined as the sum of the volume bid prices of all the legs k which are on the segment j, that is, bpvⱼ=Σₖ akⱼ×bpvₖ,
akⱼ=1 if the leg k is contained in the segment j and where
akⱼ=0 if the leg k is not contained in the segment j,
and where
the volume weight of a cargo unit n is determined as follows:
if the weight Wₙ of the cargo unit>0 and the volume Vₙ of the cargo unit≧0, then the volume weight dₙ=(Vₙ/Wₙ),
if the weight Wₙ of the cargo unit=0 and the volume Vₙ of the cargo unit n>0, then the volume weight dₙ=∞,
if the weight Wₙ of the cargo unit=0 and the volume Vₙ of the cargo unit=0, then the volume weight dₙ is indeterminate,
based on the determined volume weight d, determine the scaled volume weight sdₙ, where,
if dₙ=0, then sdₙ=0,
if 0<dₙ≦ds, then sdₙ=dₙ/2ds,
if ds<dₙ<∞, then sdₙ=1−ds/2dₙ, and
if dₙ=∞, then sdₙ=1,
where ds is a given standard volume weight;
b) determine the chargeable weight cwₙ of the transport request n as follows:
if the weight Wₙ in t is equal to 0 and the volume Vₙ in m³ is equal to 0, then cwₙ=0,
if 0≦sdₙ≦0.5, then cwₙ=Wₙ×1000 and
if 0.5<sdₙ≦1, then cwₙ=Vₙ×1000/ds; and
c) if the rate rₙ≧bpⱼ and if Vₙ≦Vᵣₑₘ and Wₙ≦Wᵣₑₘ, accept the transport request and, if the rate rₙ<bpⱼ, reject the transport request.

73. An article of manufacture comprising a computer-readable medium on which program instructions are stored, wherein when said program instructions are executed by a computer, the computer carries out all steps according to claim 1.

74. The method of claim 1, wherein determining whether the scaled volume weight sdₙ of the transport request for the n^{th} cargo unit has an extreme scaled volume weight sd, comprises determining if sdₙ is in a range of 0≦sdₙ<0.4 or of 0.6<sdₙ≦1.

75. The method of claim 1, wherein determining whether the scaled volume weight sdₙ of the transport request for the n^{th} cargo unit has an extreme scaled volume weight sdₙ comprises determining if sdₙ is in a range of 0≦sdₙ≦0.2 or of 0.8≦sdₙ≦1.

76. The method of claim 3, wherein
if sdₖ<0.5, the transport request is accepted if sdₙ<sdₖ or if 0≦sdₙ≦0.4,
if sdₖ>0.5, the transport request is accepted if sdₙ>sdₖ or if 0.6≦sdₙ≦1, and
if sdₖ=0.5, the transport request is accepted if 0≦sdₙ≦0.4 or 0.6≦sdₙ≦1.

77. The method of claim 3, wherein
if sdₖ<0.5, the transport request is accepted if sdₙ<sdₖ or if 0≦sdₙ≦0.2,
if sdₖ>0.5, the transport request is accepted if sdₙ>sdₖ or if 0.8≦dₙ≦1, and
if sdₖ=0.5, the transport request is accepted if 0≦sdₙ≦0.2 or 0.8≦sdₙ≦1.

78. The system of claim 37, wherein the processor is configured to determine whether the scaled volume weight sdₙ of the transport request for the n^{th} cargo unit has an extreme scaled volume weight sdₙ in a range of 0≦sdₙ<0.4 or of 0.6<sdₙ≦1.

79. The system of claim 37, wherein the processor is configured to determine whether the scaled volume weight sdₙ of the transport request for the n^{th} cargo unit has an extreme scaled volume weight sdₙ in a range of 0≦sdₙ≦0.2 or of 0.8≦sdₙ≦1.

80. The system of claim 39, wherein
if sdₖ<0.5, the processor is configured to accept the transport request if sdₙ<sdₖ or if 0≦sdₙ≦0.4,
if sdₖ>0.5, the processor is configured to accept the transport request if sdₙ>sdₖ or if 0.6≦sdₙ≦1, and
if sdₖ=0.5, the processor is configured to accept the transport request if 0≦sdₙ≦0.4 or 0.6≦sdₙ≦1.

81. The system of claim 39, wherein
if sdₖ<0.5, the processor is configured to accept the transport request if sdₙ<sdₖ or if 0≦sdₙ≦0.2,
if sdₖ>0.5, the processor is configured to accept the transport request if sdₙ>sdₖ or if 0.8≦dₙ≦1 and
if sdₖ=0.5, the processor is configured to accept the transport request if 0≦sdₙ≦0.2 or 0.8≦sdₙ≦1.
